(19) United States
(12) Patent Application Publication
(10) Pub. No.: US 2007/0288549 A1
(43) Pub. Date: Dec. 13, 2007

(54) Information Processing System, Server Device, Client Device, and Program

(75) Inventors: Wataru Shoji, Tokyo (JP); Keiichi Koide, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: HOWS Corporation, Tokyo (JP)

(21) Appl. No.: 11/630,336

(22) PCT Filed: May 26, 2006
(86) PCT No.: PCT/JP06/10523

§ 371 Date: Dec. 21, 2006

(30) Foreign Application Priority Data
May 27, 2005 (JP) 2005-154829
Oct. 13, 2005 (JP) 2005-298446

(51) Int. Cl. G06F 15/16

(52) U.S. Cl. 709/202

(57) ABSTRACT

Conventional information processing systems and the like have a problem in that it is impossible to easily acquire information. It is possible to easily acquire information with a server device, comprising: a management information storage portion in which at least one piece of management information, which is information for managing an association between symbol information and location information, is stored, the symbol information being information associated with information stored in at least one information storage device, and the location information being information specifying a location in which the information is stored; a location information transmission requesting information receiving portion for receiving, from a client device, location information transmission requesting information, which is information containing symbol information and is information for making a request to transmit location information; a location information acquiring portion for acquiring at least one piece of location information associated with symbol information contained in the location information transmission requesting information, based on the management information; and a location information transmitting portion for transmitting, to a client device, the at least one piece of location information that has been acquired by the location information acquiring portion.

### TECHNICAL FIELD

The present invention relates to information processing systems and the like that are used for processing information.

### BACKGROUND ART

A first conventional technique involves a so-called “favorites” function in a web browser. Furthermore, it has been also proposed to share information in favorites.

Furthermore, a second conventional technique involves a web browser (see Patent Document 1, for example). This web browser is a web browser for reducing the problem that important data fails to be read when in data for one page, an non-display portion generated because the data for one page is too long to be displayed on the screen of the web browser all at once is left unnoticed, or even when the non-display portion is noticed, the screen is not scrolled because scrolling is vexatious. More specifically, this web browser is characterized by comprising a first screen for displaying all data for one page in an HTML file or data, and a second screen for displaying an enlarged portion of the first screen display such that the portion can be easily read, in a web browser for accessing and displaying various HTML files or data on the Internet or an intranet.

Furthermore, a third conventional technique involves a web search engine for obtaining information by inputting a keyword.

On the other hand, conventionally, there has been a technique for retrieving a desired information resource from among a group of information resources with which multiple labels are associated, by specifying one or multiple labels as retrieval keys (see Patent Document 2, for example).

In this technique, it is necessary that desired labels, that is, keywords relating to information resources are prepared in advance for the information resources, and that the keywords and the information resources are stored in a database or the like.

[Patent Document 1] JP 2002-132410A (page 1, FIG. 1, for example)

[Patent Document 2] JP 2002-073655A (page 1, FIG. 1, for example)

[Non-Patent Document 1]

home page, the Internet <URL: http://www.google.co.jp/>

### DISCLOSURE OF INVENTION

### Problems to be solved by the Invention

However, in the first conventional technique, information in favorites including location information (such as a URL) is simply shared among a large number of users, and thus all registered location information is acquired, so that a large amount of location information that is not required by a user is acquired. More specifically, there is a problem in that it is impossible to select and obtain only location information associated with information that is necessary for the user.

Furthermore, in the first, second, and third conventional techniques, there is a problem in that only HTML files can be browsed, and thus it is impossible to browse various types of information.

Furthermore, in the first and second conventional techniques, there is a problem in that when information used by other users is registered, it is impossible to check whether or not registration should be performed.

Furthermore, in the third conventional technique, for example, there is a problem in that a keyword and location information are not contained in information of one file, and thus when the search engine acquires location information associated with a keyword, the load on the server device is increased.

Furthermore, in the first, second, and third conventional techniques, there is a problem in that an operation for obtaining required information is vexatious.

Furthermore, in conventional techniques, there is a problem in that in order to register a keyword, it is necessary to input the keyword using a keyboard and the like, and thus the operation is very vexatious, so that keywords and information resources cannot be registered easily.

Furthermore, with respect to registration of an information resource, there is a problem in that when registering only a part of an information resource, it is necessary for the user to once extract this part of the information and to register the extracted information, so that the operation is very vexatious.

Furthermore, in conventional techniques, there is a problem in that when registering a label, that is, a retrieval key, it is impossible to check whether or not the label has been already registered.

### Means for Solving the Problems

A first aspect of the present invention is directed to an information processing system comprising at least one information storage device, a server device, and a client device, wherein the information storage device comprises: an information storage portion in which at least one piece of information is stored; and an information transmitting portion for transmitting the information to the client device in response to a request from the client device, the server device comprises: a management information storage portion in which at least one piece of management information, which is information for managing an association between symbol information and location information, is stored, the symbol information being information associated with information stored in the at least one information storage device, and the location information being information specifying a location in which the information is stored; a location information transmission requesting information receiving portion for receiving, from the client device, location information transmission requesting information, which is information containing symbol information and is information for making a request to transmit location information; a location information acquiring portion for acquiring at least one piece of location information associated with symbol information contained in the location information transmission requesting information, based on the management information; and a location information transmitting portion for transmitting, to the client device, the at least one piece of location information that has been acquired by the location information acquiring portion, and the client device comprises: a symbol information reception portion for receiving symbol information; a location information transmission requesting information transmitting portion for transmitting, to the server device, location information transmission requesting information containing the symbol information that has been received by the symbol information reception portion; a location information receiving portion for receiving the at least one piece of location information from the server device; and a location-related information outputting portion for outputting at least one piece of location-related information, which is information relating to the at least one piece of location information that has been received by the location information receiving portion.

With this configuration, it is possible to select and obtain only location information associated with information that is necessary for the user. Thus, it is possible for the user to obtain necessary information easily and quickly.

Furthermore, a second aspect of the present invention is directed to an information processing system comprising at least one information storage device, a server device, and a client device, wherein the information storage device comprises: an information storage portion in which at least one piece of information is stored; and an information transmitting portion for transmitting the information to the client device in response to a request from the client device, the server device comprises: a management information storage portion in which at least one piece of management information, which is information for managing an association between symbol information and location information, is stored, the symbol information being information associated with information stored in the at least one information storage device, and the location information being information specifying a location in which the information is stored; a location information transmission requesting information receiving portion for receiving, from the client device, location information transmission requesting information, which is information containing symbol information and is information for making a request to transmit location information; a location information acquiring portion for acquiring at least one piece of location information associated with symbol information contained in the location information transmission requesting information, based on the management information; and a location information transmitting portion for transmitting, to the client device, the at least one piece of location information that has been acquired by the location information acquiring portion, and the client device comprises: a symbol information reception portion for receiving symbol information; a location information transmission requesting information transmitting portion for transmitting, to the server device, location information transmission requesting information containing the symbol information that has been received by the symbol information reception portion; a location information receiving portion for receiving the at least one piece of location information from the server device; an information transmission requesting portion for making a request, to an information storage device specified by the location information that has been received by the location information receiving portion, to transmit information; an information receiving portion for receiving the requested information from the information storage device; and an information outputting portion for outputting the information that has been received by the information receiving portion.

With this configuration, it is possible to select only location information associated with information that is necessary for the user, and to obtain necessary information easily and quickly.

Furthermore, a third aspect of the present invention is directed to the information processing system according to the second aspect, wherein the client device further comprises: a location-related information outputting portion for outputting at least one piece of location-related information, which is information relating to the at least one piece of location information that has been received by the location information receiving portion; and a location-related information instruction reception portion for receiving an instruction on at least one piece of location-related information, among the at least one piece of location-related information that has been output by the location-related information outputting portion, and the information transmission requesting portion makes a request, to an information storage device specified by location information relating to location-related information corresponding to the instruction that has been received by the location-related information instruction reception portion, to transmit information.

With this configuration, it is possible to select only location information associated with information that is necessary for the user, and to obtain necessary information easily and quickly.

Furthermore, a fourth aspect of the present invention is directed to the information processing system according to any one of the first to the third aspects, wherein in the client device, the information is output with an application corresponding to a format of the information.

With this configuration, it is possible for the user to obtain various types of information.

Furthermore, a fifth aspect of the present invention is directed to the information processing system according to any one of the first to the fourth aspects, wherein the client device further comprises: an information storage portion in which at least one piece of information is stored; an output instruction reception portion for receiving an output instruction on the information; wherein the information outputting portion further outputs information on which the output instruction has been received; and the symbol information reception portion further receives an instruction on symbol information contained in the output information; a registration constructing portion for constructing registration information based on the symbol information that has been received by the symbol information reception portion; and a registration information transmitting portion for transmitting, to the server device, the registration information that has been constructed by the registration constructing portion, and the server device further comprises: a registration information receiving portion for receiving registration information from the client device; and a management information accumulating portion for accumulating management information in the management information storage portion based on symbol information and location information contained in the registration information that has been received by the registration information receiving portion.

With this configuration, it is possible for a user to easily register information that has been created by the user, and to let another user use the information.

Furthermore, a sixth aspect of the present invention is directed to the information processing system according to the fifth aspect, wherein the server device further comprises an accumulation judging portion for judging whether or not management information should be accumulated, based on the registration information that has been received by the registration information receiving portion, and the management information accumulating portion accumulates the management information in the management information storage portion only when the accumulation judging portion judges that accumulation should be performed.

With this configuration, when registering information that is used by another user, it is possible to check whether or not registration should be performed.

Furthermore, a seventh aspect of the present invention is directed to the information processing system according to the sixth aspect, wherein the accumulation judging portion judges that accumulation should be performed only when in the management information storage portion, there is no management information for managing an association between symbol information and location information contained in the registration information that has been received by the registration information receiving portion.

This configuration is preferable because when registering information that is used by another user, duplicate information is not registered.

Furthermore, an eighth aspect of the present invention is directed to an information processing system comprising at least one information storage device, at least two server devices, and a client device, wherein the information storage device comprises: an information storage portion in which at least one piece of information is stored; and an information transmitting portion for transmitting the information to the client device in response to a request from the client device, the server device comprises: a management information storage portion in which at least one piece of management information, which is information for managing an association between symbol information and location information, is stored, the symbol information being information associated with information stored in the at least one information storage device, and the location information being information specifying a location in which the information is stored; a location information transmission requesting information receiving portion for receiving, from the client device, location information transmission requesting information, which is information containing symbol information and is information for making a request to transmit location information; a location information acquiring portion for acquiring at least one piece of location information associated with symbol information contained in the location information transmission requesting information, based on the management information; and a location information transmitting portion for transmitting, to the client device, the at least one piece of location information that has been acquired by the location information acquiring portion, and the client device comprises: a symbol information reception portion for receiving symbol information; a location information transmission requesting information transmitting portion for transmitting, to the at least two server devices, location information transmission requesting information containing the symbol information that has been received by the symbol information reception portion; a location information receiving portion for receiving the at least one piece of location information from at least one server device, among the at least two server devices; and a location-related information outputting portion for outputting at least one piece of location-related information, which is information relating to the at least one piece of location information that has been received by the location information receiving portion.

With this configuration, it is possible to select and obtain only location information associated with information that is necessary for the user. Also, it is possible to register location information in at least two server devices in a distributed manner, and thus it is possible to flexibly construct a system.

Furthermore, a ninth aspect of the present invention is directed to an information processing system comprising at least one information storage device, at least two server devices, and a client device, wherein the information storage device comprises: an information storage portion in which at least one piece of information is stored; and an information transmitting portion for transmitting the information to the client device in response to a request from the client device, the server device comprises: a management information storage portion in which at least one piece of management information, which is information for managing an association between symbol information and location information, is stored, the symbol information being information associated with information stored in the at least one information storage device, and the location information being information specifying a location in which the information is stored; a location information transmission requesting information receiving portion for receiving, from the client device, location information transmission requesting information, which is information containing symbol information and is information for making a request to transmit location information; a location information acquiring portion for acquiring at least one piece of location information associated with symbol information contained in the location information transmission requesting information, based on the management information; and a location information transmitting portion for transmitting, to the client device, the at least one piece of location information that has been acquired by the location information acquiring portion, and the client device comprises: a symbol information reception portion for receiving symbol information; a location information transmission requesting information transmitting portion for transmitting, to the at least two server devices, location information transmission requesting information containing the symbol information that has been received by the symbol information reception portion; a location information receiving portion for receiving the at least one piece of location information from at least one server device, among the at least two server devices; an information transmission requesting portion for making a request, to an information storage device specified by the location information that has been received by the location information receiving portion, to transmit information; an information receiving portion for receiving the requested information from the information storage device; and an information outputting portion for outputting the information that has been received by the information receiving portion.

With this configuration, it is possible to select only location information associated with information that is necessary for the user, and to easily obtain necessary information. Also, it is possible to register location information in at least two server devices in a distributed manner, and thus it is possible to flexibly construct a system.

Furthermore, a tenth aspect of the present invention is directed to the information processing system according to the ninth aspect, wherein the client device further comprises: a location-related information outputting portion for outputting at least one piece of location-related information, which is information relating to the at least one piece of location information that has been received by the location information receiving portion; and a location-related information instruction reception portion for receiving an instruction on at least one piece of location-related information, among the at least one piece of location-related information that has been output by the location-related information outputting portion, and the information transmission requesting portion makes a request, to an information storage device specified by location information relating to location-related information corresponding to the instruction that has been received by the location-related information instruction reception portion, to transmit information.

With this configuration, it is possible to select only location information associated with information that is necessary for the user, and to easily obtain necessary information. Also, it is possible to register location information in at least two server devices in a distributed manner, and thus it is possible to flexibly construct a system.

Furthermore, an eleventh aspect of the present invention is directed to the information processing system according to any one of the eighth to the tenth aspects, wherein the client device further comprises a retrieval server device determining portion for determining at least one server device to which location information transmission requesting information is to be transmitted, based on the symbol information that has been received by the symbol information reception portion, and the location information transmission requesting information transmitting portion transmits location information transmission requesting information to the at least one server device that has been determined by the retrieval server device determining portion.

With this configuration, it is possible to select only location information associated with information that is necessary for the user. Also, a server device on which retrieval is to be performed is selected from among at least two server devices, and thus it is possible to obtain location information at a high speed.

Furthermore, a twelfth aspect of the present invention is directed to the information processing system according to any one of the eighth to the eleventh aspects, wherein the client device further comprises: an information storage portion in which at least one piece of information is stored; an output instruction reception portion for receiving an output instruction on the information; wherein the information outputting portion further outputs information on which the output instruction has been received; and the symbol information reception portion further receives an instruction on symbol information contained in the output information; a registration constructing portion for constructing registration information based on the symbol information that has been received by the symbol information reception portion; and a registration information transmitting portion for transmitting, to the server device, the registration information that has been constructed by the registration constructing portion, and the server device further comprises: a registration information receiving portion for receiving registration information from the client device; and a management information accumulating portion for accumulating management information in the management information storage portion based on symbol information and location information contained in the registration information that has been received by the registration information receiving portion.

With this configuration, it is possible to select only location information associated with information that is necessary for the user.

Furthermore, a thirteenth aspect of the present invention is directed to the information processing system according to the twelfth aspect, wherein the client device further comprises a registration server device determining portion for determining at least one server device to which registration information is to be transmitted, based on the information, and the registration information transmitting portion transmits registration information to the at least one server device that has been determined by the registration server device determining portion.

With this configuration, it is possible to select and obtain only location information associated with information that is necessary for the user. Also, it is possible to register location information in at least two server devices in a distributed manner, and thus it is possible to flexibly construct a system.

Furthermore, a fourteenth aspect of the present invention is directed to an information processing system comprising at least two information storage devices and a client device, wherein the information storage device comprises: an information storage portion in which at least one piece of information is stored; a management information storage portion in which at least one piece of management information, which is information for managing an association between symbol information and location information, is stored, the symbol information being information associated with information stored in the information storage portion, and the location information being information specifying a location in which the information is stored; a location information transmission requesting information receiving portion for receiving, from the client device, location information transmission requesting information, which is information containing symbol information and is information for making a request to transmit location information; a location information acquiring portion for acquiring at least one piece of location information associated with symbol information contained in the location information transmission requesting information, based on the management information; a location information transmitting portion for transmitting, to the client device, the at least one piece of location information that has been acquired by the location information acquiring portion; and an information transmitting portion for transmitting the information to the client device in response to a request from the client device, and the client device comprises: a symbol information reception portion for receiving symbol information; a location information transmission requesting information transmitting portion for transmitting, to the at least two information storage devices, location information transmission requesting information containing the symbol information that has been received by the symbol information reception portion; a location information receiving portion for receiving the at least one piece of location information from at least one information storage device, among the at least two information storage devices; and a location-related information outputting portion for outputting at least one piece of location-related information, which is information relating to the at least one piece of location information that has been received by the location information receiving portion.

With this configuration, it is possible to select and obtain only location information associated with information that is necessary for the user. Also, with this system configuration, a server device is not necessary, and thus the system flexibility is increased.

Furthermore, a fifteenth aspect of the present invention is directed to an information processing system comprising at least two information storage devices and a client device, wherein the information storage device comprises: an information storage portion in which at least one piece of information is stored; a management information storage portion in which at least one piece of management information, which is information for managing an association between symbol information and location information, is stored, the symbol information being information associated with information stored in the information storage portion, and the location information being information specifying a location in which the information is stored; a location information transmission requesting information receiving portion for receiving, from the client device, location information transmission requesting information, which is information containing symbol information and is information for making a request to transmit location information; a location information acquiring portion for acquiring at least one piece of location information associated with symbol information contained in the location information transmission requesting information, based on the management information; a location information transmitting portion for transmitting, to the client device, the at least one piece of location information that has been acquired by the location information acquiring portion; and an information transmitting portion for transmitting the information to the client device in response to a request from the client device, and the client device comprises: a symbol information reception portion for receiving symbol information; a location information transmission requesting information transmitting portion for transmitting, to the at least two information storage devices, location information transmission requesting information containing the symbol information that has been received by the symbol information reception portion; a location information receiving portion for receiving the at least one piece of location information from at least one information storage device, among the at least two information storage devices; an information transmission requesting portion for making a request, to an information storage device specified by the location information that has been received by the location information receiving portion, to transmit information; an information receiving portion for receiving the requested information from the information storage device; and an information outputting portion for outputting the information that has been received by the information receiving portion.

With this configuration, it is possible to select only location information associated with information that is necessary for the user, and to easily obtain information. Also, with this system configuration, a server device is not necessary, and thus the system flexibility is increased.

Furthermore, a sixteenth aspect of the present invention is directed to the information processing system according to the fifteenth aspect, wherein the client device further comprises: a location-related information outputting portion for outputting at least one piece of location-related information, which is information relating to the at least one piece of location information that has been received by the location information receiving portion; and a location-related information instruction reception portion for receiving an instruction on at least one piece of location-related information, among the at least one piece of location-related information that has been output by the location-related information outputting portion, and the information transmission requesting portion makes a request, to an information storage device specified by location information relating to location-related information corresponding to the instruction that has been received by the location-related information instruction reception portion, to transmit information.

With this configuration, it is possible to select and obtain only location information associated with information that is necessary for the user. Also, with this system configuration, a server device is not necessary, and thus the system flexibility is increased.

Furthermore, a seventeenth aspect of the present invention is directed to the information processing system according to any one of the fourteenth to sixteenth aspects, wherein the client device further comprises an information storage device determining portion for determining at least one information storage device to which location information transmission requesting information is to be transmitted, based on the symbol information that has been received by the symbol information reception portion, and the location information transmission requesting information transmitting portion transmits location information transmission requesting information to the at least one information storage device that has been determined by the information storage device determining portion.

With this configuration, it is possible to select a client device on which retrieval is to be performed, based on symbol information on which an instruction is given, and thus the speed to acquire location information is significantly increased.

Furthermore, an eighteenth aspect of the present invention is directed to the information processing system according to any one of the fourteenth to the seventeenth aspects, wherein the information storage device further comprises: an output instruction reception portion for receiving an output instruction on the information; an information outputting portion for outputting information on which the output instruction has been received; a symbol information reception portion for receiving an instruction on symbol information contained in the output information; a location information reception portion for receiving location information; and a management information accumulating portion for accumulating management information in the management information storage portion based on the symbol information that has been received by the symbol information reception portion and the location information that has been acquired by the location information reception portion.

With this configuration, it is possible for a user to easily register information that has been created by the user, and to let another user use the information.

Furthermore, a nineteenth aspect of the present invention is directed to the information processing system according to any one of the first to the eighteenth aspects, wherein the symbol information is information of a character string.

Furthermore, a twentieth aspect of the present invention is directed to the information processing system according to the nineteenth aspect, wherein the symbol information reception portion receives symbol information with a tracing operation using a pointing device.

With this configuration, it is possible for the user to acquire information extremely easily.

Furthermore, a twenty-first aspect of the present invention is directed to the information processing system according to the twentieth aspect, wherein the symbol information reception portion receives symbol information immediately after the tracing operation is completed.

With this configuration, it is possible for the user to acquire information extremely easily.

Furthermore, a twenty-second aspect of the present invention is directed to an information processing device that receives a tracing operation over symbol information using a pointing device, and that performs a process based on the symbol information immediately after the tracing operation is completed.

Furthermore, a twenty-third aspect of the present invention is directed to the information processing device according to the twenty-second aspect, wherein the process is a retrieval process using the symbol information as a key, performed on an external device.

With this configuration, it is possible for the user to transfer information of a character string to an application (such as a retrieval application) extremely easily, and to easily operate an application.

Furthermore, the present invention is directed to an information processing system comprising a server device and a client device, wherein the client device comprises: a storage portion in which main information, which is information containing a character string, can be stored; an output instruction reception portion for receiving an output instruction, which is an instruction to output the main information; an outputting portion for outputting main information based on the output instruction; a character string specification reception portion for receiving a character string specification instruction, which is an instruction to specify a character string, in the main information that has been output by the outputting portion; a keyword information acquiring portion for acquiring keyword information, which is information of a character string specified by the character string specification instruction; a related information reception portion for receiving related information, which is information relating to the keyword information; and a transmitting portion for transmitting the related information and the keyword information as a pair to the server device, the server device comprises: a receiving portion for receiving the related information and the keyword information as a pair; and a first accumulating portion for accumulating the related information and the keyword information as a pair in association with each other.

With this configuration, when a character string in main information is specified, it is possible to easily register keyword information and related information relating thereto, using the character string as keyword information.

Furthermore, the present invention is directed to the information processing system according to the above aspect, wherein the client device further comprises a second accumulating portion for accumulating the related information and the keyword information as a pair in association with each other, the related information reception portion receives accumulation-destination specification that specifies the client device or the server device as accumulation-destination of the related information and the keyword information as a pair, if the accumulation-destination specification that has been received by the related information reception portion specifies the client device, then the second accumulating portion accumulates the related information and the keyword information as a pair, and if the accumulation-destination specification that has been received by the related information reception portion specifies the server device, then the transmitting portion transmits the related information and the keyword information as a pair to the server device.

With this configuration, it is possible to select accumulation-destination of keyword information and related information so as to be suitable for applications.

Furthermore, the present invention is directed to the information processing system according to the above aspect, wherein the client device further comprises an accumulation information receiving portion for receiving accumulation information, which is information indicating whether or not the keyword information has been accumulated and which has been transmitted from the server device, the transmitting portion transmits, to the server device, the keyword information that has been acquired by the keyword information acquiring portion, the related information reception portion judges whether or not keyword information has been accumulated in the server device, based on the accumulation information that has been received by the accumulation information receiving portion, and receives the related information only when it has been judged that keyword information has not been accumulated, the receiving portion of the server device receives keyword information, the first accumulating portion of the server device judges whether or not the keyword information that has been received by the receiving portion has been accumulated, and the server device further comprises an accumulation information transmitting portion in which based on judgment results of the first accumulating portion, the accumulation information is constructed and transmitted to the client device.

With this configuration, it is possible to efficiently accumulate information by avoiding registration of duplicate keyword information.

Furthermore, the present invention is directed to the information processing system according to the above aspect, wherein the character string specification reception portion receives a character string specification instruction on a character string that has been selected by dragging, and the keyword information acquiring portion acquires, as the keyword information, a character string that has been selected by the dragging.

With this configuration, it is possible to specify keyword information based on intuitive operation of tracing an interesting character string.

Furthermore, the present invention is directed to an information processing device, comprising: an output instruction reception portion for receiving an output instruction, which is an instruction to output main information, which is information including a character string; an outputting portion for outputting main information based on the output instruction; a character string specification reception portion for receiving a character string specification instruction, which is an instruction to specify a character string, in the main information that has been output by the outputting portion; a keyword information acquiring portion for acquiring, as keyword information, information of a character string specified by the character string specification instruction; a related information reception portion for receiving related information, which is information relating to the keyword information; and a transmitting portion for transmitting the related information and the keyword information as a pair to predetermined transmission destination.

With this configuration, it is possible to easily register keyword information and related information relating thereto. Also, a server device is not necessary, and thus the flexibility in system design is improved.

Furthermore, the present invention is directed to an information processing device, comprising: an output instruction reception portion for receiving an output instruction, which is an instruction to output main information, which is information including a character string; an outputting portion for outputting main information based on the output instruction; a character string specification reception portion for receiving a character string specification instruction, which is an instruction to specify a character string, in the main information that has been output by the outputting portion; a keyword information acquiring portion for acquiring, as keyword information, information of a character string specified by the character string specification instruction; a related information reception portion for receiving related information, which is information relating to the keyword information; and a second accumulating portion for accumulating the related information and the keyword information as a pair.

With this configuration, it is possible to easily register keyword information and related information relating thereto. Also, a server device is not necessary, and thus the flexibility in system design is improved.

Furthermore, the present invention is directed to an information processing system comprising a server device and a client device, wherein the client device comprises: an output instruction reception portion for receiving an output instruction, which is an instruction to output image information; an outputting portion for outputting image information based on the output instruction; an instruction information reception portion for receiving an area instruction to specify at least a part of an area, in the image information that has been output by the outputting portion, and keyword information, which is information of a character string associated with an area specified by the area instruction; a file constructing portion for constructing a partial image file, which is a file containing image information associated with an area specified by the area instruction; and a transmitting portion for transmitting the partial image file and the keyword information as a pair to the server device, and the server device comprises: a receiving portion for receiving the partial image file and the keyword information; and an accumulating portion for accumulating the partial image file and the keyword information as a pair in association with each other.

With this configuration, a step of extracting and storing a part of image information that is required to be stored is not necessary, and thus a part of image information can be registered easily and intuitively.

Furthermore, in an information processing system and the like according to the present invention, it is possible to easily register information and a keyword that is paired therewith.

### EFFECT OF THE INVENTION

In an information processing system according to the present invention, it is possible to acquire information extremely easily.

### BEST MODE FOR CARRYING OUT THE INVENTION

Hereinafter, embodiments of an information processing system and the like are described with reference to drawings. Components indicated by the same reference numerals in the embodiments perform similar operations, and thus a description thereof may not be repeated.

### Embodiment 1

An information processing system in this embodiment is an information processing system provided with at least one information storage device, one server device, and at least one client device. The client device acquires information from the at least one information storage device. The server device holds location information indicating a location in which the location of information required by the user of the client device is stored, and transmits the location information to the client device in response to a request from the client device.

FIG. 1 is a conceptual view of this information processing system. This information processing system is provided with at least one information storage device 11 (11(1) to 11(n)), one server device 12, and at least one client device 13 (13(1) to 13(m)). The devices can transmit and receive information. The devices are connected to each other via, for example, the Internet. Note that a unit for transmitting and receiving information may be a communication unit or a broadcasting unit, for example.

FIG. 2 is a block diagram of the information processing system in this embodiment.

The information storage device 11 is provided with an information storage portion 1101 and an information transmitting portion 1102.

The server device 12 is provided with a management information storage portion 1201, a location information transmission requesting information receiving portion 1202, a location information acquiring portion 1203, a location information transmitting portion 1204, a registration information receiving portion 1205, an accumulation judging portion 1206, and a management information accumulating portion 1207.

The client device 13 is provided with an output instruction reception portion 1301, an information outputting portion 1302, a symbol information reception portion 1303, a location information transmission requesting information transmitting portion 1304, a location information receiving portion 1305, a location-related information outputting portion 1306, a location-related information instruction reception portion 1307, an information transmission requesting portion 1308, an information receiving portion 1309, a registration constructing portion 1310, a registration information transmitting portion 1311, and an information storage portion 1101.

At least one piece of information is stored in the information storage portion 1101. Examples of the information include a file. Data or the like useful for the user is stored in the file. Examples of the information other than a file may include a database. If the information is a file, then the type of the file may be text, a file for spreadsheet software, bitmap, a moving image, music, or audio. More specifically, there is no limitation regarding the type of the file. The information storage portion 1101 is preferably a non-volatile storage medium, but also can be implemented as a volatile storage medium.

The information transmitting portion 1102 transmits the information to the client device 13 in response to a request from the client device 13. The information transmitting portion 1102 is typically implemented as a wireless or wired communication unit, but also may be implemented as a broadcasting unit.

At least one piece of management information, which is information for managing the association between symbol information and location information, is stored in the management information storage portion 1201, the symbol information being information associated with information stored in the at least one information storage device 11, and the location information being information specifying the location in which the information is stored. Examples of the symbol information include names or titles for specifying the information. If the information is a file, then the symbol information may be the file name of the file. If the information is a file, then the symbol information may be a character string in the first row of the file. The symbol information may be any information as long as it can be associated with the information. It is preferable that the symbol information is information of a character string comprising a character string, because it is preferable that the symbol information is information pointed with a tracing operation using a pointing device such as a mouse as described later. It should be noted that the symbol information may be bitmap, audio data, or the like. There is no limitation regarding the data type of the symbol information. Examples of the location information include information such as a URL, a URI, an IP address of the information storage device 11, and an IP address and the folder name of the information storage device 11. Examples of the management information include information containing symbol information, which is information associated with information stored in the at least one information storage device 11, and location information, which is information specifying the location in which the information is stored. Examples of the management information may include information containing pointer information of symbol information stored in an external device, and pointer information of location information stored in the same or another external device. It is preferable that the management information contains information relating to one piece of symbol information (such as the symbol information, or pointer information of the symbol information) and information relating to two or more pieces of location information (such as the location information, or pointer information of the location information). Examples of the structure of the management information include a file. If the structure of the management information is a file, then it is preferable that symbol information is contained as a part of or the entire file name of the file, and that at least one piece of location information is stored in the file. In this case, it is possible to judge whether or not there is location information associated with the symbol information, and to acquire the location information associated with the symbol information, on an existing file system at an extremely high speed. Furthermore, it is easy to construct this management information on an existing file system. Furthermore, examples of the management information may include a record of a database table. In this case, examples of the management information include a record containing the symbol information and the location information. There is no limitation regarding the data structure of the management information. The management information storage portion 1201 is preferably a non-volatile storage medium, but also can be implemented as a volatile storage medium. Here, the term “tracing operation” refers to an operation of tracing using a pointing device such as a mouse. Examples of the “tracing operation” include an operation of moving the coordinates of a mouse pointer while pressing the left button of the mouse. Typically, when a tracing operation is performed over information of a character string, a character string is selected at locations through which the mouse pointer has moved while the left button is pressed, and the character string is highlighted. Other examples of the “tracing operation” also may include an operation of moving the mouse pointer without pressing a mouse button. In this case, for example, the start point of the “tracing operation” is at the coordinates where the mouse pointer is first at rest for a predetermined time or more, and the end point of the “tracing operation” is at the coordinates where the mouse pointer is next at rest for a predetermined time or more.

The location information transmission requesting information receiving portion 1202 receives, from the client device 13, location information transmission requesting information, which is information containing symbol information and is information for making a request to transmit information including location information. The location information transmission requesting information may be the same as the symbol information. Examples of the location information transmission requesting information may include information comprising a transmission request command and the symbol information. The location information transmission requesting information receiving portion 1202 is typically implemented as a wireless or wired communication unit, but also may be implemented as a broadcast receiving unit.

The location information acquiring portion 1203 acquires at least one piece of location information associated with the symbol information contained in the location information transmission requesting information that has been received by the location information transmission requesting information receiving portion 1202, based on the management information of the management information storage portion 1201. If the management information contains symbol information and location information as a pair, then the location information acquiring portion 1203 acquires all location information paired with the symbol information contained in the location information transmission requesting information that has been received by the location information transmission requesting information receiving portion 1202. The location information acquiring portion 1203 may retrieve the location information that can be acquired based on the symbol information. There is no limitation regarding the structure of the management information. The location information acquiring portion 1203 can be typically implemented as an MPU or a memory, for example. Typically, the process procedure of the location information acquiring portion 1203 is implemented by software, and the software is stored in a storage medium such as a ROM. Note that the process procedure also may be implemented by hardware (dedicated circuit).

The location information transmitting portion 1204 transmits, to the client device 13, the at least one piece of information that has been acquired by the location information acquiring portion 1203. The location information transmitting portion 1204 is typically implemented as a wireless or wired communication unit, but also may be implemented as a broadcasting unit.

The registration information receiving portion 1205 receives registration information from the client device 13. The registration information typically contains symbol information and location information. The structure of the registration information may be the same as or different from that of the management information. The registration information receiving portion 1205 is typically implemented as a wireless or wired communication unit, but also may be implemented as a broadcast receiving unit.

The accumulation judging portion 1206 judges whether or not management information should be accumulated, based on the registration information that has been received by the registration information receiving portion 1205. It is preferable that the accumulation judging portion 1206 judges that accumulation should be performed only when in the management information storage portion 1201, there is no management information for managing the association between the symbol information and the location information contained in the registration information that has been received by the registration information receiving portion 1205. Furthermore, for example, the accumulation judging portion 1206 judges that accumulation should be performed only when in the management information storage portion 1201, there is no management information containing the symbol information and the location information contained in the registration information that has been received by the registration information receiving portion 1205. Furthermore, the accumulation judging portion 1206 may judge whether or not the management information should be accumulated, based on the client device 13 that has transmitted the registration information. More specifically, for example, the identifiers (client device identifiers) of the client devices 13 with registration permission may be stored in the accumulation judging portion 1206, and the registration information may be received only from the client devices 13 associated with the client device identifiers, so that the management information are accumulated. On the contrary, for example, the identifiers (client device identifiers) of the client device 13 without registration permission may be stored in the accumulation judging portion 1206, and the registration information from devices other than the client devices 13 associated with the client device identifiers may be received, so that the management information are accumulated. Also in these cases, the accumulation judging portion 1206 judges whether or not the management information should be accumulated, based on the registration information that has been received by the registration information receiving portion 1205. The accumulation judging portion 1206 can be typically implemented as an MPU or a memory, for example. Typically, the process procedure of the accumulation judging portion 1206 is implemented by software, and the software is stored in a storage medium such as a ROM. Note that the process procedure also may be implemented by hardware (dedicated circuit).

The management information accumulating portion 1207 accumulates the management information in the management information storage portion 1201 based on the symbol information and the location information contained in the registration information that has been received by the registration information receiving portion 1205. For example, the management information accumulating portion 1207 constructs management information containing the symbol information and the location information contained in the registration information that has been received by the registration information receiving portion 1205, and accumulates the management information in the management information storage portion 1201. It is preferable that the management information accumulating portion 1207 accumulates the management information in the management information storage portion 1201 only when the accumulation judging portion 1206 judges that accumulation should be performed. The management information accumulating portion 1207 can be typically implemented as an MPU or a memory, for example. Typically, the process procedure of the management information accumulating portion 1207 is implemented by software, and the software is stored in a storage medium such as a ROM. Note that the process procedure also may be implemented by hardware (dedicated circuit).

The output instruction reception portion 1301 receives an output instruction on the information. If the information is a file, then the output instruction may be an instruction to open the file. As the input unit of the output instruction, any unit may be used such as ten keys, a keyboard, a mouse, and a menu screen. The output instruction reception portion 1301 can be implemented as a device driver for an input unit such as ten keys and a keyboard, or by control software for a menu screen, for example.

The information outputting portion 1302 outputs the information on which the output instruction has been received by the output instruction reception portion 1301. Furthermore, the information outputting portion 1302 may output information that has been received by the information receiving portion 1309. Here, the term “output” has a concept that includes displaying on a display screen, printing in a printer, outputting a sound, transmission to an external device, and the like. The information outputting portion 1302 may or may not include an output device, such as a display screen and a loudspeaker. It is preferable that the information outputting portion 1302 outputs the information using an application corresponding to the format of the information. In this case, various applications (such as document software, spreadsheet software, database software, and image software) with which various types of information are output are stored in the client device 13, and the information outputting portion 1302 transfers information to an application corresponding to the type of the information that is to be output. The information outputting portion 1302 can be implemented by driver software for an output device, or a combination of driver software for an output device and the output device, for example.

The symbol information reception portion 1303 receives the symbol information. It is preferable that the symbol information reception portion 1303 receives an instruction on the symbol information contained in the output information. It is preferable that the symbol information reception portion 1303 receives the symbol information based on a tracing operation using a pointing device. It is preferable that immediately after the tracing operation is completed, the symbol information reception portion 1303 receives the symbol information. If the tracing operation refers to an operation of moving the coordinates of a mouse pointer while pressing the left button of the mouse, then the phrase “tracing operation is completed” refers to an operation of stopping pressing the left button of the mouse, for example. Herein, the symbol information reception portion 1303 may receive a character string (such as a word) that has been pointed by double-clicking the mouse. Examples of the pointing device include a mouse, a track ball, and a pad. Herein, it is preferable that the symbol information over which the tracing operation is performed is information of a character string. As the input unit of the symbol information, any unit may be used such as ten keys, a keyboard, a mouse, and a menu screen. The symbol information reception portion 1303 can be implemented as a device driver of an input unit such as a mouse and a keyboard, or by control software for a menu screen, for example.

The location information transmission requesting information transmitting portion 1304 transmits, to the server device 12, location information transmission requesting information containing the symbol information that has been received by the symbol information reception portion 1303. Typically, the location information transmission requesting information transmitting portion 1304 constructs location information transmission requesting information containing the symbol information that has been received by the symbol information reception portion 1303, and transmits the location information transmission requesting information to the server device 12. There is no limitation regarding the data structure of the location information transmission requesting information. Information (such as an IP address of the server device 12) for communicating with the server device 12 is typically held in the location information transmission requesting information transmitting portion 1304. The location information transmission requesting information transmitting portion 1304 is typically implemented as a wireless or wired communication unit, but also may be implemented as a broadcasting unit.

The location information receiving portion 1305 receives at least one piece of location information from the server device 12, in response to the location information transmission requesting information that has been transmitted by the location information transmission requesting information transmitting portion 1304. The location information receiving portion 1305 is typically implemented as a wireless or wired communication unit, but also may be implemented as a broadcast receiving unit.

The location-related information outputting portion 1306 outputs at least one piece of location-related information, which is information relating to the at least one piece of location information that has been received by the location information receiving portion 1305. The location-related information may be information that has been received from the server device 12 together with the location information by the location information receiving portion 1305, and may be information of an alias of the location information. Furthermore, the location-related information may be information, indicating “1”, “2” and the like, that specifies the location information, and may be information created by the client device 13. Herein, the location-related information may be the same as the location information. Here, the term “output” has a concept that includes displaying on a display screen, transmission to an external device, and the like. The location-related information outputting portion 1306 may or may not include an output device such as a display screen. The location-related information outputting portion 1306 can be implemented by driver software for an output device, or a combination of driver software for an output device and the output device, for example.

The location-related information instruction reception portion 1307 receives an instruction on at least one piece of location-related information, among the at least one piece of location-related information that has been output by the location-related information outputting portion 1306. An instruction is given, for example, by clicking a pointing device such as a mouse. As the input device of this instruction, any device may be used such as a keyboard, a mouse, and a menu screen. The location-related information instruction reception portion 1307 can be implemented as a device driver for an input unit such as a keyboard, or by control software for a menu screen, for example.

The information transmission requesting portion 1308 makes a request, to the information storage device 11 specified by the location information that has been received by the location information receiving portion 1305, to transmit information. The information transmission requesting portion 1308 may make a request, to the information storage device 11 specified by the location information relating to the location-related information corresponding to the instruction that has been received by the location-related information instruction reception portion 1307, to transmit information. The information transmission requesting portion 1308 is typically implemented as a wireless or wired communication unit, but also may be implemented as a broadcasting unit.

The information receiving portion 1309 receives the requested information from the information storage device 11. Examples of the information include a file. Typically, there is no limitation regarding the type of the file. Examples of the type of the file include an HTML file, a text file, a file for spreadsheet software, a database file, an image file, a moving image file, and a music file. The information receiving portion 1309 is preferably a wireless communication unit, but also can be implemented as a broadcast receiving unit or a wired communication unit. The information receiving portion 1309 can be implemented as a wireless or wired communication unit, for example. The information receiving portion 1309 is typically implemented as a wireless or wired communication unit, but also may be implemented as a broadcast receiving unit.

The registration constructing portion 1310 constructs registration information based on the symbol information that has been received by the symbol information reception portion 1303. The registration information typically contains symbol information and location information. The registration constructing portion 1310 is provided with a location information receiving unit that receives input of the location information, for example. In this case, the registration constructing portion 1310 constructs registration information based on the location information that has been received by the location information receiving unit, and the location information receiving unit. Furthermore, the registration constructing portion 1310 is provided with a location information acquiring unit that acquires the location information of a file containing the symbol information, that is, information containing the identifier (such as an IP address) of the client device 13, the folder name (absolute path) of the file, and the file name of the file. The registration constructing portion 1310 can be typically implemented as an MPU or a memory, for example. Typically, the process procedure of the registration constructing portion 1310 is implemented by software, and the software is stored in a storage medium such as a ROM. Note that the process procedure also may be implemented by hardware (dedicated circuit).

The registration information transmitting portion 1311 transmits, to the server device 12, the registration information that has been constructed by the registration constructing portion 1310. The registration information transmitting portion 1311 is typically implemented as a wireless or wired communication unit, but also may be implemented as a broadcasting unit.

Next, the operation of the information processing system is described.

First, the operation of the information storage device 11 is described. In response to a request from the client device 13, the information transmitting portion 1102 of the information storage device 11 acquires information from the information storage portion 1101, and transmits the information to the client device 13. An information access request containing location information is transmitted from the client device 13. Based on the location information, the information transmitting portion 1102 retrieves the information from the information storage portion 1101, and transmits the information to the client device 13. There is no limitation regarding the protocol for transmitting and receiving the information, and http and telnet, for example, can be applied.

Next, the operation of the server device 12 is described with reference to the flowchart in FIG. 3.

(Step S301) The location information transmission requesting information receiving portion 1202 judges whether or not location information transmission requesting information has been received from the client device 13. If the location information transmission requesting information has been received, then the procedure proceeds to step S302. If the location information transmission requesting information has not been received, then the procedure proceeds to step S306.

(Step S302) The location information acquiring portion 1203 acquires at least one piece of location information associated with symbol information contained in the location information transmission requesting information that has been received in step S301, based on management information of the management information storage portion 1201.

(Step S303) The location information acquiring portion 1203 judges whether or not the at least one piece of location information has been acquired in step S302 (whether or not a predetermined buffer is not null). If the location information has been acquired, then the procedure proceeds to step S304. If the location information has not been acquired, then the procedure proceeds to step S305.

(Step S304) The location information transmitting portion 1204 transmits, to the client device 13, the at least one piece of location information that has been acquired in step S302, or an error message that has been created in step S305.

(Step S305) The location information acquiring portion 1203 constructs an error message to the effect that there is no location information associated with the received symbol information. Herein, for example, information for constructing the error message is held in advance in the location information acquiring portion 1203. The procedure proceeds to step S304.

(Step S306) The registration information receiving portion 1205 judges whether or not registration information has been received from the client device 13. If the registration information has been received, then the procedure proceeds to step S307. If the registration information has not been received, then the procedure returns to step S301.

(Step S307) The accumulation judging portion 1206 judges whether or not management information should be accumulated, based on the registration information that has been received in step S306. For example, the accumulation judging portion 1206 judges that accumulation should be performed only when in the management information storage portion 1201, there is no management information containing symbol information and location information contained in the registration information that has been received in step S306.

(Step S308) The management information accumulating portion 1207 judges whether or not it has been judged in step S307 that accumulation should be performed. If it has been judged that accumulation should be performed, then the procedure proceeds to step S309. If it has been judged that accumulation should not be performed, then the procedure returns to step S301.

(Step S309) The management information accumulating portion 1207 constructs management information, based on the symbol information and the location information contained in the registration information that has been received by the registration information receiving portion 1205. Here, for example, the management information accumulating portion 1207 acquires the location information contained in the registration information that has been received by the registration information receiving portion 1205.

(Step S310) The management information accumulating portion 1207 accumulates, in the management information storage portion 1201, the management information that has been constructed in step S309. Here, for example, the management information accumulating portion 1207 opens a file in which the file name thereof contains the symbol information. Then, the management information accumulating portion 1207 adds the acquired location information to the opened file. The procedure returns to step S301.

Herein, in the flowchart in FIG. 3, if the received registration information should not be accumulated, then an error message may be constructed and transmitted to the client device.

Note that the process is ended by powering off or interruption for aborting the process in the flowchart in FIG. 3.

Next, the operation of the client device 13 is described with reference to the flowchart in FIG. 4.

(Step S401) The output instruction reception portion 1301 judges whether or not an output instruction on information has been received. If the output instruction on the information has been received, then the procedure proceeds to step S402. If the output instruction on the information has not been received, then the procedure proceeds to step S404.

(Step S402) The information outputting portion 1302 acquires, from the information storage portion 1101, the information on which the output instruction has been received by the output instruction reception portion 1301.

(Step S403) The information outputting portion 1302 outputs the information that has been acquired in step S402. The procedure returns to step S401.

(Step S404) The symbol information reception portion 1303 judges whether or not symbol information has been received. If the symbol information has been received, then the procedure proceeds to step S405. If the symbol information has not been received, then the procedure proceeds to step S423.

(Step S405) The location information transmission requesting information transmitting portion 1304 judges the symbol information that has been received in step S404 is symbol information for making a request to the server device 12 to transmit location information. If the symbol information is symbol information for making a request to transmit location information, then the procedure proceeds to step S406. If the symbol information is not symbol information for making a request to transmit location information, then the procedure proceeds to step S419. Herein, the location information transmission requesting information transmitting portion 1304 may always make a request to the server device 12 to transmit location information, without performing judgment in step S405. In this case, for example, a configuration also may be applied in which if the location information is not transmitted from the server device 12, then it is judged that information is to be registered, and the procedure proceeds to step S419. Furthermore, a configuration also may be applied in which the user selects whether to make a request to transmit location information, or to register information. In this case, the user selects items in the menu, for example.

(Step S406) The location information transmission requesting information transmitting portion 1304 constructs location information transmission requesting information containing the symbol information that has been received by the symbol information reception portion 1303.

(Step S407) The location information transmission requesting information transmitting portion 1304 transmits, to the server device 12, the location information transmission requesting information that has been constructed in step S406.

(Step S408) In response to the location information transmission requesting information that has been transmitted in step S407, the location information receiving portion 1305 judges whether or not at least one piece of location information has been received from the server device 12. If the location information has been received, then the procedure proceeds to step S409. If the location information has not been received, then the procedure proceeds to step S417.

(Step S409) The location-related information outputting portion 1306 acquires at least one piece of location-related information, which is information relating to the at least one piece of location information that has been received by the location information receiving portion 1305. The location-related information outputting portion 1306 creates symbols “1”, “2”, “3”, and the like sequentially with respect to the received location information, and regards the symbols as the location-related information. Furthermore, in a case where location information and location-related information are in a pair, the location-related information outputting portion 1306 may acquire the location-related information paired with the location information that has been received by the location information receiving portion 1305.

(Step S410) The location-related information outputting portion 1306 outputs the at least one piece of location-related information that has been acquired in step S409.

(Step S411) The information transmission requesting portion 1308 acquires one piece of location information (typically, first location information), among the at least one piece of location information that has been received by the location information receiving portion 1305.

(Step S412) The information transmission requesting portion 1308 makes a request, to the information storage device 11 specified by the acquired one piece of location information, to transmit information. This request typically includes a request to transmit the entire or a part of the location information.

(Step S413) In response to the request that has been transmitted in step S412, the information receiving portion 1309 judges whether or not the requested information has been received from the information storage device 11. If the requested information has been received, then the procedure proceeds to step S414. If the requested information has not been received, then the procedure proceeds to step S415.

(Step S414) The information outputting portion 1302 outputs the information that has been received in step S413. The procedure returns to step S401.

(Step S415) The information outputting portion 1302 judges whether or not time has run out. If time has run out, then the procedure proceeds to step S416. If time has not run out, then the procedure returns to step S413. Herein, the phrase “time has run out” refers to a state in which the information has not been received at a predetermined time or more after transmitting the request in step S412.

(Step S416) The information outputting portion 1302 constructs and outputs an error message. The procedure returns to step S401.

(Step S417) The location-related information outputting portion 1306 judges whether or not time has run out. If time has run out, then the procedure proceeds step S418. If time has not run out, then the procedure returns to step S408. Herein, the phrase “time has run out” refers to a state in which the location information has not been received at a predetermined time or more after transmitting the location information transmission requesting information in step S407.

(Step S418) The location-related information outputting portion 1306 constructs and outputs an error message. The procedure returns to step S401.

(Step S419) The registration constructing portion 1310 judges whether or not information is to be registered. If the information is to be registered, then the procedure proceeds to step S420. If the information is not to be registered, then the procedure returns to step S401.

(Step S420) The registration constructing portion 1310 acquires location information of the information that is to be registered. The registration constructing portion 1310 may acquire the location information that is input by the user, or may acquire the location information of a file that is open.

(Step S421) The registration constructing portion 1310 constructs registration information, based on the symbol information that has been received in step S404, and the location information that has been acquired in step S420.

(Step S422) The registration information transmitting portion 1311 transmits, to the server device 12, the registration information that has been constructed in step S421. Herein, for example, an IP address and the like of the server device 12 are held in advance in the registration information transmitting portion 1311. The procedure returns to step S401.

(Step S423) The location-related information instruction reception portion 1307 judges whether or not an instruction has been received on at least one piece of location-related information, among the at least one piece of location-related information that has been output by the location-related information outputting portion 1306. If the instruction has been received on at least one piece of location-related information, then the procedure proceeds to step S424. If the instruction has not been received on at least one piece of location-related information, then the procedure returns to step S401.

(Step S424) The information transmission requesting portion 1308 acquires location information associated with the location-related information on which an instruction has been given in step S423. The procedure proceeds to step S412.

Note that the process is ended by powering off or interruption for aborting the process in the flowchart in FIG. 4.

Furthermore, in the flowchart in FIG. 4, the client device 13 outputs both the location information and the information, but also may output only one of them.

Furthermore, in the flowchart in FIG. 4, if the location information associated with the symbol information has not been received, then the operation of the client device 13 may be shifted to an information registration process (process in Step S419 and thereafter) such as displaying a menu for registration of information.

Hereinafter, specific operation of the information processing system in this embodiment is described. FIG. 1 is a conceptual view of the information processing system.

FIG. 5 shows examples of the management information stored in the management information storage portion 1201 of the server device 12. The structure of this management information is a file. In this management information, symbol information is included in a part of the file name. Furthermore, in this management information, at least one piece of location information is described in the file. The location information herein is a URL.

FIG. 6 shows at least one piece of information stored in the information storage portion 1101 of the client device 13. The structure of the information herein is a file. It is here assumed that an output instruction on the information is input by the user of the client device 13. Next, the output instruction reception portion 1301 of the client device 13 receives the output instruction on the information, opens a file of the information, and displays the information on a display screen. FIG. 7 is a view showing a screen on which the information is displayed.

It is then assumed that the user performs a tracing operation with a mouse over symbol information “newspaper” in this file, and then releases the mouse button (see FIG. 7). Then, immediately after the tracing operation is completed, the symbol information reception portion 1303 receives the symbol information “newspaper”.

Next, the location information transmission requesting information transmitting portion 1304 of the client device 13 constructs location information transmission requesting information containing a command “location information request” and the received symbol information “newspaper”. FIG. 8 shows an example of the location information transmission requesting information.

Next, the location information transmission requesting information transmitting portion 1304 transmits the location information transmission requesting information in FIG. 8 to the server device 12. Herein, information such as an IP address and the like of the server device 12, for communicating with the server device 12 is held in advance in the location information transmission requesting information transmitting portion 1304.

Next, the location information transmission requesting information receiving portion 1202 of the server device 12 receives the location information transmission requesting information in FIG. 8.

Next, the location information acquiring portion 1203 tries to acquire, from the management information storage portion 1201 in FIG. 5, at least one piece of location information associated with the symbol information contained in the location information transmission requesting information in FIG. 8. More specifically, the location information acquiring portion 1203 recognizes the command “location information request” in the location information transmission requesting information in FIG. 8, and starts an operation of acquiring the location information. More specifically, the location information acquiring portion 1203 acquires the symbol information “newspaper” contained in the location information transmission requesting information in FIG. 8. Next, the location information acquiring portion 1203 retrieves, from the management information storage portion 1201, a file in which the file name thereof contains the symbol information “newspaper”. Next, the location information acquiring portion 1203 opens the file, and acquires all location information described therein. FIG. 9 shows all of this location information.

Next, the location information transmitting portion 1204 transmits the location information in FIG. 9 to the client device 13.

Next, the location information receiving portion 1305 of the client device 13 receives the location information in FIG. 9 from the server device 12.

Next, the location-related information outputting portion 1306 creates at least one piece of location-related information (“1”, “2”, “3”, “4”, . . . ), which is information relating to the at least one piece of location information that has been received by the location information receiving portion 1305. Here, the location-related information outputting portion 1306 creates information of a number of pieces corresponding to the number of the pieces of received location information.

Next, the location-related information outputting portion 1306 outputs the location-related information (“1”, “2”, “3”, “4”, . . . ). FIG. 10 shows an example of the output of the location-related information and the like. Herein, in the client device 13, the location information is respectively linked to the location-related information (“1”, “2”, “3”, “4”, . . . ).

Next, the information transmission requesting portion 1308 acquires one piece of location information “http://www.NP1.com”, among the at least one piece of location information that has been received by the location information receiving portion 1305. Next, based on the location information “http://www.NP1.com”, the information transmission requesting portion 1308 makes a request, to the corresponding information storage device 11, to transmit information.

Next, the information storage device 11 that can be identified by the location information “http://www.NP1.com” acquires the information that is identified by the location information “http://www.NP1.com” from the information storage portion 1101, and transmits the information to the client device 13.

Next, the information receiving portion 1309 of the client device 13 receives the information that is identified by the location information “http://www.NP1.com”.

Then, the information outputting portion 1302 outputs the received information. The right window in FIG. 10 shows an example of this output.

It is then assumed that an instruction is given on the location-related information “3” by the user of the client device 13 in the example of the screen display in FIG. 10. This instruction is an instruction on location-related information. Next, the location-related information instruction reception portion 1307 receives the instruction on the location-related information “3”.

The information transmission requesting portion 1308 acquires location information “http://121.85.1.58/IMG.gif” associated with the location-related information “3” on which the instruction has been given. Next, the information transmission requesting portion 1308 makes a request, to the information storage device 11 specified by the location information “http://121.85.1.58/IMG.gif”, to transmit image information “IMG.gif”.

Next, the information storage device 11 specified by the location information “http://121.85.1.58/IMG.gif” acquires the image information “IMG.gif”, and transmits the information to the client device 13.

Next, the information receiving portion 1309 receives the information “IMG.gif” from the information storage device 11. Then, the information outputting portion 1302 transfers gif data of the information “IMG.gif” to an application for display. Then, the information “IMG.gif” is displayed on a screen. FIG. 11 shows an example of this display.

It is then assumed that the user of the client device 13 performs a tracing operation over a character string “soccer” in the text file on the screen in FIG. 7.

Next, as described above, the client device 13 tries to acquire location information from the server device 12 based on the symbol information “soccer”. It is here assumed that the location information associated with the symbol information “soccer” is not held in the server device 12.

It is then assumed that the server device 12 transmits, to the client device 13, an error code (or message) to the effect that the location information associated with the symbol information “soccer” is not held.

Next, the client device 13 receives the error code to the effect that the location information associated with the symbol information “soccer” is not held.

Then, the registration constructing portion 1310 of the client device 13 outputs a menu for urging that the information associated with the symbol information “soccer” be registered (see FIG. 12). It is assumed that menu information for displaying the menu is held in advance in the registration constructing portion 1310. Herein, in FIG. 12, the menu is constituted by four following items, that is, “allocate URL address or file”, “create new page”, “allocate image data”, and “not register (cancel)”.

When “allocate URL address or file” is selected, a screen for registration of a URL of information (file) associated with the symbol information “soccer”, or the file itself, is displayed. FIG. 13a shows this screen.

When “create new page” is selected, an editor for creating information (file) associated with the symbol information “soccer” is started. FIG. 13b shows this screen.

When “allocate image data” is selected, a screen for registration of image data associated with the symbol information “soccer” is displayed. FIG. 13c shows this screen.

When “not register (cancel)” is selected, the menu in FIG. 12 is deleted.

Herein, in FIG. 13a, for example, location information “http://www.xxx. . . . ” associated with “soccer” has been input. In this case, the registration constructing portion 1310 constructs registration information shown in FIG. 14a. Then, the registration information transmitting portion 1311 transmits the registration information in FIG. 14a to the server device 12.

Next, the registration information receiving portion 1205 of the server device 12 receives the registration information in FIG. 14a.

Next, the accumulation judging portion 1206 judges whether or not management information should be accumulated, based on the registration information that has been received by the registration information receiving portion 1205. It is here assumed that it is judged that registration should be performed because there is no management information in which the file name thereof contains the symbol information “soccer”. Then, the management information accumulating portion 1207 creates a file in which the file name thereof contains “soccer”, and stores the location information “http://www.xxx. . . . ” in the file. FIG. 15a shows this status.

It is then assumed that in FIG. 13b, the information relating to “soccer” is input by the user of the client device 13 using the editor, and the editor is ended. Next, the registration constructing portion 1310 acquires the location information (URL) of the file that has been created with the editor. Then, the registration constructing portion 1310 constructs the registration information in FIG. 14b, based on the location information (URL) of the file and the symbol information “soccer”. Herein, in FIG. 13b, the symbol information “soccer” has been automatically stored as a first character string constituting the information.

The registration information transmitting portion 1311 transmits the registration information in FIG. 14b to the server device 12.

Next, the registration information receiving portion 1205 of the server device 12 receives the registration information in FIG. 14b.

Next, the accumulation judging portion 1206 judges whether or not management information should be accumulated, based on the registration information that has been received by the registration information receiving portion 1205. Herein, it is judged that registration should be performed because there is no location information “http://188.62.0.21/soccer.txt” in a file in which the file name thereof contains “soccer”. Then, the management information accumulating portion 1207 opens a file “soccer.txt” in which the file name thereof contains “soccer”, and adds the location information “http://188.62.0.21/soccer.txt” to the file.

It is then assumed that in FIG. 13c, the user of the client device 13 drops an image file “soccer.jpeg” onto the lower field in FIG. 13c. Then, the registration constructing portion 1310 constructs the registration information shown in FIG. 14c. It is here assumed that the location information of the image file “soccer.jpeg” is “http://188.62.0.21/soccer.jpeg”.

Next, the registration information transmitting portion 1311 transmits the registration information in FIG. 14c to the server device 12.

Next, the registration information receiving portion 1205 of the server device 12 receives the registration information in FIG. 14c. Furthermore, the accumulation judging portion 1206 judges that management information should be accumulated, based on the registration information that has been received by the registration information receiving portion 1205. Then, the management information accumulating portion 1207 opens the file “soccer.txt” in which the file name thereof contains “soccer”, and adds the location information “http://188.62.0.21/soccer.jpeg” to the file. FIG. 15b shows this status.

Next, for example, when the user of the client device 13 performs a tracing operation over the character string “soccer” on the screen in FIG. 7, and releases the mouse button. Then, the server device 12 is immediately requested to transmit location information associated with the symbol information “soccer”. Next, the server device 12 transmits three pieces of location information associated with the symbol information “soccer” to the client device 13.

Next, the client device 13 receives the three pieces of location information, performs the operation as above, and outputs screen display as in FIG. 10.

As described above, according to this embodiment, when an instruction is given on information, location information associated with the information can be acquired easily.

Furthermore, according to this embodiment, the client device receives at least one piece of location information associated with received symbol information, outputs location-related information relating to the location information, receives information that can be specified by one piece of location information, among the at least one piece of location information, and outputs the information. Thus, information relating to symbol information, the number thereof, and one piece of information can be acquired very easily.

Furthermore, according to this embodiment, it is possible to receive symbol information with a tracing operation using a pointing device, and to acquire information associated with the symbol information. Thus, information can be acquired very easily.

Furthermore, according to this embodiment, it is possible for the client device to receive symbol information immediately after a tracing operation is completed, and to acquire information associated with the symbol information. Thus, information can be accrued extremely easily.

Herein, the operation method described above indicates a following point. Specifically, the client device is an information processing device that receives a tracing operation over symbol information using a pointing device, and that performs a process based on the symbol information immediately after the tracing operation is completed. This process is a retrieval process using the symbol information as a key, performed on an external device (server device in the description above). Furthermore, this process may be other processes such as a process in which the user registers the symbol information as favorite information in the server device, the client device, or the like.

Furthermore, according to this embodiment, in the server device, symbol information is contained in the name of a file, and location information is stored in the file. With this data structure, it is possible to judge at a high speed whether or not there is location information associated with symbol information. Moreover, a system having this data structure can be constructed easily.

Furthermore, in this embodiment, if location information associated with symbol information has not been received, then the operation of the client device is shifted to an information registration process such as displaying a menu for registration of information. With this process, input interfaces for retrieval of information using symbol information and for registration of information can be unified, and thus it is possible to provide a user interface that can be used very easily.

Herein, in this embodiment, as the type of information specified by location information, any type may be applied. More specifically, examples of the information include text data, a still image, a moving image, music, audio, and a behavior module. If the information is text data, a still image, a moving image, music, audio, or the like, then the information outputting portion of the client device outputs the information, or transfers the information to an application (software) for outputting the information. Even when the information outputting portion transfers the information, as a result, the information is output. Furthermore, if the information is a behavior module, then the information outputting portion of the client device performs the information.

The process in this embodiment may be implemented by software. The software may be distributed by software downloading or the like. The software may be distributed in the form where the software is stored in a storage medium such as a CD-ROM. Note that the same is applied to the other embodiments described in this specification. The software that implements the server device in this embodiment may be a following program. Specifically, this program is a program for causing a computer to execute: a location information transmission requesting information receiving step of receiving, from a client device, location information transmission requesting information, which is information containing symbol information and is information for making a request to transmit location information; a location information acquiring step of acquiring at least one piece of location information associated with symbol information contained in the location information transmission requesting information, based on at least one piece of management information that is stored, which is information for managing an association between symbol information and location information, the symbol information being information associated with information stored in at least one information storage device, and the location information being information specifying a location in which the information is stored; and a location information transmitting step of transmitting, to the client device, the at least one piece of location information that has been acquired in the location information acquiring step.

Furthermore, the program may be for further causing a computer to execute: a registration information receiving step of receiving registration information from a client device; and a management information accumulating step of accumulating management information based on symbol information and location information contained in the registration information that has been received in the registration information receiving step.

Furthermore, it is preferable that the program is for further causing a computer to execute an accumulation judging step of judging whether or not management information should be accumulated, based on the registration information that has been received in the registration information receiving step, wherein in the management information accumulating step, the management information is accumulated only when it has been judged that accumulation should be performed in the accumulation judging step.

Furthermore, the software that implements the client device in this embodiment may be a following program. Specifically, this program is a program for causing a computer to execute: a symbol information reception step of receiving symbol information; a location information transmission requesting information transmitting step of transmitting, to a server device, location information transmission requesting information containing the symbol information that has been received in the symbol information reception step; a location information receiving step of receiving at least one piece of location information from the server device; and a location-related information outputting step of outputting at least one piece of location-related information, which is information relating to the at least one piece of location information that has been received in the location information receiving step.

The software that implements the client device may be a program for causing a computer to execute: a symbol information reception step of receiving symbol information; a location information transmission requesting information transmitting step of transmitting, to a server device, location information transmission requesting information containing the symbol information that has been received in the symbol information reception step; a location information receiving step of receiving at least one piece of location information from the server device; an information transmission requesting step of making a request, to an information storage device specified by the location information that has been received in the location information receiving step, to transmit information; an information receiving step of receiving the requested information from the information storage device; and an information outputting step of outputting the information that has been received in the information receiving step.

Furthermore, the program may be for further causing a computer to execute: a location-related information outputting step of outputting at least one piece of location-related information, which is information relating to the at least one piece of location information that has been received in the location information receiving step; and a location-related information instruction reception step of receiving an instruction on at least one piece of location-related information, among the at least one piece of location-related information that has been output in the location-related information outputting step, wherein in the information transmission requesting step, a request to transmit information is made to an information storage device specified by location information relating to location-related information corresponding to the instruction that has been received in the location-related information instruction reception step.

Furthermore, it is preferable that in the information outputting step in the program, the information is output with an application corresponding to a format of the information. With this process, regardless of the format of information (such as text, HTML, XML, an image, audio, or a moving image), information can be acquired and/or registered with a similar interface.

Furthermore, the program may be for further causing a computer to execute: an output instruction reception step of receiving an output instruction on information that is stored; wherein in the information outputting step, information on which the output instruction has been received is further output; and in the symbol information reception step, an instruction on symbol information contained in the output information is further received; a registration constructing step of constructing registration information based on the symbol information that has been received in the symbol information reception step; and a registration information transmitting step of transmitting, to the server device, the registration information that has been constructed in the registration constructing step.

### Embodiment 2

An information processing system in this embodiment is an information processing system provided with at least one information storage device, at least two server devices, and at least one client device. The client device acquires information from the at least one information storage device. The server devices hold location information indicating a location in which the location of information required by the user of the client device is stored. This embodiment is different from Embodiment 1 in that the client device makes a request, to the at least two server devices, to transmit location information. Furthermore, in this embodiment, the client device may select a server device on which retrieval of location information is to be performed, based on symbol information.

FIG. 16 is a block diagram of the information processing system in this embodiment.

This information processing system is provided with the at least one information storage device 11, the at least two server devices 12, and at least one client device 163.

The client device 163 is provided with the output instruction reception portion 1301, the information outputting portion 1302, the symbol information reception portion 1303, a location information transmission requesting information transmitting portion 16304, a location information receiving portion 16305, the location-related information outputting portion 1306, the location-related information instruction reception portion 1307, the information transmission requesting portion 1308, the information receiving portion 1309, the registration constructing portion 1310, the registration information transmitting portion 1311, the information storage portion 1101, a retrieval server device determining portion 16306, and a registration server device determining portion 16307.

The location information transmission requesting information transmitting portion 16304 transmits, to the at least two server devices 12, location information transmission requesting information containing the symbol information that has been received by the symbol information reception portion 1303. Typically, the location information transmission requesting information transmitting portion 16304 constructs location information transmission requesting information based on the symbol information, and transmits the location information transmission requesting information. The location information transmission requesting information transmitting portion 16304 is typically implemented as a wireless or wired communication unit, but also may be implemented as a broadcasting unit.

The location information receiving portion 16305 receives at least one piece of location information from at least one server device 12, among the at least two server devices 12. The location information received by the location information receiving portion 16305 is not necessarily received from all of the server devices 12 to which the location information transmission requesting information has been transmitted. The location information receiving portion 16305 is typically implemented as a wireless or wired communication unit, but also may be implemented as a broadcast receiving unit.

The retrieval server device determining portion 16306 determines at least one server device 12 to which the location information transmission requesting information is to be transmitted, based on the symbol information that has been received by the symbol information reception portion 1303. The retrieval server device determining portion 16306 may determine the server device 12 to which the location information transmission requesting information is to be transmitted, based on the data type of the symbol information, may determine the server device 12 to which the location information transmission requesting information is to be transmitted, based on the language (such as Japanese or English) of the symbol information, or may determine the server device 12 to which the location information transmission requesting information is to be transmitted, based on the data size of the symbol information, for example. There is no limitation regarding a determination method of the retrieval server device determining portion 16306. The retrieval server device determining portion 16306 can be typically implemented as an MPU or a memory, for example. Typically, the process procedure of the retrieval server device determining portion 16306 is implemented by software, and the software is stored in a storage medium such as a ROM. Note that the process procedure also may be implemented by hardware (dedicated circuit).

The registration server device determining portion 16307 determines at least one server device to which the registration information is to be transmitted, based on the information associated with the location information that is to be registered. The registration server device determining portion 16307 may determine the at least one server device to which the registration information is to be transmitted, based on the information type (such as text, an image, or a moving image). Furthermore, the registration server device determining portion 16307 may determine the at least one server device 12 to which the registration information is to be transmitted, based on the symbol information that has been received by the symbol information reception portion 1303. The registration server device determining portion 16307 may determine the server device 12 to which the registration information is to be transmitted, based on the data type of the symbol information, may determine the server device 12 to which the registration information is to be transmitted, based on the language (such as Japanese or English) of the symbol information, or may determine the server device 12 to which the registration information is to be transmitted, based on the data size of the symbol information. There is no limitation regarding a determination method of the registration server device determining portion 16307. The registration server device determining portion 16307 can be typically implemented as an MPU or a memory, for example. Typically, the process procedure of the registration server device determining portion is implemented by software, and the software is stored in a storage medium such as a ROM. Note that the process procedure also may be implemented by hardware (dedicated circuit).

Next, the operation of the information processing system is described. The operation of the information storage device 11 and the server device 12 has been already described.

The operation of the client device 163 is described with reference to the flowchart in FIG. 17. In the flowchart in FIG. 17, only steps that are different from those in the flowchart in FIG. 4 are described.

(Step S1701) The retrieval server device determining portion 16306 determines at least one server device 12 to which the location information transmission requesting information is to be transmitted, based on the information associated with the location information. For example, the retrieval server device determining portion 16306 acquires the language (such as Japanese or English) of the information, and acquires the identifiers of the server devices 12 that are managed for each language.

(Step S1702) The location information transmission requesting information transmitting portion 16304 transmits the location information transmission requesting information to the at least one server device 12 that has been determined in step S1701. The location information transmission requesting information has been constructed in step S406.

(Step S1703) The location information receiving portion 16305 judges whether or not the location information has been received from all of the server devices 12 to which the location information transmission requesting information has been transmitted. If the location information has been received from all of the server devices 12, then the procedure proceeds to step S409. If the location information has not been received from all of the server devices 12, then the procedure proceeds to step S1704.

(Step S1704) The location-related information outputting portion 1306 judges whether or not time has run out. Herein, the phrase “time has run out” refers to a state in which a predetermined time has passed after transmitting the location information transmission requesting information. If time has run out, then the procedure proceeds to step S1705. If time has not run out, then the procedure returns to step S1703.

(Step S1705) The registration constructing portion 1310 judges whether or not there is the location information that has been received by the location information receiving portion 16305. If there is the location information, then the procedure proceeds to step S409. If there is no location information, then the procedure proceeds to step S1706.

(Step S1706) The registration constructing portion 1310 acquires location information of the information that is to be registered. Herein, the location information may be input by the user, or may be location information and the like indicating the location of a file that is currently open. Herein, between step S1705 and step S1706, it is preferable to urge the user to register the information, for example, by displaying a menu as shown in FIG. 12. The operation after displaying a menu as shown in FIG. 12 has been already described in Embodiment 1.

(Step S1707) The registration constructing portion 1310 constructs registration information, based on the location information that has been acquired in step S1706, and the symbol information that has been received in step S404.

(Step S1708) The registration server device determining portion 16307 determines the at least one server device 12 to which the registration information is to be transmitted, based on the information associated with the location information. For example, the registration server device determining portion 16307 acquires the data type (such as text, a still image, a moving image, or audio) of the information associated with the location information that is to be registered, and acquires the identifiers of the server devices 12 that are managed for each data type.

(Step S1709) The registration information transmitting portion 1311 transmits the registration information that has been constructed in step S1707, to the server device 12 that has been determined in step S1708. The procedure returns to step S401.

Herein, in the flowchart in FIG. 17, the location information transmission requesting information transmitting portion 16304 transmits the location information transmission requesting information to the server device 12 that has been determined by the retrieval server device determining portion 16306, but also may transmit the location information transmission requesting information to all of the server devices 12. In this case, the retrieval server device determining portion 16306 is not necessary.

Furthermore, in the flowchart in FIG. 17, the registration information transmitting portion 1311 transmits the registration information to the server device 12 that has been determined by the registration server device determining portion 16307, but also may transmit the registration information to all of the server devices 12. In this case, the registration server device determining portion 16307 is not necessary.

Note that the process is ended by powering off or interruption for aborting the process in the flowchart in FIG. 17.

Hereinafter, specific operation of the information processing system in this embodiment is described.

FIG. 5 shows examples of the management information stored in the management information storage portion 1201 of the server device 12.

FIG. 6 shows at least one piece of information stored in the information storage portion 1101 of the client device 163.

FIG. 18 shows a server information management list held in the client device 163. At least one record containing “language” and “server device” is held in the server information management list. The “language” refers to the language of the symbol information. The “server device” refers to the identifier of the server device 12. With the server information management list, the retrieval server device determining portion 16306 and the registration server device determining portion 16307 acquire the identifier “server device” associated with the “language” that matches the language of the symbol information, and then determine the server device 12.

It is here assumed that an output instruction on the information is input by the user of the client device 163. Next, the output instruction reception portion 1301 of the client device 163 receives the output instruction on the information, opens a file of the information, and displays the information on a display screen. FIG. 7 is a view showing a screen on which the information is displayed.

It is then assumed that the user performs a tracing operation with a mouse on symbol information “newspaper” in this file, and then releases the mouse button (see FIG. 7). Then, immediately after the tracing operation is completed, the symbol information reception portion 1303 receives the symbol information “newspaper”.

Next, the location information transmission requesting information transmitting portion 1304 of the client device 163 constructs location information transmission requesting information containing a command “location information request” and the received symbol information “newspaper”. FIG. 8 shows an example of the location information transmission requesting information.

Next, the retrieval server device determining portion 16306 judges that the language of the symbol information “newspaper” is Japanese. A technique for acquiring the code of the symbol information “newspaper” and determining the language is already known, and thus a detailed description thereof has been omitted.

Next, the retrieval server device determining portion 16306 acquires the server device identifiers “186.210.0.57” and “186.108.1.55” paired with the language “Japanese”, from the server information management list in FIG. 18.

Next, the location information transmission requesting information transmitting portion 1304 transmits the location information transmission requesting information having a structure as shown in FIG. 8, to the two server devices 12 that are identified by the server device identifiers “186.210.0.57” and “186.108.1.55”.

Next, the location information transmission requesting information receiving portions 1202 of the two server devices 12 receive the location information transmission requesting information having a structure as shown in FIG. 8. Next, the two server devices 12 acquire at least one piece of location information associated with the symbol information “newspaper”, and transmit the at least one piece of location information to the client device 163. Next, the client device 163 receives the at least one piece of location information from the two server devices 12, displays location-related information, acquires the information associated with the one piece of location information from the information storage device 11, and outputs the information. The series of operation of the client device 163 is similar to that of the client device 13 in Embodiment 1.

Then, the client device 163 outputs the location-related information and one piece of information as shown in FIG. 10. More specifically, in this embodiment, the two server devices 12 acquire four pieces of location information in total.

The process in which when an instruction is given on the location-related information in FIG. 10 by the user of the client device 163, the information is acquired from the corresponding information storage device 11 and output is similar to that of the client device 13 in Embodiment 1.

It is then assumed that the user of the client device 163 performs a tracing operation over a character string “soccer” in the text file on the screen in FIG. 7.

Next, as described above, the client device 163 tries to acquire location information from the two server devices 12 that are identified by the server device identifiers “186.210.0.57” and “186.108.1.55”, based on the symbol information “soccer”. It is here assumed that the location information associated with the symbol information “soccer” is not held in either one of the two server devices 12.

Then, the registration constructing portion 1310 of the client device 163 outputs a menu for urging that the information associated with the symbol information “soccer” be registered (see FIG. 12). More specifically, in this embodiment, if location information associated with symbol information has not been received, then the operation of the client device 163 is shifted to an information registration process such as displaying a menu for registration of information. With this process, input interfaces for retrieval of information using symbol information and for registration of information can be unified, and thus it is possible to provide a user interface that can be used very easily.

It is here assumed that location information “http://www.xxx. . . . ” associated with “soccer” is input by the user using the screen in FIG. 13a.

Next, the registration constructing portion 1310 constructs registration information shown in FIG. 14a. Then, the registration information transmitting portion 1311 transmits the registration information in FIG. 14a to the two server devices 12 (with the server device identifiers “186.210.0.57” and “186.108.1.55”)

Next, the registration information receiving portions 1205 of the two server devices 12 receive the registration information in FIG. 14a.

Next, the accumulation judging portions 1206 of the two server devices 12 judge whether or not management information should be accumulated, based on the registration information that has been received by the registration information receiving portions 1205. It is here assumed that it is judged that registration should be performed because there is no management information in which the file name thereof contains the symbol information “soccer”. Then, the management information accumulating portions 1207 of the two server devices 12 create a file in which the file name thereof contains “soccer”, and store the location information “http://www.xxx. . . . ” in the file. FIG. 15a shows this status.

Herein, in the registration process of the management information, the same management information is registered in the two server devices 12, but also may be registered only in one the server device 12.

Furthermore, the registration server device determining portion 16307 may determine different server devices 12, depending on the data type (such as image data or text data) of the information associated with the location information, for example.

As described above, according to this embodiment, when an instruction is given on information, location information associated with the information can be acquired easily. Furthermore, according to this embodiment, at least two server devices are used, and thus the load on the server devices can be distributed.

The process in this embodiment may be implemented by software. The software may be distributed by software downloading or the like. The software may be distributed in the form where the software is stored in a storage medium such as a CD-ROM. Note that the same is applied to the other embodiments described in this specification. The software that implements the client device in this embodiment may be a following program. Specifically, this program is a program for causing a computer to execute: a symbol information reception step of receiving symbol information; a location information transmission requesting information transmitting step of transmitting, to at least two server devices, location information transmission requesting information containing the symbol information that has been received in the symbol information reception step; a location information receiving step of receiving at least one piece of location information that has been acquired based on management information, from at least one server device, among the at least two server devices; and a location-related information outputting step of outputting at least one piece of location-related information, which is information relating to the at least one piece of location information that has been received in the location information receiving step.

Furthermore, the software that implements the client device may be a program for causing a computer to execute: a symbol information reception step of receiving symbol information; a location information transmission requesting information transmitting step of transmitting, to at least two server devices, location information transmission requesting information containing the symbol information that has been received in the symbol information reception step; a location information receiving step of receiving at least one piece of location information that has been acquired based on management information, from at least one server device, among the at least two server devices; an information transmission requesting step of making a request, to an information storage device specified by the location information that has been received in the location information receiving step, to transmit information; an information receiving step of receiving the requested information from the information storage device; and an information outputting step of outputting the information that has been received in the information receiving step.

The program may be for further causing a computer to execute: a location-related information outputting step of outputting at least one piece of location-related information, which is information relating to the at least one piece of location information that has been received in the location information receiving step; and a location-related information instruction reception step of receiving an instruction on at least one piece of location-related information, among the at least one piece of location-related information that has been output in the location-related information outputting step, wherein in the information transmission requesting step, a request to transmit information is made to an information storage device specified by location information relating to location-related information corresponding to the instruction that has been received in the location-related information instruction reception step.

The program may be for further causing a computer to execute a retrieval server device determining step of determining at least one server device to which location information transmission requesting information is to be transmitted, based on the symbol information that has been received in the symbol information reception step, wherein in the location information transmission requesting information transmitting step, location information transmission requesting information is transmitted to the at least one server device that has been determined in the retrieval server device determining step.

The program may be for further causing a computer to execute: an output instruction reception step of receiving an output instruction on information that is stored; wherein in the information outputting step, information on which the output instruction has been received is further output; and in the symbol information reception step, an instruction on symbol information contained in the output information is further received; a registration constructing step of constructing registration information based on the symbol information that has been received in the symbol information reception step; and a registration information transmitting step of transmitting, to the server device, the registration information that has been constructed in the registration constructing step.

The program may be for further causing a computer to execute a registration server device determining step of determining at least one server device to which registration information is to be transmitted, based on the information, wherein in the registration information transmitting step, registration information is transmitted to the at least one server device that has been determined in the registration server device determining step.

### Embodiment 3

An information processing system in this embodiment is an information processing system provided with at least two information storage devices and a client device. This information processing system is a peer-to-peer system.

FIG. 19 is a conceptual view of the information processing system in this embodiment. This information processing system is provided with at least two information storage devices 191 (191(1) to 191(n)) and a client device 192.

FIG. 20 is a block diagram of the information processing system in this embodiment.

The information storage device 191 is provided with the information storage portion 1101, the information transmitting portion 1102, the management information storage portion 1201, the location information transmission requesting information receiving portion 1202, the location information acquiring portion 1203, the location information transmitting portion 1204, the output instruction reception portion 1301, the information outputting portion 1302, the symbol information reception portion 1303, a location information reception portion 19101, and a management information accumulating portion 19102.

The client device 192 is provided with the output instruction reception portion 1301, the information outputting portion 1302, the symbol information reception portion 1303, a location information transmission requesting information transmitting portion 19204, a location information receiving portion 19205, the location-related information outputting portion 1306, the location-related information instruction reception portion 1307, the information transmission requesting portion 1308, the information receiving portion 1309, and the information storage portion 1101.

The location information reception portion 19101 receives location information. The location information reception portion 19101 may receive the location information that has been input by the user, or may acquire the location information of the information that has been output by the information outputting portion 1302.

The management information accumulating portion 19102 accumulates the management information in the management information storage portion 1201 based on the symbol information that has been received by the symbol information reception portion 1303 and the location information that has been acquired by the location information reception portion 19101. The management information accumulating portion 19102 may construct and accumulate the management information based on the symbol information and the location information. Furthermore, if the management information is a file in which the file name thereof contains the symbol information, and the location information is stored in the file, then the management information accumulating portion 19102 retrieves a file in which the file name thereof contains the symbol information, opens the file, and adds the location information to the file. The management information accumulating portion 19102 can be typically implemented as an MPU or a memory, for example. Typically, the process procedure of the management information accumulating portion 19102 is implemented by software, and the software is stored in a storage medium such as a ROM. Note that the process procedure also may be implemented by hardware (dedicated circuit).

The location information transmission requesting information transmitting portion 19204 constructs location information transmission requesting information containing the symbol information that has been received by the symbol information reception portion 1303, and transmits the location information transmission requesting information to at least one information storage device 191. It is here assumed that information (such as an IP address of the information storage device 191) for communicating with the at least one information storage device 191 is held in advance in the location information transmission requesting information transmitting portion 19204. The location information transmission requesting information transmitting portion 19204 is typically implemented as a wireless or wired communication unit, but also may be implemented as a broadcasting unit.

The location information receiving portion 19205 receives at least one piece of location information from at least one information storage device 191, among the at least one information storage device 191. The location information receiving portion 19205 is typically implemented as a wireless or wired communication unit, but also may be implemented as a broadcast receiving unit.

Next, the operation of the information processing system is described.

First, the operation of the information storage device 191 is described with reference to the flowchart in FIG. 21. In the flowchart in FIG. 21, with respect to steps that are the same as those in the flowcharts in FIGS. 3 and 4, a description concerning the operation thereof has been omitted.

(Step S2101) The symbol information reception portion 1303 and the location information reception portion 19101 respectively judge whether or not the symbol information and the location information have been received. If the symbol information and the location information have been received, then the procedure proceeds to step S2102. If the symbol information and the location information have not been received, then the procedure proceeds to step S2104.

(Step S2102) The management information accumulating portion 19102 constructs management information, based on the symbol information and the location information that have been received in step S2101.

(Step S2103) The management information accumulating portion 19102 accumulates the management information that has been constructed in step S2102. The procedure returns to step S301.

(Step S2104) The information transmitting portion 1102 judges whether or not the client device 192 has made a request to transmit information. A request to transmit information typically contains location information (such as a URL) indicating the location of the information.

(Step S2105) The information transmitting portion 1102 acquires the information associated with the location information from the information storage portion 1101.

(Step S2106) The information transmitting portion 1102 transmits, to the client device 192, the information that has been acquires in step S2105. The procedure returns to step S301.

Note that the process is ended by powering off or interruption for aborting the process in the flowchart in FIG. 21.

Next, the operation of the client device 192 is described with reference to the flowchart in FIG. 22. In the flowchart in FIG. 22, with respect to steps that are the same as those in the flowchart in FIG. 4, a description concerning the operation thereof has been omitted.

(Step S2201) The location information transmission requesting information transmitting portion 19204 transmits the location information transmission requesting information to all of the information storage devices 191.

(Step S2202) The location information receiving portion 19205 judges whether or not at least one piece of location information has been received from all of the information storage devices 191 to which the location information transmission requesting information has been transmitted. If the at least one piece of location information has been received from all of the information storage devices 191, then the procedure proceeds to step S409. If the location information has not been received, then the procedure proceeds to step S2203.

(Step S2203) The location-related information outputting portion 1306 judges whether or not time has run out. Herein, the phrase “time has run out” refers to a state in which a predetermined time has passed after transmitting the location information transmission requesting information. If time has run out, then the procedure proceeds to step S1705. If time has not run out, then the procedure returns to step S1703.

(Step S2204) The location-related information outputting portion 1306 judges whether or not there is the location information that has been received by the location information receiving portion 19205. If there is the location information, then the procedure proceeds to step S409. If there is no location information, then the procedure proceeds to step S2205.

(Step S2205) The location-related information outputting portion 1306 constructs and outputs an error message. Herein, the error message is held in advance, for example.

Note that the process is ended by powering off or interruption for aborting the process in the flowchart in FIG. 22.

Hereinafter, specific operation of the information processing system in this embodiment is described. FIG. 19 is a conceptual view of the information processing system.

FIG. 5 shows examples of the management information stored in the management information storage portion 1201 of the information storage device 191.

FIG. 6 shows at least one piece of information stored in the information storage portion 1101 of the client device 192. The information herein is a file. It is here assumed that an output instruction on the information is input by the user of the client device 192. Next, the output instruction reception portion 1301 of the client device 192 receives the output instruction on the information, opens a file of the information, and displays the information on a display screen. FIG. 7 is a view showing a screen on which the information is displayed.

It is then assumed that the user performs a tracing operation with a mouse over symbol information “newspaper” in this file, and then releases the mouse button (see FIG. 7). Then, immediately after the tracing operation is completed, the symbol information reception portion 1303 receives the symbol information “newspaper”.

Next, the location information transmission requesting information transmitting portion 19204 of the client device 192 constructs location information transmission requesting information containing a command “location information request” and the received symbol information “newspaper”. FIG. 8 shows an example of the location information transmission requesting information.

Next, the location information transmission requesting information transmitting portion 19204 transmits the location information transmission requesting information in FIG. 8 to at least one information storage device 191. Herein, an IP address and the like of at least one information storage device 191 for communicating with the at least one information storage device 191 are held in advance in the location information transmission requesting information transmitting portion 19204.

Next, each location information transmission requesting information receiving portion 1202 of the at least one information storage device 191 receives the location information transmission requesting information in FIG. 8.

Next, each location information acquiring portion 1203 of the at least one information storage device 191 tries to acquire, from the management information storage portion 1201 in FIG. 5, at least one piece of location information associated with the symbol information contained in the location information transmission requesting information in FIG. 8. More specifically, the location information acquiring portion 1203 recognizes the command “location information request” in the location information transmission requesting information in FIG. 8, and starts an operation of acquiring the location information. More specifically, the location information acquiring portion 1203 acquires the symbol information “newspaper” contained in the location information transmission requesting information in FIG. 8. Next, the location information acquiring portion 1203 retrieves, from the management information storage portion 1201, a file in which the file name thereof contains the symbol information “newspaper”. Next, the location information acquiring portion 1203 opens the file, and acquires all location information described therein.

Next, each location information transmitting portion 1204 of the at least one information storage device 191 transmits the acquired location information to the client device 192.

Next, the location information receiving portion 19205 of the client device 192 receives the location information from the at least one information storage device 191. Herein, the location information receiving portion 19205 does not necessarily receive the location information from all of the information storage devices 191 to which a request to transmit the location information has been made.

Next, the location-related information outputting portion 1306 creates at least one piece of location-related information (“1”, “2”, “3”, “4”, . . . ), which is information relating to the at least one piece of location information that has been received by the location information receiving portion 19205. Here, the location-related information outputting portion 1306 creates information of a number of pieces corresponding to the number of the pieces of received location information.

Next, the location-related information outputting portion 1306 outputs the location-related information (“1”, “2” “3”, “4”, . . . ). FIG. 10 shows an example of the output of the location-related information and the like. Herein, in the client device 192, the location information is respectively linked to the location-related information (“1”, “2”, “3”, “4”, . . . ).

Next, the information transmission requesting portion 1308 of the client device 192 acquires one piece of location information (typically, first location information), among the at least one piece of location information that has been received by the location information receiving portion 19205. Next, based on the location information, the information transmission requesting portion 1308 makes a request, to the corresponding information storage device 191, to transmit information.

Herein, the location information contained in the management information that is held in the information storage device 191 is not necessarily location information (such as information of a folder) that can be accessed by the information storage device 191 itself, and also may be information of the location (such as a folder) of another information storage device 191.

Next, the information storage device 191 that can be identified by the location information acquires the information that is identified by the location information from the information storage portion 1101, and transmits the information to the client device 192.

Next, the information receiving portion 1309 of the client device 192 receives the information that is identified by the location information.

Then, the information outputting portion 1302 outputs the received information. The right window in FIG. 10 shows an example of this output.

Furthermore, the symbol information reception portion 1303 of the information storage device 191, and the location information reception portion 19101 respectively receive symbol information (such as “soccer”) and location information (such as “http://www.xxx. . . . ”). Based on the information, the management information accumulating portion 19102 constructs and accumulates management information (see FIG. 15a).

As described above, according to this embodiment, when an instruction is given on information, location information associated with the information can be acquired easily. Furthermore, according to this embodiment, at least one information storage device is used, and thus the load on the server device can be distributed.

Herein, according to this embodiment, information storage devices and the client device may have the same configuration. In this case, it is possible to provide an environment in which information created by a device is registered in the own device, and information can be shared among these devices.

Furthermore, in this embodiment, a configuration also may be applied in which the client device further comprises an information storage device determining portion for determining at least one information storage device to which location information transmission requesting information is to be transmitted, based on the symbol information that has been received by the symbol information reception portion, and the location information transmission requesting information transmitting portion transmits location information transmission requesting information to the at least one information storage device that has been determined by the information storage device determining portion. This information storage device determining portion may determine the information storage device to which the location information transmission requesting information is to be transmitted, based on the data type or the language of the symbol information, for example. The information storage device determining portion can be typically implemented as an MPU or a memory, for example. Typically, the process procedure of the information storage device determining portion is implemented by software, and the software is stored in a storage medium such as a ROM. Note that the process procedure also may be implemented by hardware (dedicated circuit).

The process in this embodiment may be implemented by software. The software may be distributed by software downloading or the like. The software may be distributed in the form where the software is stored in a storage medium such as a CD-ROM. Note that the same is applied to the other embodiments described in this specification. The software that implements the client device in this embodiment may be a following program. Specifically, this program is a program for causing a computer to execute: a symbol information reception step of receiving symbol information; a location information transmission requesting information transmitting step of transmitting, to at least two information storage devices, location information transmission requesting information containing the symbol information that has been received in the symbol information reception step; a location information receiving step of receiving at least one piece of location information that has been acquired based on management information, from at least one information storage device, among the at least two information storage devices; and a location-related information outputting step of outputting at least one piece of location-related information, which is information relating to the at least one piece of location information that has been received in the location information receiving step.

Furthermore, the software that implements the client device in this embodiment may be a program for causing a computer to execute: a symbol information reception step of receiving symbol information; a location information transmission requesting information transmitting step of transmitting, to at least two information storage devices, location information transmission requesting information containing the symbol information that has been received in the symbol information reception step; a location information receiving step of receiving at least one piece of location information based on management information from at least one information storage device, among the at least two information storage devices; an information transmission requesting step of making a request, to an information storage device specified by the location information that has been received in the location information receiving step, to transmit information; an information receiving step of receiving the requested information from the information storage device; and an information outputting step of outputting the information that has been received in the information receiving step.

Furthermore, the program may be for further causing a computer to execute: a location-related information outputting step of outputting at least one piece of location-related information, which is information relating to the at least one piece of location information that has been received in the location information receiving step; and a location-related information instruction reception step of receiving an instruction on at least one piece of location-related information, among the at least one piece of location-related information that has been output in the location-related information outputting step, wherein in the information transmission requesting step, a request to transmit information is made to an information storage device specified by location information relating to location-related information corresponding to the instruction that has been received in the location-related information instruction reception step.

Furthermore, the program may be for further causing a computer to execute an information storage device determining step of determining at least one information storage device to which location information transmission requesting information is to be transmitted, based on the symbol information that has been received in the symbol information reception step, wherein in the location information transmission requesting information transmitting step, location information transmission requesting information is transmitted to the at least one information storage device that has been determined in the information storage device determining step.

The software that implements the information storage device in this embodiment may be a program for causing a computer to execute: a location information transmission requesting information receiving step of receiving, from a client device, location information transmission requesting information, which is information containing symbol information and is information for making a request to transmit location information; a location information acquiring step of acquiring at least one piece of location information associated with symbol information contained in the location information transmission requesting information, based on at least one piece of management information that is stored, which is information for managing an association between symbol information and location information, the symbol information being information associated with information that is stored, and the location information being information specifying a location in which the information is stored; and a location information transmitting step of transmitting, to the client device, the at least one piece of location information that has been acquired in the location information acquiring step.

In the foregoing embodiments, each process (each function) may be performed by a centralized process using a single device (system), or may be performed by a distributed process using multiple devices.

Note that in the above-described program, the transmitting step of transmitting information, the receiving step of receiving information, and the like do not include a process performed by hardware, such as a process in the transmitting step performed in a modem, an interface card, or the like (a process performed only by hardware).

The program may be executed by a single or multiple computers. In other words, the program may be executed by either a centralized process or a distributed process.

Furthermore, in the foregoing embodiments, it would be appreciated that two or more communication units (such as information transmitting portions) in one device may be physically implemented by one medium.

The present invention is not limited to the embodiments set forth herein. Various modifications are possible within the scope of the present invention.

### Embodiment 4

FIG. 23 is a block diagram of an information processing system in this embodiment.

The information processing system is provided with a client device 10 and a server device 20. The devices can transmit and receive information. The devices are connected to each other via a network 30 such as the Internet. Note that a unit for transmitting and receiving information may be a communication unit or a broadcasting unit, for example.

The client device 10 is provided with an output instruction reception portion 110, an outputting portion 111, a storage portion 112, a character string specification reception portion 113, a keyword information acquiring portion 114, a related information reception portion 115, an accumulation information receiving portion 116, and a transmitting portion 117.

The server device 20 is provided with a receiving portion 210, a first accumulating portion 211, and an accumulation information transmitting portion 212.

The output instruction reception portion 110 receives an output instruction on main information, which is information including a character string. Examples of the main information include a file. Data including a character string or the like useful for the user is stored in the file. Examples of the main information other than a file may include a database. If the main information is a file, then the file may be constituted by information containing only a character string, or may include information such as an image, in addition to a character string. The type of the file may be text, a file for word processor software, a file for spreadsheet software, an HTML file, or an XML file. More specifically, there is no limitation regarding the type of the file. If the main information is a file, then the output instruction may be an instruction to open the file. As the input unit of the output instruction, any unit may be used such as a mouse, ten keys, a keyboard, and a menu screen. The output instruction may include information specifying the main information that is to be output. Examples of the information specifying the main information include whereabouts information, which is information indicating the whereabouts of the main information, more specifically, a URL, a URI, an IP address, directory information, or the like. The main information that is to be output may be stored inside the client device 10, or may be stored in another device or the like on the network. The output instruction reception portion 110 can be implemented as a device driver for an input unit such as a mouse and a keyboard, or by control software for a menu screen, for example.

The outputting portion 111 outputs the main information based on the output instruction. More specifically, the outputting portion 111 acquires and outputs the main information. There is no limitation regarding the source from which the outputting portion 111 acquires the main information. If information specifying the main information that is to be output is included in the output instruction, then the outputting portion 111 typically acquires and outputs the main information specified by the output instruction. It is also possible that information for making a request to transmit the main information is output to a device and the like at the location indicated by the whereabouts information included in the output instruction, and then the main information that has been transmitted from another device such as a web server in response to this information is acquired and output. Herein, a case is described in which the outputting portion 111 acquires the main information from the storage portion 112 described below, and outputs the main information. The outputting portion 111 may acquire and output predetermined main information. The outputting portion 111 may or may not include an output device such as a display screen. The outputting portion can be implemented by driver software for an output device, or a combination of driver software for an output device and the output device, for example. Here, the term “output” has a concept that includes displaying on a display screen, transmission to an external device, and the like.

Main information, which is information including a character string, can be stored in the storage portion 112. In the storage portion 112, the main information may be stored in advance, or the main information that has been transmitted from another device such as a web server may be accumulated. It is also possible that when a transmitting portion (not shown) in the client device 10 outputs a request for an HTML file to a particular web server, the HTML file that has been transmitted by the web server in response thereto is received by a receiving portion (not shown) and is stored in the storage portion 112, for example. Here, the term “store” has a concept that also includes temporary storage performed when receiving data that has been transmitted from another device, for example. The storage portion 112 may be a volatile storage medium or may be a non-volatile storage medium.

The character string specification reception portion 113 receives a character string specification instruction, which is an instruction to specify a character string, in the main information that has been output by the outputting portion 111. It is preferable that the character string specification reception portion 113 receives an instruction to specify a character string, in the main information that has been selected by dragging using a pointing device. Here, the term “dragging” refers to an operation in which main information, more specifically, a character string is traced using a pointing device such as a mouse. Examples of the “dragging” include an operation of moving the coordinates of a mouse pointer while pressing the left button of the mouse. If the dragging refers to an operation of moving the coordinates of a mouse pointer while pressing the left button of the mouse, then the phrase “dragging is completed” may refer to an operation of stopping pressing the left button of the mouse, that is, an operation of releasing the mouse button. Typically, when dragging is performed over information of a character string, a character string is selected at locations through which the mouse pointer has moved while the left button is pressed, and the character string is highlighted. For example, a character string specification instruction to specify a character string that has been selected by dragging, is received by the character string specification reception portion 113 immediately after the dragging using, as a trigger and the like, an operation of completing the dragging, such as an operation of releasing the mouse button. Other examples of the “dragging” also may include an operation of moving the mouse pointer without pressing a mouse button. In this case, for example, the start point of the “dragging” is at the coordinates where the mouse pointer is first at rest for a predetermined time or more, and the end point of the “dragging” is at the coordinates where the mouse pointer is next at rest for a predetermined time or more. Herein, the character string specification reception portion 113 may receive a character string specification instruction on a character string in a rectangular area in which two points clicked with a mouse and the like serve as diagonally opposing corners. The character string specification reception portion 113 may receive an instruction to specify a character string (such as a word) that has been pointed by double-clicking the mouse. Examples of the pointing device include a mouse, a track ball, and a pad. As the input device of the character string specification instruction, any unit may be used such as a mouse, ten keys, a keyboard, and a menu screen. The character string specification reception portion 113 can be implemented as a device driver of an input unit such as a mouse and a keyboard, or by control software for a menu screen, for example.

The keyword information acquiring portion 114 acquires keyword information, which is information of a character string specified by the character string specification instruction. For example, the keyword information acquiring portion 114 acquires information of a character string specified by the character string specification instruction in the main information that has been acquired by the outputting portion 111, and regards the information of the character string as the keyword information. For example, when the character string specification reception portion 113 receives a character string specification instruction on a character string that has been selected by dragging, the keyword information acquiring portion 114 acquires, as the keyword information, the character string that has been selected by dragging. There is no limitation regarding a timing or trigger for the keyword information acquiring portion 114 to acquire a keyword, but it is preferable that keyword information is acquired immediately after the character string specification reception portion 113 receives character string specification. For example, the keyword information acquiring portion 114 acquires the keyword information using, as a trigger and the like, reception of the character string specification by the character string specification reception portion 113. Accordingly, for example, immediately after dragging is completed, the character string specification reception portion 113 receives the character string specification instruction, and the keyword information acquiring portion 114 acquires the keyword information. The keyword information acquiring portion 114 can be typically implemented as an MPU or a memory, for example. Typically, the process procedure of the keyword information acquiring portion is implemented by software, and the software is stored in a storage medium such as a ROM. Note that the process procedure also may be implemented by hardware (dedicated circuit).

The related information reception portion 115 receives related information, which is information relating to the keyword information. There is no limitation regarding the relationship between the keyword information and the related information. For example, the related information may be information explaining a word in the keyword information, or may be a URL of an HTML file in which the word is explained. Furthermore, the related information may be information of a photograph or an illustration for illustrating the keyword information as an image. Furthermore, the relationship between the keyword information and the related information may be obtained based on subjective judgment by the user, or it may be judged based on a predetermined condition that there is the relationship therebetween, for example. The related information may be text, a still image or a moving image constituted by bitmap or vector, video, music, audio, or the like. There is no limitation regarding whether or not the related information is a file, and also may be a character string that has been copied from text information, for example. Furthermore, the related information may be information for indicating the whereabouts of predetermined information relating to the keyword information, for example, address information such as a URL, a URI, or an IP address, or a combination of address information and information for identifying a file such as the file name. It is preferable that using, as a trigger and the like, acquisition of the keyword information by the keyword information acquiring portion 114, the related information reception portion 115 outputs a menu or dialogue for urging that the related information be input, immediately after the keyword information is acquired. It is also possible that the related information reception portion 115 judges whether or not the keyword information is stored in the server device 20, based on the accumulation information that has been received by the accumulation information receiving portion 116 described below, and receives the related information only when it is judged that the keyword information has not been accumulated. The accumulation information is described later. In this case, it is preferable that the related information reception portion 115 outputs a menu or dialogue for urging that the related information be input, using, as a trigger and the like, the judgment that the keyword information has not been accumulated. As the input unit of the related information, any unit may be used such as ten keys, a keyboard, a mouse, and a menu screen. The related information reception portion 115 can be implemented as a device driver for an input unit such as ten keys and a keyboard, or by control software for a menu screen, for example.

The accumulation information receiving portion 116 receives accumulation information that indicates whether or not the keyword information has been accumulated, and that has been transmitted from the server device 20 described below. Specifically, the accumulation information is information indicating whether or not keyword information matching the keyword information that has been acquired by the keyword information acquiring portion 114 has been accumulated in the server device 20. The accumulation information receiving portion 116 may receive the accumulation information from multiple server devices. In this case, the related information reception portion 115 may receive the related information only when all of the accumulation information indicates that the keyword information has not been accumulated. Alternatively, the related information reception portion 115 may receive the related information when there is at least one piece of accumulation information indicating that the keyword information has not been accumulated. More specifically, in response to the keyword information that has been transmitted by the transmitting portion 117, the accumulation information receiving portion 116 receives the accumulation information that has been transmitted from the server device 20. The accumulation information receiving portion 116 is typically implemented as a wireless or wired communication unit, but also may be implemented as a broadcast receiving unit.

The transmitting portion 117 transmits the related information and the keyword information as a pair to the server device 20. More specifically, the transmitting portion 117 transmits the keyword information that has been acquired by the keyword information acquiring portion 114 and the related information that has been received by the related information reception portion 115, as a pair to the server device 20. Information indicating the whereabouts of the server device 20 to which the related information and the keyword information are to be transmitted from the transmitting portion 117 may be selected in advance, or may be acquired as the whereabouts information, of the server device 20 serving as transmission destination, that has been received by the related information reception portion 115, for example. There is no limitation regarding a timing or trigger for the transmitting portion 117 to transmit the related information and the keyword information as a pair. For example, they may be transmitted when a reception portion (not shown) receives a transmission instruction from the user. Alternatively, they may be transmitted when the related information reception portion 115 receives the related information. Furthermore, any configuration may be applied as the configuration in which the related information and the keyword information as a pair are transmitted by the transmitting portion 117. For example, it is possible that a file including the related information is constructed, provided with the file name constituted by a keyword indicated by the keyword information, and then transmitted. It is also possible to construct and transmit a file including the related information and the keyword. It is also possible to construct and transmit respective files of the related information, the keyword, and the information for managing the association therebetween. Herein, in a case where multiple server devices are used, the related information and the keyword information as a pair may be transmitted to all of the server devices. Alternatively, the related information and the keyword information as a pair may be transmitted only to a server device that has been judged by the accumulation information receiving portion 116 not to have the keyword information accumulated therein. Furthermore, the transmitting portion 117 may transmit, to the server device 20, the keyword information that has been acquired by the keyword information acquiring portion 114. More specifically, using, as a trigger and the like, acquisition of the keyword information by the keyword information acquiring portion 114, the transmitting portion 117 may transmit the acquired keyword information to the server device 20 after the keyword information acquiring portion 114 acquires the keyword information, or preferably immediately after the acquisition. Herein, in a case where multiple server devices are used, the keyword information may be transmitted to all of the server devices. Furthermore, information that includes the keyword information, and that is for inquiring of the server device 20 whether or not there is the keyword information may be transmitted to the server device 20. The transmitting portion 117 is typically implemented as a wireless or wired communication unit, but also may be implemented as a broadcasting unit.

The receiving portion 210 receives the related information and the keyword information as a pair. The receiving portion 210 is typically implemented as a wireless or wired communication unit, but also may be implemented as a broadcast receiving unit.

The first accumulating portion 211 stores the related information and the keyword information as a pair in association with each other. The first accumulating portion 211 accumulates the related information and the keyword information, for example, in a hard disk, or a non-volatile or volatile storage medium such as a memory (not shown) inside the server device 20. Furthermore, the first accumulating portion 211 may accumulate the related information and the keyword information in different storage media. They also may be accumulated in a removable storage medium such as a CD-R. Alternatively, they may be stored in an information storage device that is provided outside the server device 20, that is provided with a storage portion such as a hard disk and a memory in which information can be stored, and that is a device in which information is to be stored, for example. Any method may be applied as the method by which the first accumulating portion 211 manages the association between the related information and the keyword information as a pair. For example, the association between the related information and the keyword information as a pair may be managed by providing a file including the related information with the file name constituted by a keyword indicated by the keyword information, and accumulating the file in a storage medium. Alternatively, the first accumulating portion 211 may manage the association between the related information and the keyword information as a pair, by constructing management information containing the association between the related information and the keyword information, and accumulating the management information in a storage medium or the like. Furthermore, when the keyword information from the client device 10 is received, the receiving portion 210 may judge whether or not the received keyword information has been accumulated in a storage medium in which the keyword information is to be accumulated. For example, if there is keyword information matching the received keyword information in a storage medium, then the first accumulating portion 211 judges that keyword information that is the same as the received keyword information has been accumulated, and if there is no matching keyword information, then it is judged that keyword information that is the same as the received keyword information has not been accumulated. The first accumulating portion 211 can be typically implemented as an MPU or a memory, for example. Typically, the process procedure of the first accumulating portion 211 is implemented by software, and the software is stored in a storage medium such as a ROM. Note that the process procedure also may be implemented by hardware (dedicated circuit).

Based on the judgment results of the first accumulating portion 211, the accumulation information transmitting portion 212 constructs accumulation information and transmits the accumulation information to the client device 10. As described above, the accumulation information is information indicating whether or not keyword information matching the keyword information that has been transmitted from the client device 10 has been accumulated in the server device 20. Examples of the accumulation information may include a predetermined code or message. For example, if the first accumulating portion 211 judges that the received keyword information has been accumulated, then accumulation information indicating that a keyword that is the same as the keyword information that has been acquired by the keyword information acquiring portion 114 has been accumulated in the server device 20 is constructed and transmitted. If the first accumulating portion 211 judges that the received keyword information has not been accumulated, then accumulation information indicating that a keyword that is the same as the keyword information that has been acquired by the keyword information acquiring portion 114 has not been accumulated in the server device 20 is constructed and transmitted. Herein, the accumulation information transmitting portion 212 may transmit an error code, an error message, or the like only when the keyword information has been already accumulated. In this case, the related information reception portion 115 may judge that the keyword information has not been accumulated only when an error code or the like has not been received by the accumulation information receiving portion 116 at a predetermined time after transmitting the keyword information. Alternatively, a code or message indicating that the keyword information has not been accumulated may be transmitted only when the keyword information has not been accumulated. In this case, the related information reception portion 115 may judge that the keyword information has not been accumulated only when such a code is received by the accumulation information receiving portion 116. Furthermore, in a case where multiple client devices are used, the accumulation information transmitting portion 212 transmits the accumulation information to the client device serving as transmission-source from which the keyword information was transmitted. The accumulation information transmitting portion 212 is typically implemented as a wireless or wired communication unit, but also may be implemented as a broadcasting unit.

Next, the operation of the client device 10 in the information processing system is described with reference to the flowchart in FIG. 24.

(Step S2401) The output instruction reception portion 110 judges whether or not an output instruction has been received. If the output instruction has been received, then the procedure proceeds to step S2402. If the output instruction has not been received, then the procedure proceeds to step S2404.

(Step S2402) The outputting portion 111 acquires main information based on the output instruction that has been received in step S2401. If the output instruction includes information specifying main information stored in the storage portion 112, then the main information on which the instruction is given is acquired from the storage portion 112.

(Step S2403) The outputting portion 111 outputs the main information that has been acquired in step S2402. The procedure returns to step S2401.

(Step S2404) The character string specification reception portion 113 judges whether or not a character string specification instruction has been received. If the character string specification instruction has been received, then the procedure proceeds to step S2405. If the character string specification instruction has not been received, then the procedure returns to step S2401.

(Step S2405) The keyword information acquiring portion 114 acquires keyword information, which is information of a character string specified by the character string specification instruction, for example, from the main information that has been acquired by the outputting portion 111.

(Step S2406) The transmitting portion 117 transmits the keyword information that has been acquired in step S2405.

(Step S2407) The accumulation information receiving portion 116 judges whether or not accumulation information has been received. If the accumulation information has been received, then the procedure proceeds to step S2408. If the accumulation information has not been received, then the procedure returns to step S2407. Herein, if the accumulation information has not been received for a predetermined time, then the procedure may return to step S2401 regarding this state as time-out.

(Step S2408) The related information reception portion 115 judges whether or not related information should be received, by judging whether or not keyword information has been accumulated in the server device 20, based on the accumulation information that has been received in step S2407. For example, only when the accumulation information is information indicating that keyword information that is the same as the keyword information that has been transmitted in step S2406 has not been accumulated yet, it is judged that the keyword information has not been accumulated, and that the related information should be received. Otherwise, it is judged that the related information cannot be received. If the related information should be received, then the procedure proceeds to step S2409. If the related information cannot be received, then the procedure returns to step S2401.

(Step S2409) The related information reception portion 115 judges whether or not the related information and accumulation-destination specification have been received. If they have been received, then the procedure proceeds to step S2410. If they have not been received, then the procedure returns to step S2409. Herein, before the process in step S2409, a dialogue for urging that the related information be input, an input screen, and the like may be output. Furthermore, if accumulation-destination of the related information is fixed, then it is not necessary to receive the accumulation-destination specification.

(Step S2410) The transmitting portion 117 transmits the keyword information that has been acquired in step S2405 and the related information that has been received in step S2409 as a pair, to a device specified by the accumulation-destination specification that has been received in step S2409, for example, to the server device 20. The procedure returns to step S2401.

Herein, in the flowchart in FIG. 24, in a case where a duplicate pair of the keyword information and the related information may be stored in the server device 20, it is possible not to perform the processes from step S2406 to step S2408.

Note that the process is ended by powering off or interruption for aborting the process in the flowchart in FIG. 24.

Next, the operation of the server device 20 in the information processing system is described with reference to the flowchart in FIG. 25.

(Step S2501) The receiving portion 210 judges whether or not keyword information has been received. If the keyword information has been received, then the procedure proceeds to step S2502. If the keyword information has not been received, then the procedure proceeds to step S2506.

(Step S2502) The first accumulating portion 211 judges whether or not the keyword information that has been received in step S2501 has been already accumulated in a storage medium or the like. If the keyword information has been accumulated, then the procedure proceeds to step S2503. If the keyword information has not been accumulated, then the procedure proceeds to step S2505.

(Step S2503) The accumulation information transmitting portion 212 constructs accumulation information indicating that keyword information that is the same as the keyword information that has been received in step S2501 has been already accumulated.

(Step S2504) The accumulation information transmitting portion 212 transmits the constructed accumulation information to transmission-source of the keyword information, in this embodiment, to the client device 10. The procedure returns to step S2501.

(Step S2505) The accumulation information transmitting portion 212 constructs accumulation information indicating that keyword information that is the same as the keyword information that has been received in step S2501 has not been accumulated yet. The procedure proceeds to step S2504.

(Step S2506) The receiving portion 210 judges whether or not the keyword information and the related information as a pair have been received. If they have been received, then the procedure proceeds to step S2507. If they have not been received, then the procedure returns to step S2501.

(Step S2507) Based on the keyword information and the related information as a pair that have been acquired in step S2506, the first accumulating portion 211 accumulates the keyword information and the related information as a pair in a storage medium or the like. The procedure returns to step S2501.

Herein, in the flowchart in FIG. 25, in a case where a duplicate pair of the keyword information and the related information may be stored in the server device 20, it is possible not to perform the processes from step S2501 to step S2504.

Note that the process is ended by powering off or interruption for aborting the process in the flowchart in FIG. 25.

Hereinafter, specific operation of the information processing system in this embodiment is described. FIG. 26 is a conceptual view of this information processing system.

FIG. 27 is a view showing at least one piece of main information stored in the storage portion 112 of the client device 10. The structure of the main information herein is a file. It is here assumed that an output instruction on the main information is input by the user of the client device 10. Next, the output instruction reception portion 110 of the client device 10 receives the output instruction on the main information, and the outputting portion 111 opens a file of image information and displays the main information on a display screen. FIG. 28 is a view showing a screen on which the main information is displayed.

It is then assumed that as shown in FIG. 28, the user performs dragging with a mouse over a character string “soccer” in this file, and then releases the mouse button. Then, immediately after the dragging is completed, the character string specification reception portion 113 receives specification on the character string “soccer”. The keyword information acquiring portion 114 acquires the character string “soccer” and regards the character string as the keyword information.

The transmitting portion 117 transmits the keyword information “soccer” to the server device 20. Herein, information such as an IP address and the like of the server device 12, for communicating with the server device 12 is held in advance in the transmitting portion 117.

Next, the receiving portion 210 of the server device 20 receives the keyword information “soccer”. Then, the first accumulating portion 211 judges whether or not the keyword information “soccer” has been already accumulated in a storage medium or the like. Herein, it is judged that the keyword information “soccer” has not been accumulated.

Based on the judgment results of the first accumulating portion 211, the accumulation information transmitting portion 212 constructs accumulation information indicating that the keyword information “soccer” has not been accumulated, and transmits the constructed accumulation information to the client device 10 that is transmission source of the keyword information “soccer”. An IP address and the like for communicating with the client device 10 may be transmitted to the server device 20 when the client device 10 transmits the keyword information, for example. Furthermore, the accumulation information may be transmitted to all devices that are connected to the server device 20 via the network.

The client device 10 receives the accumulation information indicating that the keyword information “soccer” has not been accumulated.

Based on the accumulation information, the related information reception portion 115 of the client device 10 judges that the keyword information “soccer” has not been accumulated in the server device 20, and outputs a menu for urging that related information relating to the keyword information “soccer” be registered as shown in FIG. 29. It is assumed that menu information for displaying the menu is held in advance in the related information reception portion 115. Herein, in FIG. 29, the menu is constituted by four following items, that is, “allocate URL address or link to file”, “input new information”, “allocate file”, and “not register (cancel)”.

When “allocate URL address or link to file” is selected, a screen for registration of a URL of related information (file) relating to the keyword information “soccer”, or a link to the file is displayed. FIG. 30a shows this screen.

When “input new information” is selected, an editor for creating information relating to the keyword information “soccer” is started. FIG. 30b shows this screen.

When “allocate file” is selected, a screen for registration of a file associated with the keyword information “soccer” is displayed. FIG. 30c shows this screen.

When “not register (cancel)” is selected, the menu in FIG. 29 is deleted.

Herein, in FIG. 30a, whereabouts information “http://www.xxx. . . . ”, which is information indicating the whereabouts, associated with “soccer” has been input, for example. In this case, the transmitting portion 117 constructs information in which keyword information and related information, in this embodiment, whereabouts information are paired as shown in FIG. 31a. Then, the transmitting portion 117 transmits the information in FIG. 31a to the server device 20.

Next, the receiving portion 210 of the server device 20 receives the information in FIG. 31a. Next, the first accumulating portion 211 creates a file in which the file name thereof contains keyword information “soccer.txt”, stores the whereabouts information “http://www.xxx. . . . ” in the file, and accumulates the file. FIG. 32a shows this status. In this manner, a keyword and location information are contained in information of one file, and thus the search engine can acquire location information associated with a keyword, and the load on the server device 20 can be reduced.

Herein, in a case where a link to a file stored inside the client device 10 is allocated, whereabouts information such as a URL indicating the whereabouts of the file inside the client device 10 may be input instead of the whereabouts information in FIG. 30a. The input of this whereabouts information and the like may be received by dragging and dropping the file onto an input field, for example. For example, an IP address of the client device 10 is “188.62.0.21” and the file name of the file that has been dragged and dropped is “goal.txt”, when dragging and dropping this file, whereabouts information “http://188.62.0.21/goal.txt” is input. When the whereabouts information is transmitted to the server device 20, the whereabouts information indicating the link to the file “goal.txt” inside the client device 10 can be accumulated in the server device 20 as related information relating to the keyword information “soccer”.

It is then assumed that in FIG. 30b, the user of the client device 10 inputs related information relating to “soccer” such as text “Soccer originated in England . . . ” using an editor, and selects “transmit” in the menu. The transmitting portion 117 constructs information as shown in FIG. 31b, and transmits the information to the server device 20. Herein, in FIG. 30b, the keyword information “soccer” has been automatically stored as a first character string constituting the information.

Then, the transmitting portion 117 transmits the registration information in FIG. 31b to the server device 20.

Next, the receiving portion 210 of the server device 20 receives the registration information in FIG. 3 lb.

The first accumulating portion 211 creates a file “soccer.txt” in which the file name thereof contains “soccer”, stores the related information “Soccer originated in England . . . ” in the file, and accumulates the file. Herein, it is also possible that a file “soccer.txt” in which the file name thereof contains the keyword information “soccer” is created, a file in which the file name thereof contains related information other than the keyword information “soccer” is constructed and accumulated inside the server device 20, and the whereabouts information such as a URL specifying storage destination of the accumulated file containing the related information is stored in the created file “soccer.txt”. FIG. 32b shows this status.

It is then assumed that in FIG. 30c, the user of the client device 10 drops an icon or the like of an image file “shoot.jpeg” onto the lower field in FIG. 30c, as a file that is to be allocated. Then, the transmitting portion 117 constructs information in which keyword information and an image file are paired as shown in FIG. 31c.

Next, the transmitting portion 117 transmits the information in FIG. 31c to the server device 20.

The receiving portion 210 of the server device 20 receives the information shown in FIG. 31c. Then, the first accumulating portion 211 changes the file name of the image file “shoot.jpeg” into the keyword information “soccer”, and accumulates the file. Herein, for the sake of convenience, the file name is changed into “soccer.jpeg” in order to clarify the file type, and the file is accumulated. Herein, it is also possible that the first accumulating portion 211 creates a file “soccer.txt” in which the file name thereof contains the keyword information “soccer”, accumulates an image file “shoot.jpeg”, which is the related information, into a storage medium or the like, and stores the whereabouts information such as a URL specifying storage destination of the related information, in the created file “soccer.txt”. FIG. 32c shows this status.

Here, a case is described in which the keyword information “soccer” has been accumulated inside the server device 20. In this case, when the server device 20 receives the keyword information, the first accumulating portion 211 judges that the keyword information “soccer” has been already accumulated in a storage medium or the like. Then, based on the judgment results of the first accumulating portion 211, the accumulation information transmitting portion 212 constructs accumulation information indicating that the keyword information “soccer” has been accumulated, and transmits the accumulation information to the client device 10.

The client device 10 receives the accumulation information indicating that the keyword information “soccer” has been accumulated. The related information reception portion 115 judges that the keyword information “soccer” has been accumulated in the server device 20, based on the accumulation information. Then, the related information reception portion 115 determines not to receive the related information, and outputs a dialogue “keyword “soccer” has been already registered” as shown in FIG. 33, and ends the process.

As described above, according to this embodiment, when a character string in main information is specified, it is possible to register related information using the character string as keyword information. Thus, it is no more necessary to input keyword information using a keyboard or the like, and thus keyword information and related information relating thereto can be registered easily.

If an interesting character string is found while accessing to main information, related information can be registered while specifying this character string, and thus related information associated with a character string can be registered based on intuitive operation.

Furthermore, immediately after specifying a character string, it is judged that whether or not the character string is to be registered as keyword information, and related information is received only when registration should be performed. Thus, it is possible to efficiently register related information by restricting new registration of related information associated with keyword information in a state where related information associated with this keyword information has been already registered. Moreover, it is possible to eliminate unnecessary registration operation.

Furthermore, according to this embodiment, for example, a keyword and location information are contained in information of one file, and thus the search engine can acquire location information associated with a keyword, and the load on the server device 20 can be reduced.

Herein, in Embodiment 4 described above, as shown in FIG. 34, it is also possible that the client device 10 is further provided with a second accumulating portion 118, the related information reception portion 115 receives accumulation-destination specification, which is an instruction to specify the client device 10 or the server device 20 as accumulation-destination of keyword information and related information, and the keyword information and the related information as a pair are accumulated in the client device 10 or the server device 20 that is specified by the selective instruction.

In this case, the related information reception portion 115 receives the accumulation-destination specification that specifies the client device 10 or the server device 20 as accumulation-destination of the related information and the keyword information as a pair. More specifically, as accumulation-destination, the accumulation-destination specification may specify the client device 10, that is, the own device, or the server device 20, or also may specify directory for specifying a storage portion in these devices, for example. Furthermore, the accumulation-destination specification also may specify whereabouts information such as an IP address for specifying the server device 20 that serves as the accumulation-destination.

Furthermore, the second accumulating portion 118 provided inside the client device 10 accumulates the related information and the keyword information as a pair, if the accumulation-destination specification that has been received by the related information reception portion 115 specifies the client device 10, that is, the own device. The second accumulating portion 118 accumulates the related information and the keyword information, for example, in a hard disk, or a non-volatile or volatile storage medium such as a memory (not shown) inside the client device 10. Furthermore, the second accumulating portion 118 may accumulate the related information and the keyword information in different storage media. They also may be accumulated in a removable storage medium such as a CD-R. Any method may be applied as the method by which the second accumulating portion 118 manages the association between the related information and the keyword information as a pair. For example, the association between the related information and the keyword information as a pair may be managed by providing a file including the related information with the file name constituted by a keyword indicated by the keyword information, and accumulating the file in a storage medium. Alternatively, the second accumulating portion 118 may manage the association between the related information and the keyword information as a pair, by constructing management information containing the association between the related information and the keyword information, and accumulating the management information in a storage medium or the like. The second accumulating portion 118 can be typically implemented as an MPU or a memory, for example. Typically, the process procedure of the second accumulating portion 118 is implemented by software, and the software is stored in a storage medium such as a ROM. Note that the process procedure also may be implemented by hardware (dedicated circuit).

Furthermore, if the accumulation-destination specification that has been received by the related information reception portion 115 specifies the server device 20, then the transmitting portion 117 transmits the related information and the keyword information as a pair to the server device 20.

With this configuration, it is possible to switch accumulation-destination of keyword information and related information as a pair. Thus, it is possible to select accumulation-destination so as to be suitable for applications, such as to accumulate keyword information and related information as a pair only for a personal use inside the client device 10, and to accumulate keyword information and related information as a pair that are to be shared in a group or the like inside the server device 20.

Herein, it is preferable that when the transmitting portion 117 transmits keyword information in order to confirm whether or not the keyword information has been already accumulated in the server device 20, the transmitting portion 117 transmits the keyword information after the server device 20 is specified by accumulation-destination specification. Furthermore, if the client device 10 is specified by accumulation-destination specification, then the second accumulating portion 118 or the like may confirm whether or not the keyword information has been already accumulated inside the client device 10.

Furthermore, if the accumulation-destination of keyword information and related information as a pair is limited to a storage medium or the like inside the client device 10, then it is not necessary to receive the accumulation-destination specification, and only the second accumulating portion 118 may be provided without the transmitting portion 117. With this configuration, the server device 20 is not necessary, and thus the flexibility in system design is improved.

Furthermore, in this embodiment, in a case where duplicate keyword information and the like may be registered, it is possible not to include processing portions such as the accumulation information receiving portion 116 and the accumulation information transmitting portion 212, for confirming whether or not keyword information has been registered, a process in which the transmitting portion 117 transmits keyword information immediately after the keyword information is acquired, and a process in which the first accumulating portion 211 judges whether or not keyword information has been accumulated, for example.

Furthermore, in this embodiment, it is also possible that when the server device 20 receives keyword information and related information as a pair that have been transmitted from the client device 10, the first accumulating portion 211 of the server device 20 judges whether or not keyword information that is the same as the keyword information included in this pair has been accumulated, and if the same keyword information is included, then it is further judged whether or not the same related information has been accumulated. It is also possible that the first accumulating portion 211 does not accumulate keyword information and related information as a pair only when the same keyword information and related information are included. With this configuration, it is possible not to register the totally same pair of keyword information and related information, and thus it is possible to prevent duplicate information from being registered.

Herein, in this embodiment, a case was described in which one client device and one server device are provided, but in the present invention, multiple client devices may be used, and multiple server devices also may be used. For example, one server device may receive, for example, keyword information and related information as a pair from multiple client devices. In a case where multiple server devices are used, a server device to which keyword information and related information as a pair are to be transmitted may be specified, or keyword information and related information as a pair may be transmitted to all server devices. Note that the same is applied to other embodiments.

Furthermore, in this embodiment, the output that may be output by the outputting portion 111 of the client device 10 are received and displayed via a network or the like by another client device, and a character string specification instruction that has been input to another client device with respect to this display may be received via a network or the like by the character string specification reception portion 113 of the client device 10. Note that the same is applied to other embodiments.

The process in this embodiment may be implemented by software. The software may be distributed by software downloading or the like. The software may be distributed in the form where the software is stored in a storage medium such as a CD-ROM. Note that the same is applied to the other embodiments described in this specification. The software that implements the client device of the information processing system in this embodiment may be a following program. Specifically, this program is a program for causing a computer to execute: an output instruction reception step of receiving an output instruction, which is an instruction to output main information, which is information including a character string; an outputting step of outputting main information based on the output instruction; a character string specification reception step of receiving a character string specification instruction, which is an instruction to specify a character string, in the main information that has been output in the outputting step; a keyword information acquiring step of acquiring keyword information, which is information of a character string specified by the character string specification instruction; a related information reception step of receiving related information, which is information relating to the keyword information; and a transmitting step of transmitting the related information and the keyword information as a pair to predetermined transmission destination.

Furthermore, it is also possible to apply a program for causing a computer to execute: an output instruction reception step of receiving an output instruction, which is an instruction to output main information, which is information including a character string; an outputting step of outputting main information based on the output instruction; a character string specification reception step of receiving a character string specification instruction, which is an instruction to specify a character string, in the main information that has been output in the outputting step; a keyword information acquiring step of acquiring keyword information, which is information of a character string specified by the character string specification instruction; a related information reception step of receiving related information, which is information relating to the keyword information; and an accumulating step of accumulating the related information and the keyword information as a pair.

Note that in the above-described program, the transmitting step of transmitting information, the receiving step of receiving information, and the like do not include a process performed by hardware, such as a process in the transmitting step performed in a modem, an interface card, or the like (a process performed only by hardware). Note that the same is applied to other embodiments.

Furthermore, this program may be executed by downloading it from a server or the like, or may be executed by reading out the program stored in a predetermined storage medium (an optical disk such as a CD-ROM, a magnetic disk, and a semiconductor memory, for example). Note that the same is applied to other embodiments.

The program may be executed by a single or multiple computers. In other words, the program may be executed by either a centralized process or a distributed process. Note that the same is applied to other embodiments.

### Embodiment 5

FIG. 35 is a block diagram of an information processing system in this embodiment.

The information processing system is provided with a client device 40 and a server device 50. The devices can transmit and receive information. The devices are connected to each other via a network 30 such as the Internet. Note that a unit for transmitting and receiving information may be a communication unit or a broadcasting unit, for example.

The client device 40 is provided with an output instruction reception portion 410, an outputting portion 411, an instruction information reception portion 413, a file constructing portion 414, and a transmitting portion 415.

The server device 50 is provided with a receiving portion 510 and an accumulating portion 511.

The output instruction reception portion 410 receives an output instruction, which is an instruction to output image information. Examples of the image information include a file. Bitmap data, vector data, or the like is stored in the file. The image file may be in a JPEG format, a GIF format, a BMP format, or an SVG format. More specifically, there is no limitation regarding the file format. If the image information is a file, then the output instruction may be an instruction to open the file. As the input unit of the output instruction, any unit may be used such as a mouse, ten keys, a keyboard, and a menu screen. The output instruction may include information specifying the image information that is to be output. Examples of the information specifying the image information include whereabouts information indicating the whereabouts of the image information, more specifically, a URL, a URI, an IP address, directory information, or the like. The image information that is to be output may be stored inside the client device 40, or may be stored in another device or the like on the network. The output instruction reception portion 410 can be implemented as a device driver for an input unit such as a mouse and a keyboard, or by control software for a menu screen, for example.

The outputting portion 411 outputs the image information based on the output instruction. More specifically, the outputting portion 411 acquires and outputs the image information. There is no limitation regarding the source from which the outputting portion 411 acquires the image information. If information specifying the image information that is to be output is included in the output instruction, then the outputting portion 411 typically acquires and outputs the image information specified by the output instruction. It is also possible that information for making a request to transmit the image information is output to a device and the like at the location indicated by the whereabouts information included in the output instruction, and then the image information that has been transmitted from another device such as a web server in response to this information is acquired and output. Herein, a case is described in which the outputting portion 411 acquires the image information from a storage portion 412 described below, and outputs the image information. The outputting portion 411 may acquire and output predetermined image information. The outputting portion 411 may or may not include an output device such as a display screen. The outputting portion can be implemented by driver software for an output device, or a combination of driver software for an output device and the output device, for example. Here, the term “output” has a concept that includes displaying on a display screen, transmission to an external device, and the like.

Image information can be stored in the storage portion 412. In the storage portion 412, the image information may be stored in advance, or the image information that has been transmitted from another device such as a web server may be accumulated. It is also possible that when a transmitting portion (not shown) in the client device 40 outputs a request for an image file to a particular web server, the image file that has been transmitted by the web server in response thereto is received by a receiving portion (not shown) and is stored in the storage portion 412, for example. Here, the term “store” has a concept that also includes temporary storage performed when receiving data that has been transmitted from another device, for example. The storage portion 412 may be a volatile storage medium or may be a non-volatile storage medium.

The instruction information reception portion 413 receives an area instruction to specify at least a part of an area in the image information that has been output by the outputting portion 411, and keyword information, which is information of a character string associated with the area specified by the area instruction. The area instruction may be on the entire image information. It is preferable that the instruction information reception portion 413 receives an area instruction on an area specified, for example, by dragging and releasing using a pointing device. If the “dragging” refers to an operation of moving the coordinates of a mouse pointer while pressing the left button of the mouse, then the “releasing” refers to an operation of stopping pressing the left button of the mouse. More specifically, it is also possible that the instruction information reception portion 413 acquires information of the coordinates of the dragging start point and information of the coordinates of the releasing point on image information that has been output by the outputting portion 411, and receives an area instruction to specify, among the output image information, a part of the image information in a rectangular area in which two points indicated by the information of the coordinates serve as diagonally opposing corners. Other examples of the “dragging” also may include an operation of moving the mouse pointer without pressing a mouse button. In this case, for example, the start point of the “dragging” is at the coordinates where the mouse pointer is first at rest for a predetermined time or more, and the end point of the “releasing” is at the coordinates where the mouse pointer is next at rest for a predetermined time or more. Furthermore, the instruction information reception portion 413 also may receive an area instruction to specify a polygonal area in which the coordinates indicated by information of the coordinates of at least three points serve as vertexes, by receiving the information of the coordinates of at least three points on an output image. Furthermore, it is also possible to receive an area instruction to specify an area within a predetermined window disposed on output image information, or an area in which objects with a predetermined shape arranged on output image information are overlapped. Furthermore, the instruction information reception portion 413 receives keyword information, which is information of a character string associated with the area specified by the area instruction. The keyword information indicates, for example, a character string relating to an image that is output onto the area instructed in the area instruction, more specifically, a character string used as a retrieval key when retrieving an image inside this area. Examples thereof include the title, the identification number, the date, or the like of this image. As the input unit of the area instruction or the keyword information, any unit may be used such as ten keys, a keyboard, a mouse, and a menu screen. More specifically, the instruction information reception portion 413 receives the area instruction immediately after the “releasing” using, as a trigger and the like, an operation of releasing a mouse button, for example. Then, for example, a menu for receiving the keyword information is output using the reception as a trigger and the like. The instruction information reception portion 413 can be implemented as a device driver for an input unit such as ten keys and a keyboard, or by control software for a menu screen, for example.

The file constructing portion 414 constructs a partial image file, which is a file containing image information associated with an area specified by the area instruction. More specifically, in image information that has been acquired and output by the outputting portion 411, an area specified by the area instruction is extracted, and a partial image file containing the extracted image information is constructed. If the area specification is on the entire image information, then the partial image file may be obtained as a file constructed by extracting the entire image. As in the image file described above, there is no limitation regarding the file type and the like of the partial image file. A technique by which the file constructing portion 414 extracts image information of a part of an area in image information and constructs an image file based on the extracted image information is already known, and thus a description thereof has been omitted. The file constructing portion 414 can be typically implemented as an MPU or a memory, for example. Typically, the process procedure of the file constructing portion 414 is implemented by software, and the software is stored in a storage medium such as a ROM. Note that the process procedure also may be implemented by hardware (dedicated circuit).

The transmitting portion 415 transmits the partial image file and the keyword information as a pair to the server device 50. Information indicating the whereabouts of the server device 50 to which the partial image file and the keyword information are to be transmitted from the transmitting portion 415 may be selected in advance, or may be received by the instruction information reception portion 413, for example. There is no limitation regarding a timing or trigger for the transmitting portion 415 to transmit the partial image file and the keyword information as a pair. For example, they may be transmitted when a reception portion (not shown) receives a transmission or registration instruction from the user. Furthermore, any configuration may be applied as the configuration in which the partial image file and the keyword information as a pair are transmitted by the transmitting portion 415. For example, it is possible that a file including the partial image file is constructed, provided with the file name constituted by a keyword indicated by the keyword information, and then transmitted. It is also possible to construct and transmit a file including the partial image file and the keyword. It is also possible to construct and transmit respective files of the partial image file, the keyword, and the information for managing the association therebetween. The transmitting portion 415 is typically implemented as a wireless or wired communication unit, but also may be implemented as a broadcasting unit.

The receiving portion 510 receives the partial image file and the keyword information. The receiving portion 510 is typically implemented as a wireless or wired communication unit, but also may be implemented as a broadcast receiving unit.

The accumulating portion 511 accumulates the partial image file and the keyword information as a pair in association with each other. The accumulating portion 511 accumulates the partial image file and the keyword information, for example, in a hard disk, or a non-volatile or volatile storage medium such as a memory (not shown) inside the server device 50. Furthermore, the accumulating portion 511 may accumulate the partial image file and the keyword information in different storage media. They also may be accumulated in a removable storage medium such as a CD-R. Any method may be applied as the method by which the accumulating portion 511 manages the association between the partial image file and the keyword information as a pair. For example, the association between the partial image file and the keyword information as a pair may be managed by providing the partial image file with the file name constituted by a keyword indicated by the keyword information, and accumulating the file in a storage medium. Alternatively, the accumulating portion 511 may manage the association between the partial image file and keyword information as a pair, by constructing management information containing the association between the partial image file and the keyword information, and accumulating the management information in a storage medium or the like. The accumulating portion 511 can be typically implemented as an MPU or a memory, for example. Typically, the process procedure of the accumulating portion 511 is implemented by software, and the software is stored in a storage medium such as a ROM. Note that the process procedure also may be implemented by hardware (dedicated circuit).

Next, the operation of the client device 40 in the information processing system is described with reference to the flowchart in FIG. 36.

(Step S3601) The output instruction reception portion 410 judges whether or not an output instruction has been received. If the output instruction has been received, then the procedure proceeds to step S3602. If the output instruction has not been received, then the procedure proceeds to step S3604.

(Step S3602) The outputting portion 411 acquires image information based on the output instruction that has been received in step S3601. If the output instruction includes information specifying image information stored in the storage portion 412, then the image information on which the instruction is given is acquired from the storage portion 412.

(Step S3603) The outputting portion 411 outputs the image information that has been acquired in step S3602. The procedure returns to step S3601.

(Step S3604) The instruction information reception portion 413 judges whether or not an area instruction has been received. If the area instruction has been received, then the procedure proceeds to step S3605. If the area instruction has not been received, then the procedure returns to step S3601.

(Step S3605) The instruction information reception portion 413 judges whether or not keyword information has been received. If the keyword information has been received, then the procedure proceeds to step S3606. If the keyword information has not been received, then the procedure returns to step S3605.

(Step S3606) The file constructing portion 414 extracts image information of an area specified by the area instruction that has been received in step S3604, in the image information that has been acquired by the outputting portion 411 in step S3602, and constructs a partial image file using the extracted image information. Herein, the processes of step S3606 and step S3605 may be performed in any processing order.

(Step S3607) The transmitting portion 415 transmits the keyword information that has been received in step S3605 and the partial image file that has been constructed in step S3606 as a pair, to the server device 50. The procedure returns to step S3601.

Note that the process is ended by powering off or interruption for aborting the process in the flowchart in FIG. 36.

The operation of the server device 50 is similar to the above-described operation in Embodiment 4 in which the related information and the keyword information as a pair are received and accumulated, except that the related information is replaced by the partial image file, and thus a description thereof has been omitted.

Hereinafter, specific operation of the information processing system in this embodiment is described. A conceptual view of this information processing system is similar to that in FIG. 26.

FIG. 37 shows at least one piece of image information stored in the storage portion 412 of the client device 40. The structure of this image information is a file. It is here assumed that an output instruction on image information “shoot.jpeg” is input by the user of the client device 40. Next, the output instruction reception portion 410 of the client device 40 receives the output instruction on the image information, and then the outputting portion 411 opens a file of the image information “shoot.jpeg”, and displays the image information on a display screen.

It is then assumed that as shown in FIG. 38, the user performs dragging and releasing with a mouse over an area 160 that is a part of the image information “shoot.jpeg” displayed on the display screen. Then, immediately after the dragging and the releasing are completed, the instruction information reception portion 413 receives an area instruction to specify the area 160 over which dragging and releasing have been performed.

Furthermore, as shown in FIG. 39, the instruction information reception portion 413 outputs a menu for urging that keyword information associated with an area specified by the area instruction be registered. Menu information for displaying the menu is held in advance in the instruction information reception portion 413.

Next, when user inputs a character string “soccer” using a keyboard or the like to an input field 170, and presses a registration button 171 in a menu shown in FIG. 39, the instruction information reception portion 413 receives the keyword information “soccer”. Furthermore, as shown in FIG. 40, the file constructing portion 414 extracts the image information specified by the area instruction, and constructs a partial image file. It is assumed that this partial image file is provided with, for example, a file name “01_shoot.jpeg” following a predetermined naming rule. Then, the transmitting portion 415 constructs information in which the keyword information and the constructed partial image file are paired as shown in FIG. 41, and transmits the information to the server device 50.

Next, the receiving portion 510 of the server device 50 receives the partial image file “01_shoot.jpeg” and the keyword information “soccer” as a pair. Then, the accumulating portion 511 accumulates the partial image file “01_shoot.jpeg” in a storage medium or the like. Furthermore, a file “soccer.txt” in which the file name thereof is the keyword information “soccer” is created, and then information specifying the location in which the partial image file “01_shoot.jpeg” paired with the keyword information “soccer” is stored, that is, the whereabouts information is stored in this file. Herein, the whereabouts information may be information indicating a relative position with respect to the file “soccer.txt”, or may be information indicating an absolute position including, for example, an IP address of the server device 50.

As described above, according to this embodiment, a predetermined area in image information that has been output is specified, and thus an image file constituted by the image information can be provided with keyword information and registered in the server device 50, for example. Accordingly, a step of extracting and storing a part of image information that is required to be stored is not necessary, and thus a part of image information can be registered easily.

If an interesting portion is found file accessing to image information, only this portion can be specified and registered as an image file, and thus a part of image information can be registered based on intuitive operation.

Herein, also in Embodiment 5, it is also possible to select the server device 50 or the client device 40 as accumulation-destination of a partial image file and keyword information as a pair, as in the modification example in Embodiment 4 shown in FIG. 34.

Furthermore, if keyword information has been already registered in the server device 50, then it is also possible not to register a partial image file, as in Embodiment 4.

In the foregoing embodiments, each process (each function) may be performed by a centralized process using a single device (system), or may be performed by a distributed process using multiple devices.

In the foregoing embodiments, each component may be constituted by dedicated hardware. Alternatively, a component that can be implemented by software may be implemented by executing a program. For example, each component can be implemented by reading out and executing a software program stored in a storage medium such as a hard disk or a semiconductor memory by a program executing portion such as a CPU. Herein, the software that implements the information processing device in the foregoing embodiments may be a following program. Specifically, this program is a program for causing a computer to execute: an output instruction reception step of receiving an output instruction, which is an instruction to output image information; an outputting step of outputting image information based on the output instruction; an instruction information reception step of receiving an area instruction to specify at least a part of an area, in the image information that has been output in the outputting step, and keyword information, which is information of a character string associated with an area specified by the area instruction; a file constructing step of constructing a partial image file, which is a file containing image information associated with an area specified by the area instruction; and a transmitting step of transmitting the partial image file and the keyword information as a pair to predetermined transmission destination.

Furthermore, in the foregoing embodiments, it would be appreciated that two or more communication units (such as information transmitting portions) in one device may be physically implemented by one medium.

The present invention is not limited to the embodiments set forth herein. Various modifications are possible within the scope of the present invention.

### INDUSTRIAL APPLICABILITY

As described above, the information processing system according to the present invention has an effect in that when an instruction is given on information, location information associated with the information can be acquired easily, and thus this system is useful as an information retrieval system, for example.

Furthermore, the information processing system and the like according to the present invention are suitable as an information processing system used, for example, for registration of information that is used for retrieval, and in particular, they are useful as an information processing system in which information is provided with a keyword and then registered, or an information processing system in which only a part of an image is registered, for example.

### BRIEF DESCRIPTION OF THE DRAWINGS

FIG. 1 is a conceptual view of an information processing system in Embodiment 1.

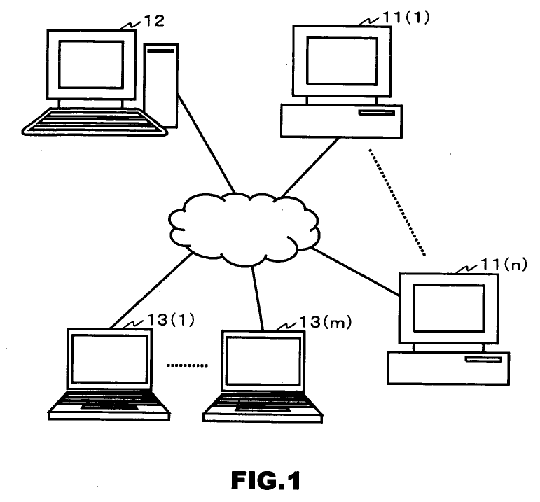

FIG. 2 is a block diagram of the information processing system.

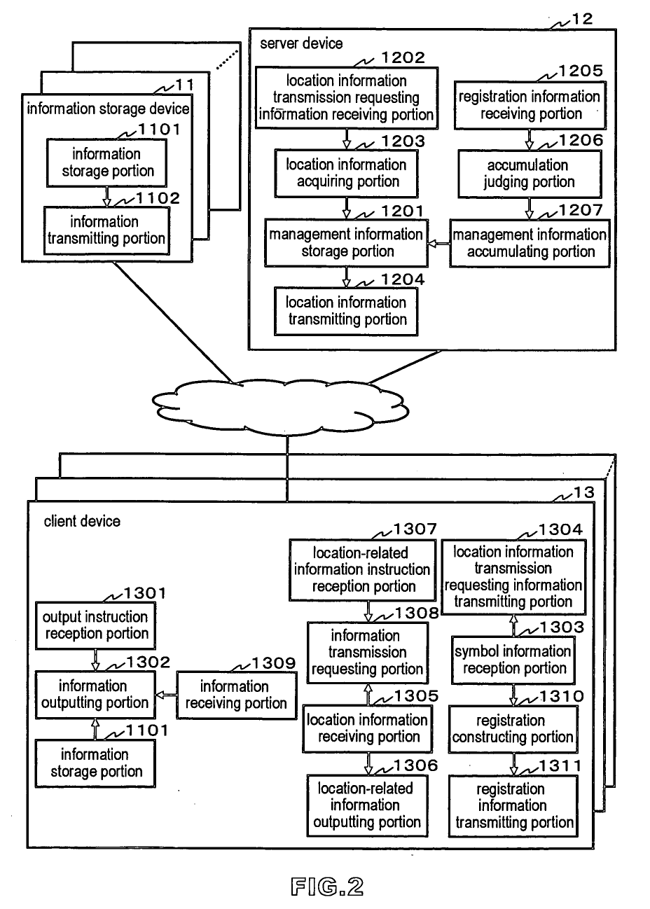

FIG. 3 is a flowchart illustrating the operation of the server device.

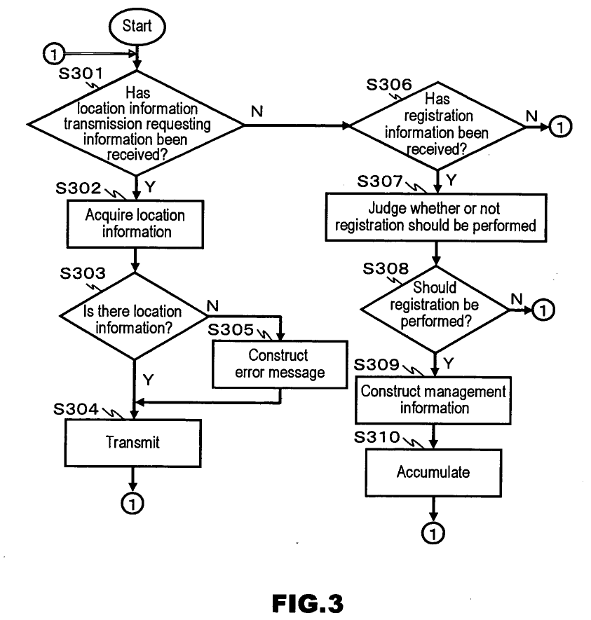

FIG. 4 is a flowchart illustrating the operation of the client device.

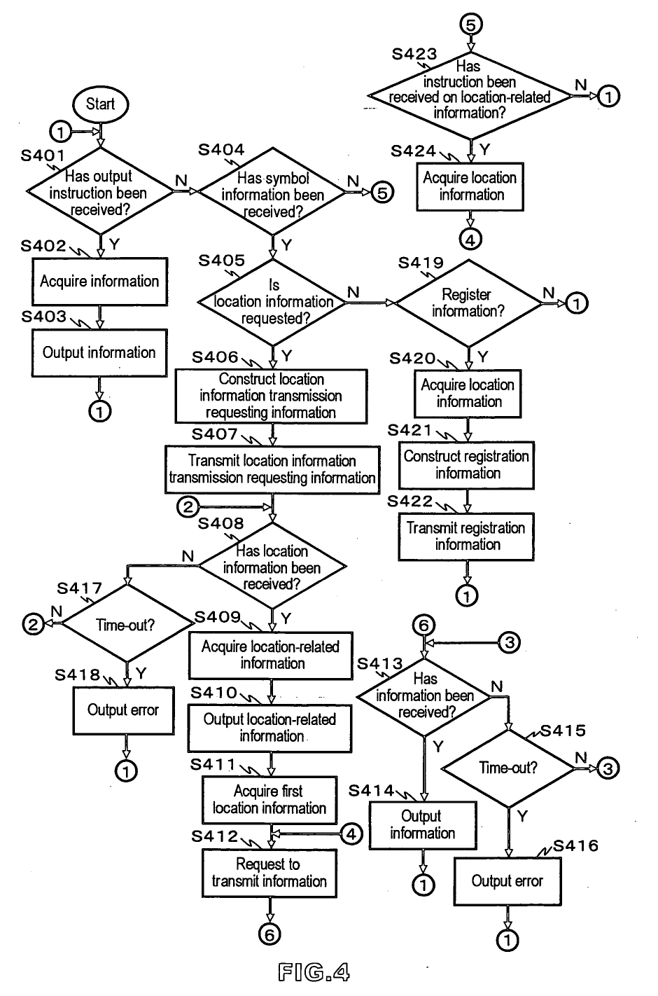

FIG. 5a is a view showing an example of the management information.

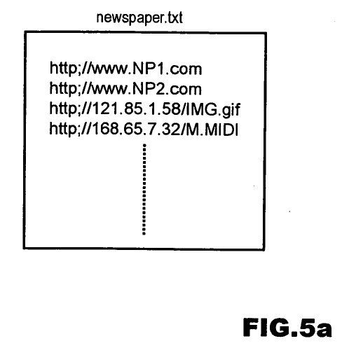

FIG. 5b is a view showing an example of the management information.

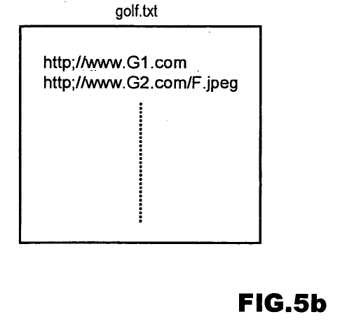

FIG. 6 is a view showing an example of information stored in the client device.

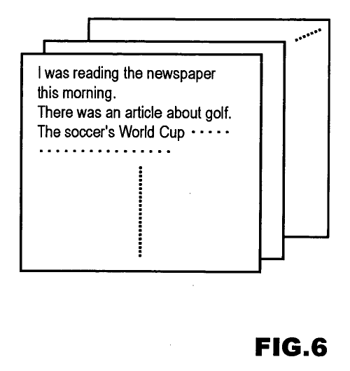

FIG. 7 is a view showing an example of screen display of the client device.

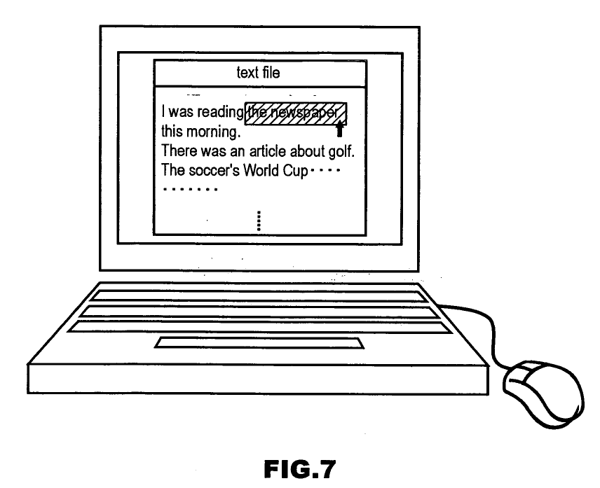

FIG. 8 is a diagram showing an example of the location information transmission requesting information.

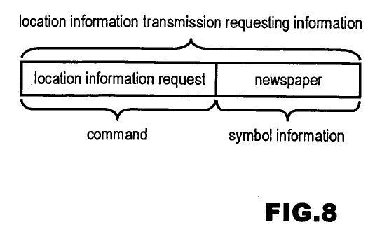

FIG. 9 is a view showing an example of the received location information.

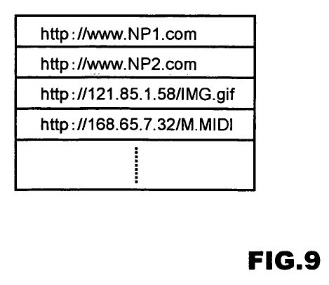

FIG. 10 is view showing a display example of the acquired information.

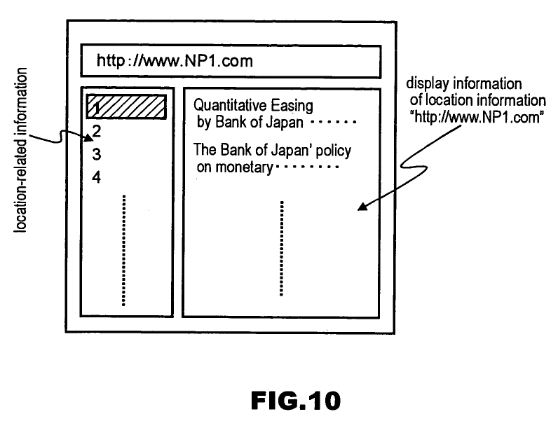

FIG. 11 is view showing a display example of the acquired information.

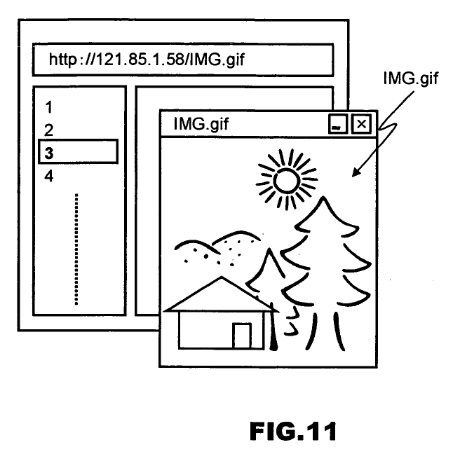

FIG. 12 is a view showing an example of a registration screen of the client device.

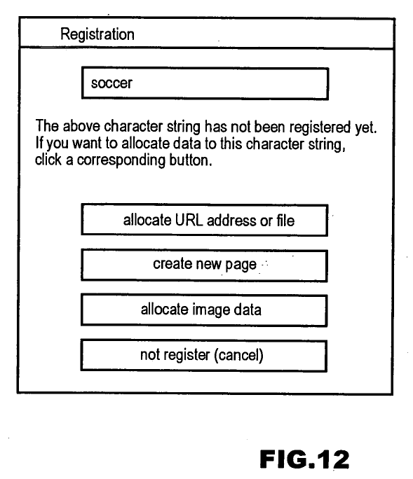

FIG. 13a is a view of an example of the registration screen.

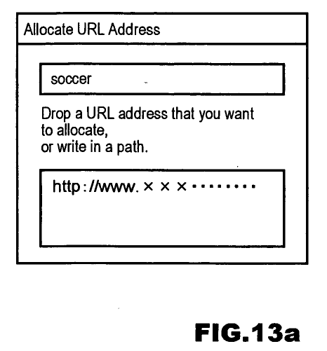

FIG. 13b is a view of an example of the registration screen.

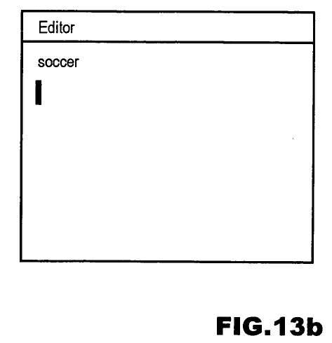

FIG. 13c is a view of an example of the registration screen.

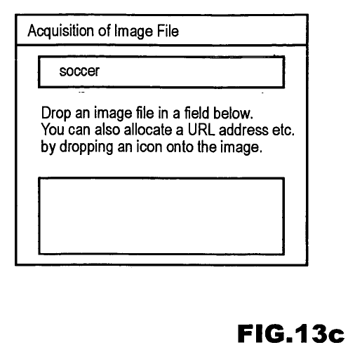

FIG. 14a is a diagram showing an example of the registration information.

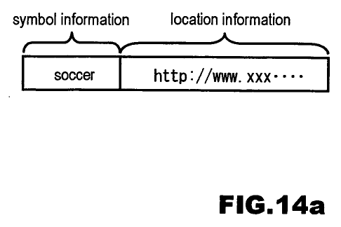

FIG. 14b is a diagram showing an example of the registration information.

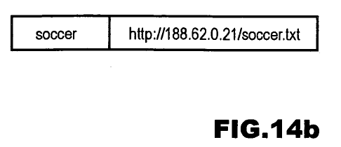

FIG. 14c is a diagram showing an example of the registration information.

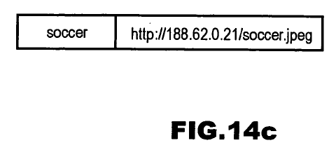

FIG. 15a is a view showing an example of the management information.

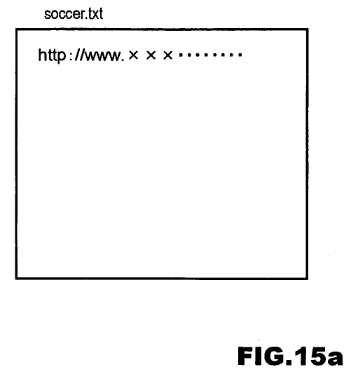

FIG. 15b is a view showing an example of the management information.

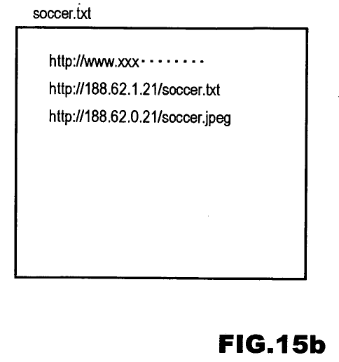

FIG. 16 is a block diagram of an information processing system in Embodiment 2.

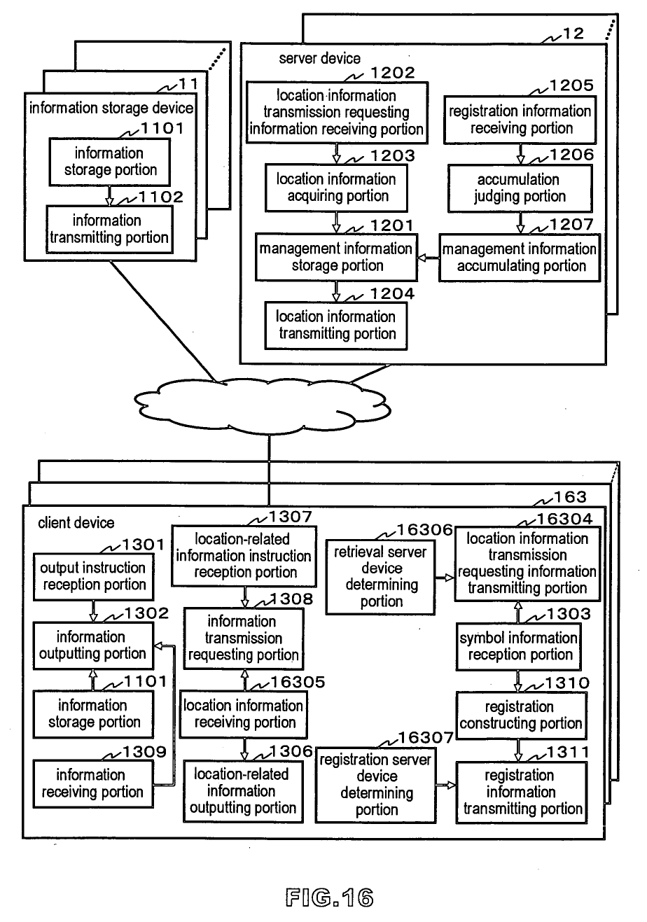

FIG. 17 is a flowchart illustrating the operation of the client device.

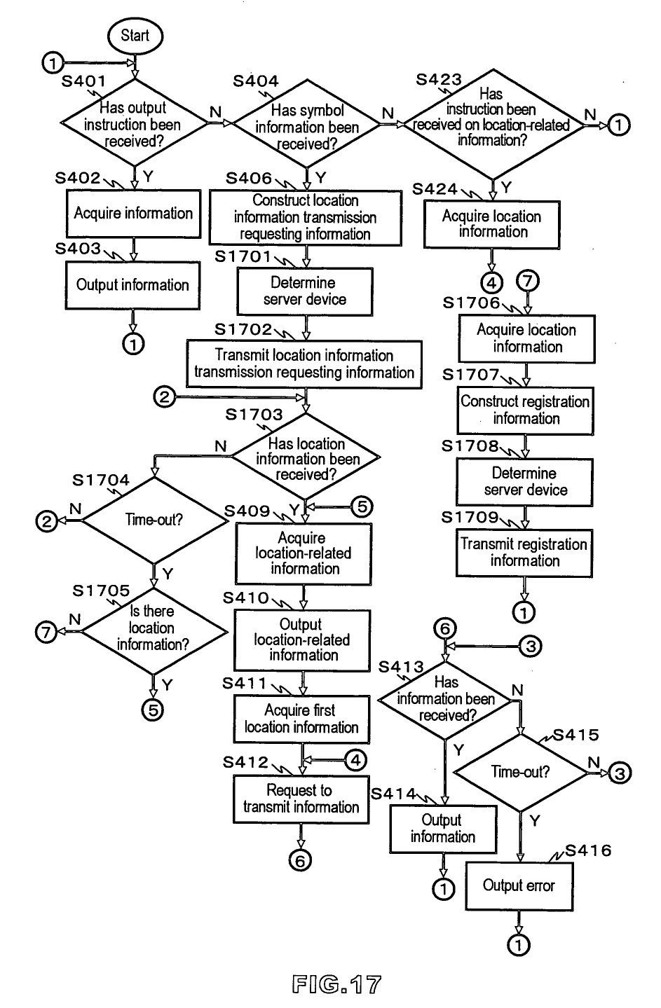

FIG. 18 is a view showing the server information management list.

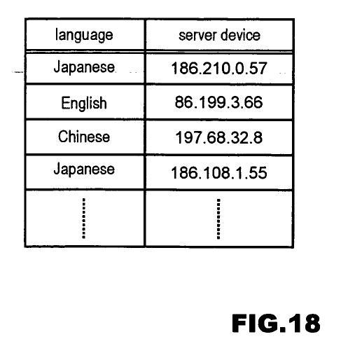

FIG. 19 is a conceptual view of an information processing system in Embodiment 3.

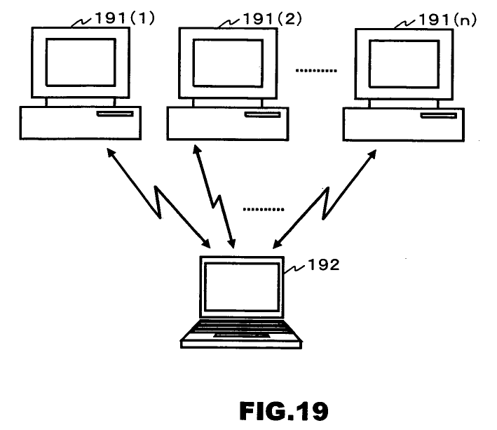

FIG. 20 is a block diagram of the information processing system.

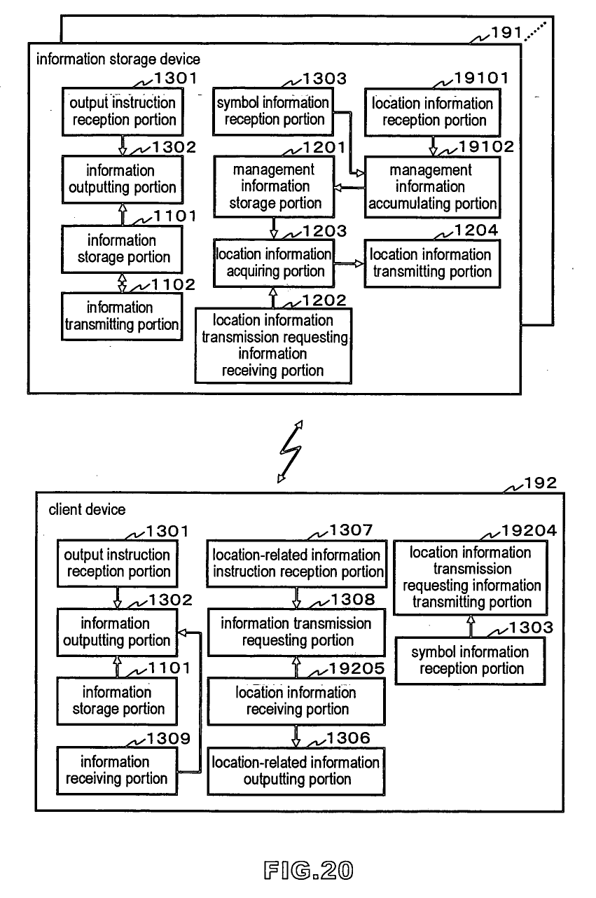

FIG. 21 is a flowchart illustrating the operation of the information storage device.

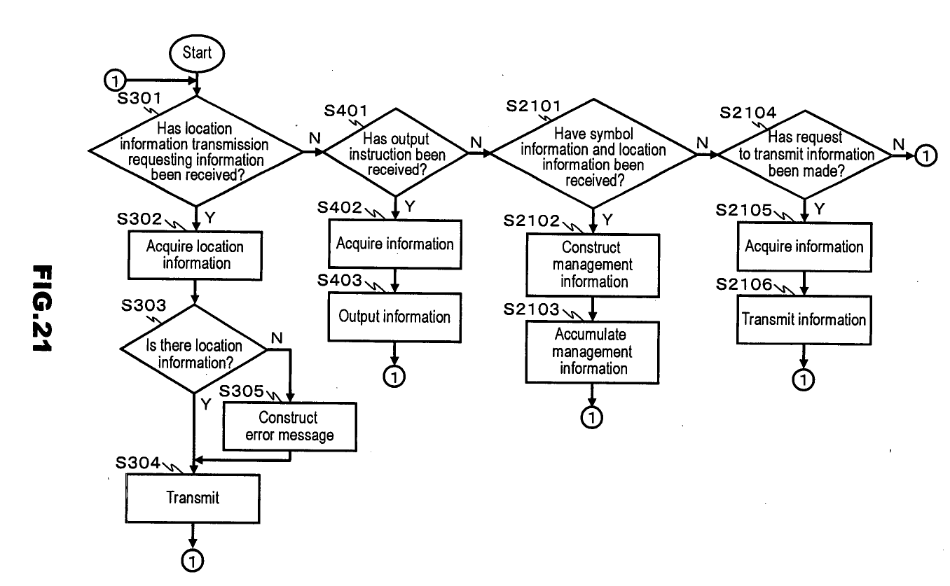

FIG. 22 is a flowchart illustrating the operation of the client device.

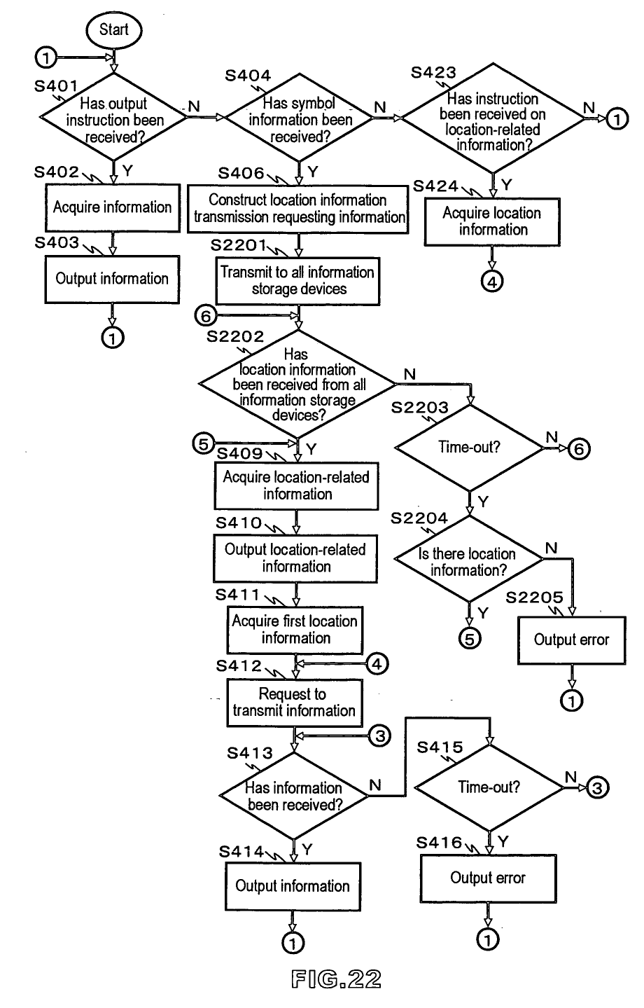

FIG. 23 is a block diagram of an information processing system in Embodiment 4.

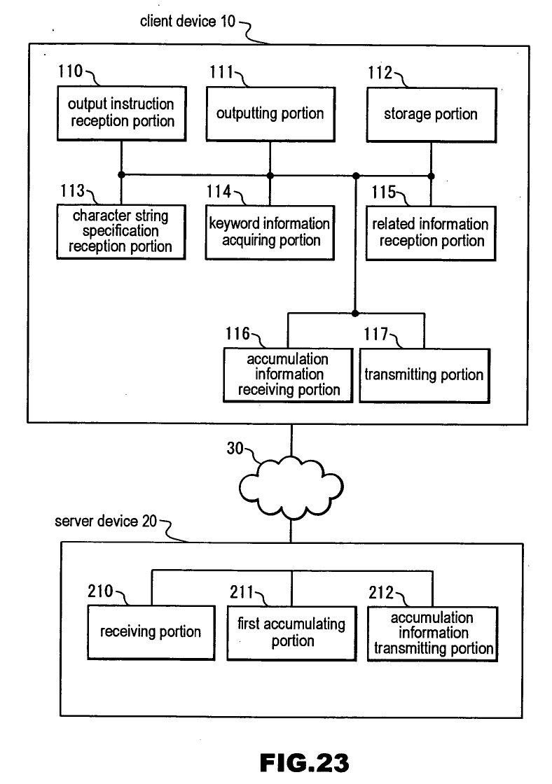

FIG. 24 is a flowchart illustrating the operation of the client device.

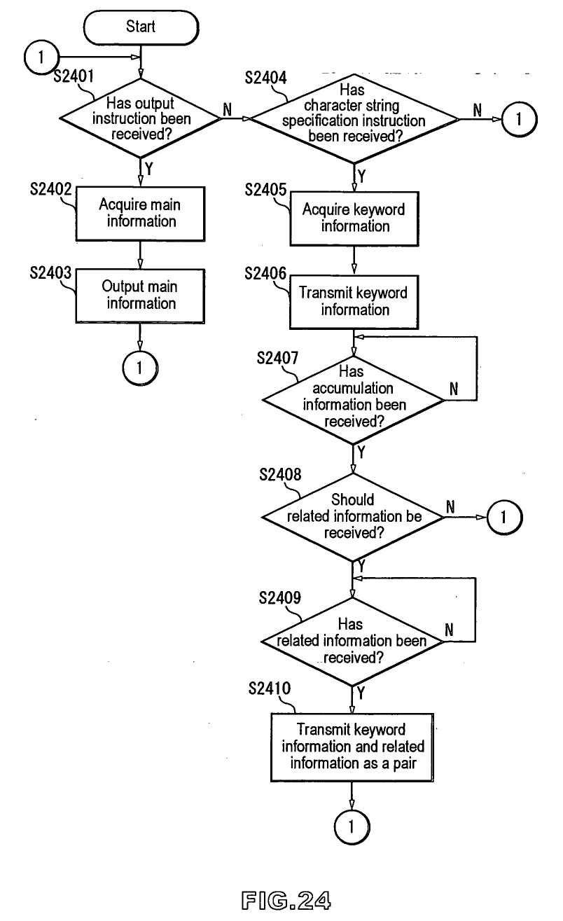

FIG. 25 is a flowchart illustrating the operation of the server device.

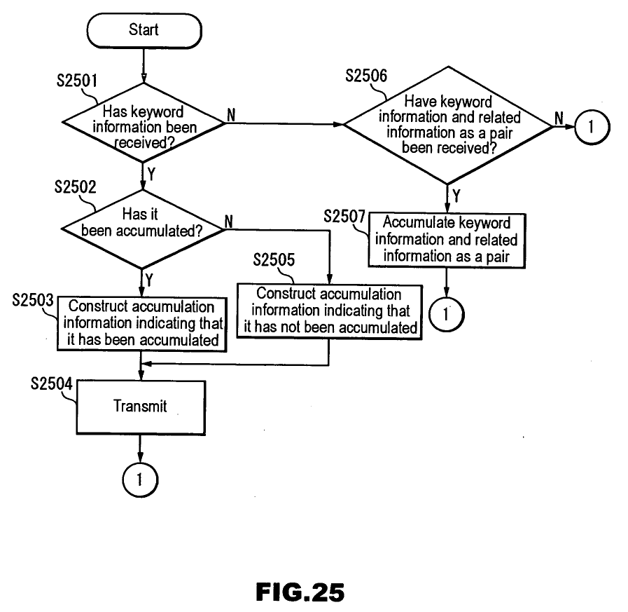

FIG. 26 is a conceptual view thereof.

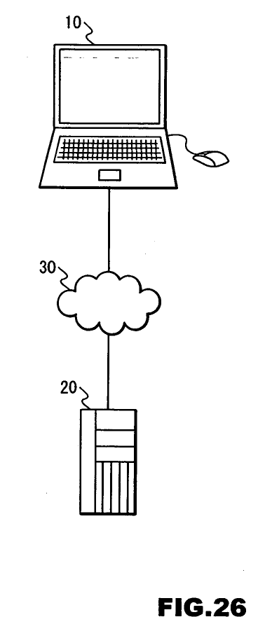

FIG. 27 is a view showing an example of the main information.

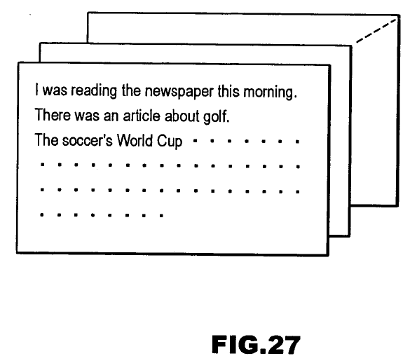

FIG. 28 is a view showing the display example.

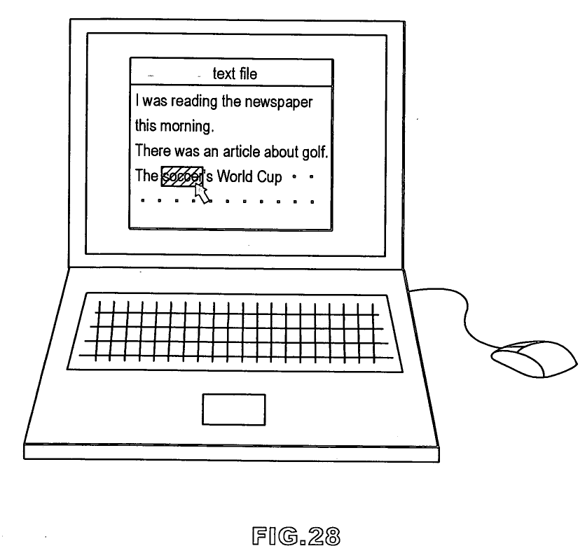

FIG. 29 is a view showing the display example.

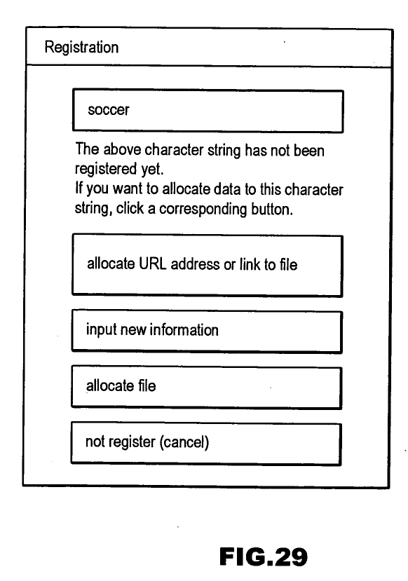

FIG. 30a is a view showing the display example.

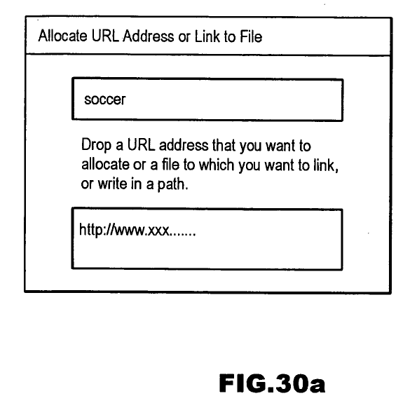

FIG. 30b is a view showing the display example.

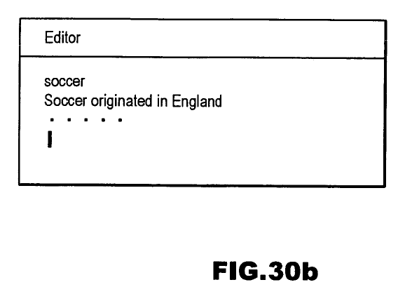

FIG. 30c is a view showing the display example.

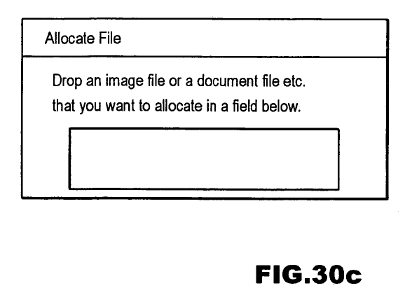

FIG. 31a is a diagram showing the information in which keyword information and related information are paired.

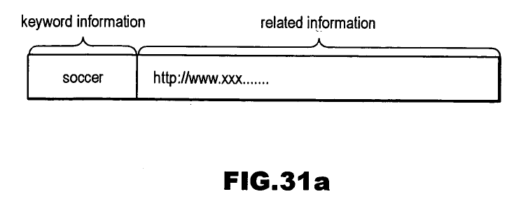

FIG. 31b is a diagram showing the information in which keyword information and related information are paired.

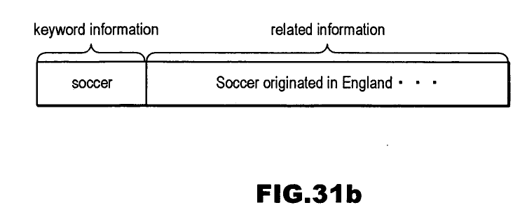

FIG. 31c is a diagram showing the information in which keyword information and related information are paired.

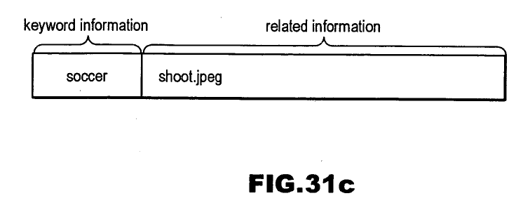

FIG. 32a is a view showing an example of the accumulated information.

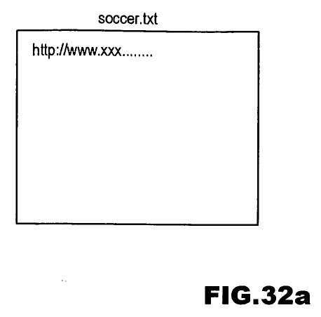

FIG. 32b is a view showing an example of the accumulated information.

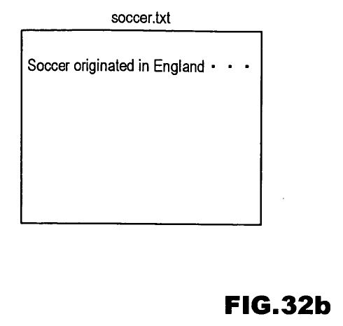

FIG. 32c is a view showing an example of the accumulated information.

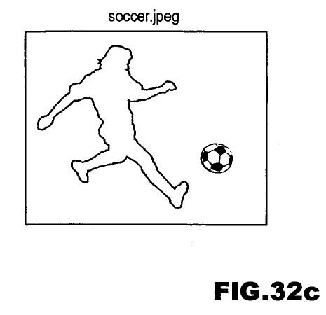

FIG. 33 is a showing the display example.

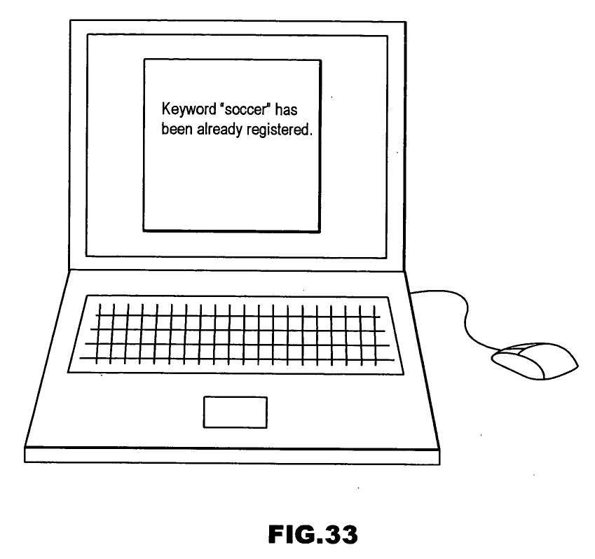

FIG. 34 is a diagram showing the modified example.

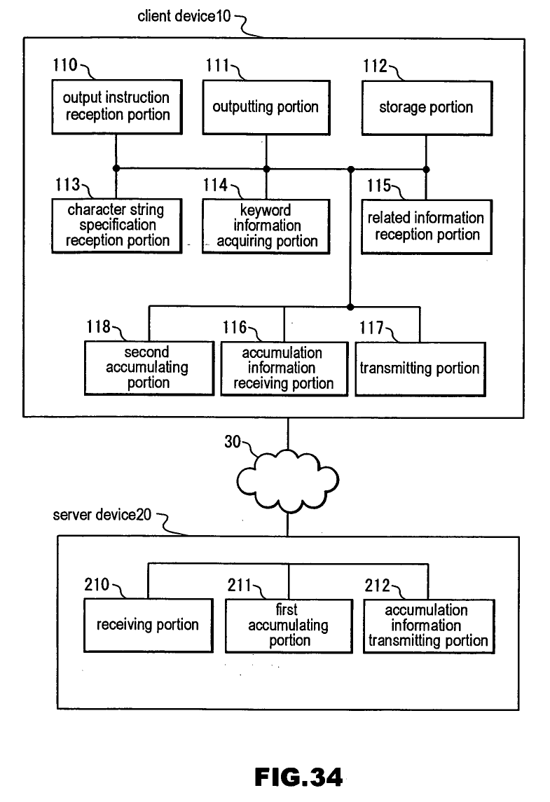

FIG. 35 is a block diagram of an information processing system in Embodiment 5.

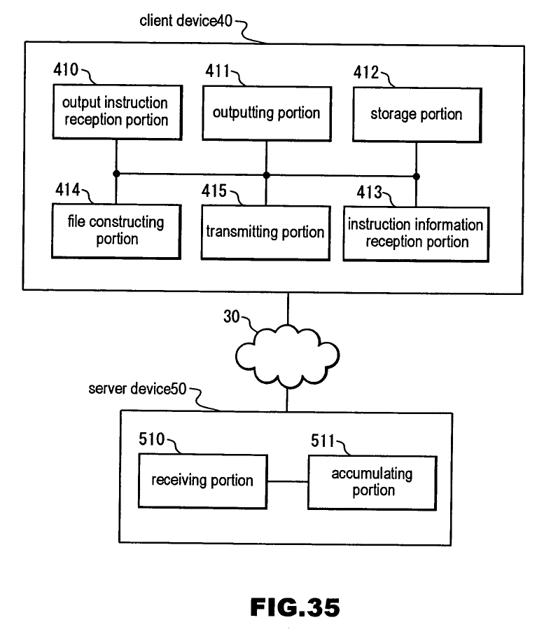

FIG. 36 is a flowchart illustrating the operation of the client device.

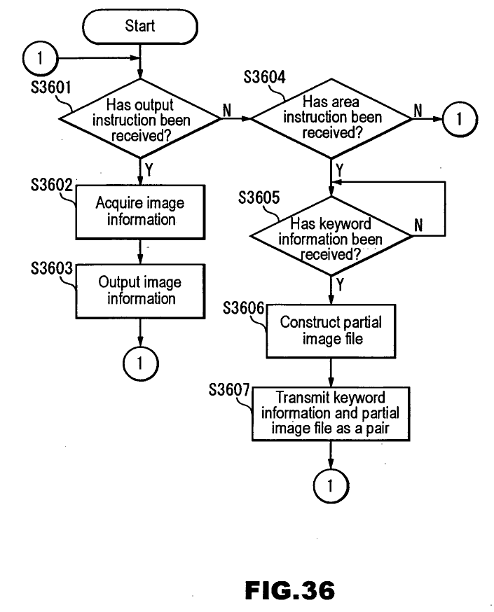

FIG. 37 is a view showing an example of the image information.

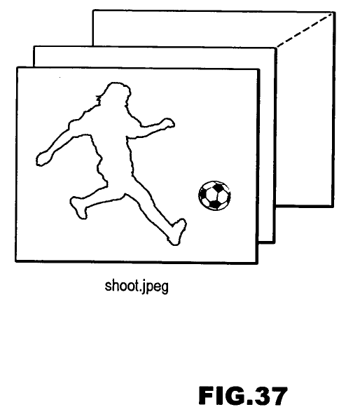

FIG. 38 is a view showing the display example.

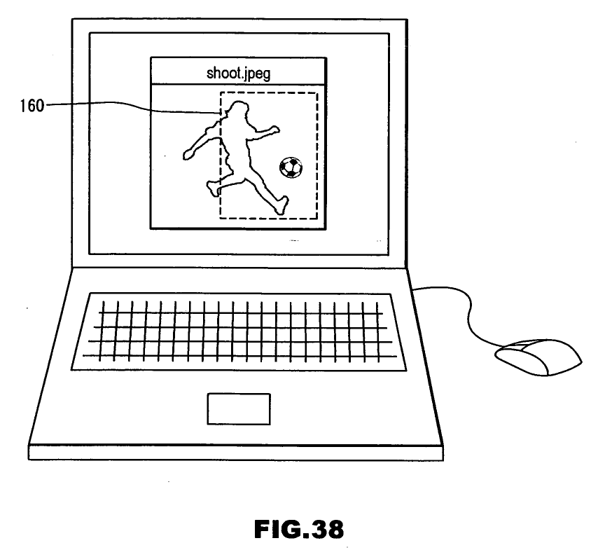

FIG. 39 is a view showing the display example.

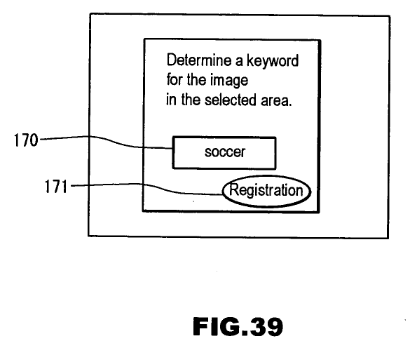

FIG. 40 is a view showing an example of the partial image file.

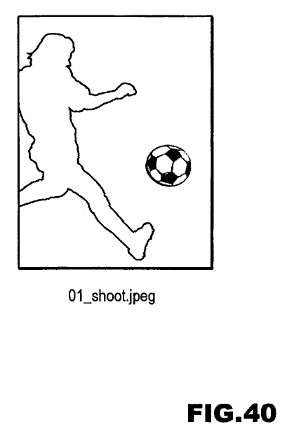

FIG. 41 is a diagram showing the information in which keyword information and a partial image file are paired.

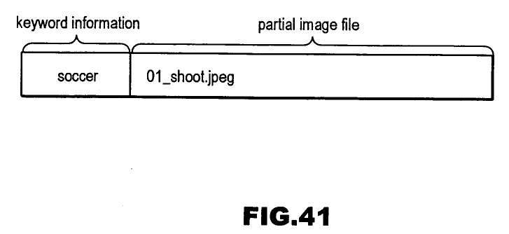

1. An information processing system comprising at least one information storage device, a server device, and a client device,
wherein the information storage device comprises:
an information storage portion in which at least one piece of information is stored; and
an information transmitting portion for transmitting the information to the client device in response to a request from the client device,
the server device comprises:
a management information storage portion in which at least one piece of management information, which is information for managing an association between symbol information and location information, is stored, the symbol information being information associated with information stored in the at least one information storage device, and the location information being information specifying a location in which the information is stored;
a location information transmission requesting information receiving portion for receiving, from the client device, location information transmission requesting information, which is information containing symbol information and is information for making a request to transmit location information;
a location information acquiring portion for acquiring at least one piece of location information associated with symbol information contained in the location information transmission requesting information, based on the management information; and
a location information transmitting portion for transmitting, to the client device, the at least one piece of location information that has been acquired by the location information acquiring portion, and
the client device comprises:
a symbol information reception portion for receiving symbol information;
a location information transmission requesting information transmitting portion for transmitting, to the server device, location information transmission requesting information containing the symbol information that has been received by the symbol information reception portion;
a location information receiving portion for receiving the at least one piece of location information from the server device; and
a location-related information outputting portion for outputting at least one piece of location-related information, which is information relating to the at least one piece of location information that has been received by the location information receiving portion.

2. An information processing system comprising at least one information storage device, a server device, and a client device,
wherein the information storage device comprises:
an information storage portion in which at least one piece of information is stored; and
an information transmitting portion for transmitting the information to the client device in response to a request from the client device,
the server device comprises:
a management information storage portion in which at least one piece of management information, which is information for managing an association between symbol information and location information, is stored, the symbol information being information associated with information stored in the at least one information storage device, and the location information being information specifying a location in which the information is stored;
a location information transmission requesting information receiving portion for receiving, from the client device, location information transmission requesting information, which is information containing symbol information and is information for making a request to transmit location information;
a location information acquiring portion for acquiring at least one piece of location information associated with symbol information contained in the location information transmission requesting information, based on the management information; and
a location information transmitting portion for transmitting, to the client device, the at least one piece of location information that has been acquired by the location information acquiring portion, and
the client device comprises:
a symbol information reception portion for receiving symbol information;
a location information transmission requesting information transmitting portion for transmitting, to the server device, location information transmission requesting information containing the symbol information that has been received by the symbol information reception portion;
a location information receiving portion for receiving the at least one piece of location information from the server device;
an information transmission requesting portion for making a request, to an information storage device specified by the location information that has been received by the location information receiving portion, to transmit information;
an information receiving portion for receiving the requested information from the information storage device; and
an information outputting portion for outputting the information that has been received by the information receiving portion.

3. The information processing system according to claim 2,
wherein the client device further comprises:
a location-related information outputting portion for outputting at least one piece of location-related information, which is information relating to the at least one piece of location information that has been received by the location information receiving portion; and
a location-related information instruction reception portion for receiving an instruction on at least one piece of location-related information, among the at least one piece of location-related information that has been output by the location-related information outputting portion, and
the information transmission requesting portion makes a request, to an information storage device specified by location information relating to location-related information corresponding to the instruction that has been received by the location-related information instruction reception portion, to transmit information.

4. The information processing system according to claim 1,
wherein in the client device, the information is output with an application corresponding to a format of the information.

5. The information processing system according to claim 1,
wherein the client device further comprises:
an information storage portion in which at least one piece of information is stored;
an output instruction reception portion for receiving an output instruction on the information;
wherein the information outputting portion further outputs information on which the output instruction has been received; and
the symbol information reception portion further receives an instruction on symbol information contained in the output information;
a registration constructing portion for constructing registration information based on the symbol information that has been received by the symbol information reception portion; and
a registration information transmitting portion for transmitting, to the server device, the registration information that has been constructed by the registration constructing portion, and
the server device further comprises:
a registration information receiving portion for receiving registration information from the client device; and
a management information accumulating portion for accumulating management information in the management information storage portion based on symbol information and location information contained in the registration information that has been received by the registration information receiving portion.

6. The information processing system according to claim 5,
wherein the server device further comprises an accumulation judging portion for judging whether or not management information should be accumulated, based on the registration information that has been received by the registration information receiving portion, and
the management information accumulating portion accumulates the management information in the management information storage portion only when the accumulation judging portion judges that accumulation should be performed.

7. The information processing system according to claim 6,
wherein the accumulation judging portion judges that accumulation should be performed only when in the management information storage portion, there is no management information for managing an association between symbol information and location information contained in the registration information that has been received by the registration information receiving portion.

8. An information processing system comprising at least one information storage device, at least two server devices, and a client device,
wherein the information storage device comprises:
an information storage portion in which at least one piece of information is stored; and
an information transmitting portion for transmitting the information to the client device in response to a request from the client device,
the server device comprises:
a management information storage portion in which at least one piece of management information, which is information for managing an association between symbol information and location information, is stored, the symbol information being information associated with information stored in the at least one information storage device, and the location information being information specifying a location in which the information is stored;
a location information transmission requesting information receiving portion for receiving, from the client device, location information transmission requesting information, which is information containing symbol information and is information for making a request to transmit location information;
a location information acquiring portion for acquiring at least one piece of location information associated with symbol information contained in the location information transmission requesting information, based on the management information; and
a location information transmitting portion for transmitting, to the client device, the at least one piece of location information that has been acquired by the location information acquiring portion, and
the client device comprises:
a symbol information reception portion for receiving symbol information;
a location information transmission requesting information transmitting portion for transmitting, to the at least two server devices, location information transmission requesting information containing the symbol information that has been received by the symbol information reception portion;
a location information receiving portion for receiving the at least one piece of location information from at least one server device, among the at least two server devices; and
a location-related information outputting portion for outputting at least one piece of location-related information, which is information relating to the at least one piece of location information that has been received by the location information receiving portion.

9. An information processing system comprising at least one information storage device, at least two server devices, and a client device,
wherein the information storage device comprises:
an information storage portion in which at least one piece of information is stored; and
an information transmitting portion for transmitting the information to the client device in response to a request from the client device,
the server device comprises:
a management information storage portion in which at least one piece of management information, which is information for managing an association between symbol information and location information, is stored, the symbol information being information associated with information stored in the at least one information storage device, and the location information being information specifying a location in which the information is stored;
a location information transmission requesting information receiving portion for receiving, from the client device, location information transmission requesting information, which is information containing symbol information and is information for making a request to transmit location information;
a location information acquiring portion for acquiring at least one piece of location information associated with symbol information contained in the location information transmission requesting information, based on the management information; and
a location information transmitting portion for transmitting, to the client device, the at least one piece of location information that has been acquired by the location information acquiring portion, and
the client device comprises:
a symbol information reception portion for receiving symbol information;
a location information transmission requesting information transmitting portion for transmitting, to the at least two server devices, location information transmission requesting information containing the symbol information that has been received by the symbol information reception portion;
a location information receiving portion for receiving the at least one piece of location information from at least one server device, among the at least two server devices;
an information transmission requesting portion for making a request, to an information storage device specified by the location information that has been received by the location information receiving portion, to transmit information;
an information receiving portion for receiving the requested information from the information storage device; and
an information outputting portion for outputting the information that has been received by the information receiving portion.

10. The information processing system according to claim 9,
wherein the client device further comprises:
a location-related information outputting portion for outputting at least one piece of location-related information, which is information relating to the at least one piece of location information that has been received by the location information receiving portion; and
a location-related information instruction reception portion for receiving an instruction on at least one piece of location-related information, among the at least one piece of location-related information that has been output by the location-related information outputting portion, and
the information transmission requesting portion makes a request, to an information storage device specified by location information relating to location-related information corresponding to the instruction that has been received by the location-related information instruction reception portion, to transmit information.

11. The information processing system according to claim 8,
wherein the client device further comprises a retrieval server device determining portion for determining at least one server device to which location information transmission requesting information is to be transmitted, based on the symbol information that has been received by the symbol information reception portion, and
the location information transmission requesting information transmitting portion transmits location information transmission requesting information to the at least one server device that has been determined by the retrieval server device determining portion.

12. The information processing system according to claim 8,
wherein the client device further comprises:
an information storage portion in which at least one piece of information is stored;
an output instruction reception portion for receiving an output instruction on the information;
wherein the information outputting portion further outputs information on which the output instruction has been received; and
the symbol information reception portion further receives an instruction on symbol information contained in the output information;
a registration constructing portion for constructing registration information based on the symbol information that has been received by the symbol information reception portion; and
a registration information transmitting portion for transmitting, to the server device, the registration information that has been constructed by the registration constructing portion, and
the server device further comprises:
a registration information receiving portion for receiving registration information from the client device; and
a management information accumulating portion for accumulating management information in the management information storage portion based on symbol information and location information contained in the registration information that has been received by the registration information receiving portion.

13. The information processing system according to claim 12,
wherein the client device further comprises a registration server device determining portion for determining at least one server device to which registration information is to be transmitted, based on the information, and
the registration information transmitting portion transmits registration information to the at least one server device that has been determined by the registration server device determining portion.

14. An information processing system comprising at least two information storage devices and a client device,
wherein the information storage device comprises:
an information storage portion in which at least one piece of information is stored;
a management information storage portion in which at least one piece of management information, which is information for managing an association between symbol information and location information, is stored, the symbol information being information associated with information stored in the information storage portion, and the location information being information specifying a location in which the information is stored;
a location information transmission requesting information receiving portion for receiving, from the client device, location information transmission requesting information, which is information containing symbol information and is information for making a request to transmit location information;
a location information acquiring portion for acquiring at least one piece of location information associated with symbol information contained in the location information transmission requesting information, based on the management information;
a location information transmitting portion for transmitting, to the client device, the at least one piece of location information that has been acquired by the location information acquiring portion; and
an information transmitting portion for transmitting the information to the client device in response to a request from the client device, and
the client device comprises:
a symbol information reception portion for receiving symbol information;
a location information transmission requesting information transmitting portion for transmitting, to the at least two information storage devices, location information transmission requesting information containing the symbol information that has been received by the symbol information reception portion;
a location information receiving portion for receiving the at least one piece of location information from at least one information storage device, among the at least two information storage devices; and
a location-related information outputting portion for outputting at least one piece of location-related information, which is information relating to the at least one piece of location information that has been received by the location information receiving portion.

15. An information processing system comprising at least two information storage devices and a client device,
wherein the information storage device comprises:
an information storage portion in which at least one piece of information is stored;
a management information storage portion in which at least one piece of management information, which is information for managing an association between symbol information and location information, is stored, the symbol information being information associated with information stored in the information storage portion, and the location information being information specifying a location in which the information is stored;
a location information transmission requesting information receiving portion for receiving, from the client device, location information transmission requesting information, which is information containing symbol information and is information for making a request to transmit location information;
a location information acquiring portion for acquiring at least one piece of location information associated with symbol information contained in the location information transmission requesting information, based on the management information;
a location information transmitting portion for transmitting, to the client device, the at least one piece of location information that has been acquired by the location information acquiring portion; and
an information transmitting portion for transmitting the information to the client device in response to a request from the client device, and
the client device comprises:
a symbol information reception portion for receiving symbol information;
a location information transmission requesting information transmitting portion for transmitting, to the at least two information storage devices, location information transmission requesting information containing the symbol information that has been received by the symbol information reception portion;
a location information receiving portion for receiving the at least one piece of location information from at least one information storage device, among the at least two information storage devices;
an information transmission requesting portion for making a request, to an information storage device specified by the location information that has been received by the location information receiving portion, to transmit information;
an information receiving portion for receiving the requested information from the information storage device; and
an information outputting portion for outputting the information that has been received by the information receiving portion.

16. The information processing system according to claim 15,
wherein the client device further comprises:
a location-related information outputting portion for outputting at least one piece of location-related information, which is information relating to the at least one piece of location information that has been received by the location information receiving portion; and
a location-related information instruction reception portion for receiving an instruction on at least one piece of location-related information, among the at least one piece of location-related information that has been output by the location-related information outputting portion, and
the information transmission requesting portion makes a request, to an information storage device specified by location information relating to location-related information corresponding to the instruction that has been received by the location-related information instruction reception portion, to transmit information.

17. The information processing system according to claim 14,
wherein the client device further comprises an information storage device determining portion for determining at least one information storage device to which location information transmission requesting information is to be transmitted, based on the symbol information that has been received by the symbol information reception portion, and
the location information transmission requesting information transmitting portion transmits location information transmission requesting information to the at least one information storage device that has been determined by the information storage device determining portion.

18. The information processing system according to claim 14,
wherein the information storage device further comprises:
an output instruction reception portion for receiving an output instruction on the information;
an information outputting portion for outputting information on which the output instruction has been received;
a symbol information reception portion for receiving an instruction on symbol information contained in the output information;
a location information reception portion for receiving location information; and
a management information accumulating portion for accumulating management information in the management information storage portion based on the symbol information that has been received by the symbol information reception portion and the location information that has been acquired by the location information reception portion.

19. The information processing system according to claim 1,
wherein the symbol information is information of a character string.

20. The information processing system according to claim 19,
wherein the symbol information reception portion receives symbol information with a tracing operation using a pointing device.

21. The information processing system according to claim 20,
wherein the symbol information reception portion receives symbol information immediately after the tracing operation is completed.

22. An information storage device constituting the information processing system according to claim 1.

23. A server device constituting the information processing system according to claim 1.

24. A client device constituting the information processing system according to claim 1.

25. An information processing device that receives a tracing operation over symbol information using a pointing device, and that performs a process based on the symbol information immediately after the tracing operation is completed.

26. The information processing device according to claim 25,
wherein the process is a retrieval process using the symbol information as a key, performed on an external device.

27. A program for causing a computer to execute:
a location information transmission requesting information receiving step of receiving, from a client device, location information transmission requesting information, which is information containing symbol information and is information for making a request to transmit location information;
a location information acquiring step of acquiring at least one piece of location information associated with symbol information contained in the location information transmission requesting information, based on at least one piece of management information that is stored, which is information for managing an association between symbol information and location information, the symbol information being information associated with information stored in at least one information storage device, and the location information being information specifying a location in which the information is stored; and
a location information transmitting step of transmitting, to the client device, the at least one piece of location information that has been acquired in the location information acquiring step.

28. The program according to claim 27, for further causing a computer to execute:
a registration information receiving step of receiving registration information from a client device; and
a management information accumulating step of accumulating management information based on symbol information and location information contained in the registration information that has been received in the registration information receiving step.

29. The program according to claim 28, for further causing a computer to execute an accumulation judging step of judging whether or not management information should be accumulated, based on the registration information that has been received in the registration information receiving step,
wherein in the management information accumulating step, the management information is accumulated only when it has been judged that accumulation should be performed in the accumulation judging step.

30. A program for causing a computer to execute:
a symbol information reception step of receiving symbol information;
a location information transmission requesting information transmitting step of transmitting, to a server device, location information transmission requesting information containing the symbol information that has been received in the symbol information reception step;
a location information receiving step of receiving, from the server device, at least one piece of location information that has been acquired based on management information; and
a location-related information outputting step of outputting at least one piece of location-related information, which is information relating to the at least one piece of location information that has been received in the location information receiving step.

31. A program for causing a computer to execute:
a symbol information reception step of receiving symbol information;
a location information transmission requesting information transmitting step of transmitting, to a server device, location information transmission requesting information containing the symbol information that has been received in the symbol information reception step;
a location information receiving step of receiving, from the server device, at least one piece of location information that has been acquired based on management information;
an information transmission requesting step of making a request, to an information storage device specified by the location information that has been received in the location information receiving step, to transmit information;
an information receiving step of receiving the requested information from the information storage device; and
an information outputting step of outputting the information that has been received in the information receiving step.

32. The program according to claim 29, for further causing a computer to execute:
a location-related information outputting step of outputting at least one piece of location-related information, which is information relating to the at least one piece of location information that has been received in the location information receiving step; and
a location-related information instruction reception step of receiving an instruction on at least one piece of location-related information, among the at least one piece of location-related information that has been output in the location-related information outputting step,
wherein in the information transmission requesting step, a request to transmit information is made to an information storage device specified by location information relating to location-related information corresponding to the instruction that has been received in the location-related information instruction reception step.

33. The program according to claim 31,
wherein in the information outputting step, the information is output with an application corresponding to a format of the information.

34. The program according to claim 31, for further causing a computer to execute:
an output instruction reception step of receiving an output instruction on information that is stored;
wherein in the information outputting step, information on which the output instruction has been received is further output; and
in the symbol information reception step, an instruction on symbol information contained in the output information is further received;
a registration constructing step of constructing registration information based on the symbol information that has been received in the symbol information reception step; and
a registration information transmitting step of transmitting, to the server device, the registration information that has been constructed in the registration constructing step.

35. A program for causing a computer to execute:
a symbol information reception step of receiving symbol information;
a location information transmission requesting information transmitting step of transmitting, to at least two server devices, location information transmission requesting information containing the symbol information that has been received in the symbol information reception step;
a location information receiving step of receiving at least one piece of location information that has been acquired based on management information, from at least one server device, among the at least two server devices; and
a location-related information outputting step of outputting at least one piece of location-related information, which is information relating to the at least one piece of location information that has been received in the location information receiving step.

36. A program for causing a computer to execute:
a symbol information reception step of receiving symbol information;
a location information transmission requesting information transmitting step of transmitting, to at least two server devices, location information transmission requesting information containing the symbol information that has been received in the symbol information reception step;
a location information receiving step of receiving at least one piece of location information that has been acquired based on management information, from at least one server device, among the at least two server devices;
an information transmission requesting step of making a request, to an information storage device specified by the location information that has been received in the location information receiving step, to transmit information;
an information receiving step of receiving the requested information from the information storage device; and
an information outputting step of outputting the information that has been received in the information receiving step.

37. The program according to claim 36, for further causing a computer to execute:
a location-related information outputting step of outputting at least one piece of location-related information, which is information relating to the at least one piece of location information that has been received in the location information receiving step; and
a location-related information instruction reception step of receiving an instruction on at least one piece of location-related information, among the at least one piece of location-related information that has been output in the location-related information outputting step,
wherein in the information transmission requesting step, a request to transmit information is made to an information storage device specified by location information relating to location-related information corresponding to the instruction that has been received in the location-related information instruction reception step.

38. The program according to claim 35, for further causing a computer to execute:
an output instruction reception step of receiving an output instruction on information that is stored;
wherein in the information outputting step, information on which the output instruction has been received is further output; and
in the symbol information reception step, an instruction on symbol information contained in the output information is further received;
a registration constructing step of constructing registration information based on the symbol information that has been received in the symbol information reception step; and
a registration information transmitting step of transmitting, to the server device, the registration information that has been constructed in the registration constructing step.

39. A program for causing a computer to execute:
a symbol information reception step of receiving symbol information;
a location information transmission requesting information transmitting step of transmitting, to at least two information storage devices, location information transmission requesting information containing the symbol information that has been received in the symbol information reception step;
a location information receiving step of receiving at least one piece of location information that has been acquired based on management information, from at least one information storage device, among the at least two information storage devices; and
a location-related information outputting step of outputting at least one piece of location-related information, which is information relating to the at least one piece of location information that has been received in the location information receiving step.

40. A program for causing a computer to execute:
a symbol information reception step of receiving symbol information;
a location information transmission requesting information transmitting step of transmitting, to at least two information storage devices, location information transmission requesting information containing the symbol information that has been received in the symbol information reception step;
a location information receiving step of receiving at least one piece of location information based on management information from at least one information storage device, among the at least two information storage devices;
an information transmission requesting step of making a request, to an information storage device specified by the location information that has been received in the location information receiving step, to transmit information;
an information receiving step of receiving the requested information from the information storage device; and
an information outputting step of outputting the information that has been received in the information receiving step.

41. The program according to claim 40, for further causing a computer to execute:
a location-related information outputting step of outputting at least one piece of location-related information, which is information relating to the at least one piece of location information that has been received in the location information receiving step; and
a location-related information instruction reception step of receiving an instruction on at least one piece of location-related information, among the at least one piece of location-related information that has been output in the location-related information outputting step,
wherein in the information transmission requesting step, a request to transmit information is made to an information storage device specified by location information relating to location-related information corresponding to the instruction that has been received in the location-related information instruction reception step.

42. A program for causing a computer to execute:
a location information transmission requesting information receiving step of receiving, from a client device, location information transmission requesting information, which is information containing symbol information and is information for making a request to transmit location information;
a location information acquiring step of acquiring at least one piece of location information associated with symbol information contained in the location information transmission requesting information, based on at least one piece of management information that is stored, which is information for managing an association between symbol information and location information, the symbol information being information associated with information that is stored, and the location information being information specifying a location in which the information is stored; and
a location information transmitting step of transmitting, to the client device, the at least one piece of location information that has been acquired in the location information acquiring step.

43. An information processing system comprising a server device and a client device,
wherein the client device comprises:
a storage portion in which main information, which is information containing a character string, can be stored;
an output instruction reception portion for receiving an output instruction, which is an instruction to output the main information;
an outputting portion for outputting main information based on the output instruction;
a character string specification reception portion for receiving a character string specification instruction, which is an instruction to specify a character string, in the main information that has been output by the outputting portion;
a keyword information acquiring portion for acquiring keyword information, which is information of a character string specified by the character string specification instruction;
a related information reception portion for receiving related information, which is information relating to the keyword information; and
a transmitting portion for transmitting the related information and the keyword information as a pair to the server device,
the server device comprises:
a receiving portion for receiving the related information and the keyword information as a pair; and
a first accumulating portion for accumulating the related information and the keyword information as a pair in association with each other.

44. The information processing system according to claim 43,
wherein the client device further comprises a second accumulating portion for accumulating the related information and the keyword information as a pair in association with each other,
the related information reception portion receives accumulation-destination specification that specifies the client device or the server device as accumulation-destination of the related information and the keyword information as a pair,
if the accumulation-destination specification that has been received by the related information reception portion specifies the client device, then the second accumulating portion accumulates the related information and the keyword information as a pair, and
if the accumulation-destination specification that has been received by the related information reception portion specifies the server device, then the transmitting portion transmits the related information and the keyword information as a pair to the server device.

45. The information processing system according to claim 43,
wherein the client device further comprises an accumulation information receiving portion for receiving accumulation information, which is information indicating whether or not the keyword information has been accumulated and which has been transmitted from the server device,
the transmitting portion transmits, to the server device, the keyword information that has been acquired by the keyword information acquiring portion,
the related information reception portion judges whether or not keyword information has been accumulated in the server device, based on the accumulation information that has been received by the accumulation information receiving portion, and receives the related information only when it has been judged that keyword information has not been accumulated,
the receiving portion of the server device receives keyword information,
the first accumulating portion of the server device judges whether or not the keyword information that has been received by the receiving portion has been accumulated, and
the server device further comprises an accumulation information transmitting portion in which based on judgment results of the first accumulating portion, the accumulation information is constructed and transmitted to the client device.

46. The information processing system according to claim 43,
wherein the character string specification reception portion receives a character string specification instruction on a character string that has been selected by dragging, and
the keyword information acquiring portion acquires, as the keyword information, a character string that has been selected by the dragging.

47. The information processing system according to claim 43,
wherein the outputting portion outputs main information that has been transmitted from a web server.

48. An information processing device, comprising:
an output instruction reception portion for receiving an output instruction, which is an instruction to output main information, which is information including a character string;
an outputting portion for outputting main information based on the output instruction;
a character string specification reception portion for receiving a character string specification instruction, which is an instruction to specify a character string, in the main information that has been output by the outputting portion;
a keyword information acquiring portion for acquiring, as keyword information, information of a character string specified by the character string specification instruction;
a related information reception portion for receiving related information, which is information relating to the keyword information; and
a transmitting portion for transmitting the related information and the keyword information as a pair to predetermined transmission destination.

49. An information processing device, comprising:
an output instruction reception portion for receiving an output instruction, which is an instruction to output main information, which is information including a character string;
an outputting portion for outputting main information based on the output instruction;
a character string specification reception portion for receiving a character string specification instruction, which is an instruction to specify a character string, in the main information that has been output by the outputting portion;
a keyword information acquiring portion for acquiring, as keyword information, information of a character string specified by the character string specification instruction;
a related information reception portion for receiving related information, which is information relating to the keyword information; and
a second accumulating portion for accumulating the related information and the keyword information as a pair.

50. An information processing system comprising a server device and a client device,
wherein the client device comprises:
a storage portion in which image information can be stored;
an output instruction reception portion for receiving an output instruction, which is an instruction to output the image information;
an outputting portion for outputting image information based on the output instruction;
an instruction information reception portion for receiving an area instruction to specify at least a part of an area, in the image information that has been output by the outputting portion, and keyword information, which is information of a character string associated with an area specified by the area instruction;
a file constructing portion for constructing a partial image file, which is a file containing image information associated with an area specified by the area instruction; and
a transmitting portion for transmitting the partial image file and the keyword information as a pair to the server device, and
the server device comprises:
a receiving portion for receiving the partial image file and the keyword information; and
an accumulating portion for accumulating the partial image file and the keyword information as a pair in association with each other.

51. The information processing system according to claim 50,
wherein the file constructing portion extracts an area specified by the area instruction in the image information, and constructs a partial image file containing the extracted image information.

52. A program for causing a computer to execute:
an output instruction reception step of receiving an output instruction, which is an instruction to output main information, which is information including a character string;
an outputting step of outputting main information based on the output instruction;
a character string specification reception step of receiving a character string specification instruction, which is an instruction to specify a character string, in the main information that has been output in the outputting step;
a keyword information acquiring step of acquiring keyword information, which is information of a character string specified by the character string specification instruction;
a related information reception step of receiving related information, which is information relating to the keyword information; and
a transmitting step of transmitting the related information and the keyword information as a pair to predetermined transmission destination.

53. A program for causing a computer to execute:
an output instruction reception step of receiving an output instruction, which is an instruction to output main information, which is information including a character string;
an outputting step of outputting main information based on the output instruction;
a character string specification reception step of receiving a character string specification instruction, which is an instruction to specify a character string, in the main information that has been output in the outputting step;
a keyword information acquiring step of acquiring keyword information, which is information of a character string specified by the character string specification instruction;
a related information reception step of receiving related information, which is information relating to the keyword information; and
an accumulating step of accumulating the related information and the keyword information as a pair.

54. A program for causing a computer to execute:
an output instruction reception step of receiving an output instruction, which is an instruction to output image information;
an outputting step of outputting image information based on the output instruction;
an instruction information reception step of receiving an area instruction to specify at least a part of an area, in the image information that has been output in the outputting step, and keyword information, which is information of a character string associated with an area specified by the area instruction;
a file constructing step of constructing a partial image file, which is a file containing image information associated with an area specified by the area instruction; and
a transmitting step of transmitting the partial image file and the keyword information as a pair to predetermined transmission destination.
